(19) United States
(12) Patent Application Publication
(10) Pub. No.: US 2006/0048800 A1
(43) Pub. Date: Mar. 9, 2006

(54) Automated building exterior cleaning apparatus

(76) Inventors: Rodger H. Rast, Gold River, CA (US); Rick Martin Wiesner, Carmichael, CA (US)

Correspondence Address: RODGER H. RAST, 11230 GOLD EXPRESS DRIVE, SUIT 310 MS 337, GOLD RIVER, CA, 95670, US

(21) Appl. No.: 11/222,610

(22) Filed: Sep. 9, 2005

Related U.S. Application Data
(60) Provisional application No. 60/608,789, filed on Sep. 9, 2004.

(51) Int. Cl. B08B 3/00

(52) U.S. Cl. 134/56 R; 134/172

(57) ABSTRACT

An automated exterior building cleaning system particularly well suited for cleaning the window exteriors on a high rise building. By way of example the system is deployed on a rooftop rail system traversed by a movable platform from which a washing head is deployed over the edges of the building and lowered on cables for cleaning the window surfaces and other building elements. The system is configured for remote monitoring and control and provides a number of novel elements and safety features.

### CROSS-REFERENCE TO RELATED APPLICATIONS

This application claims priority from provisional patent application Ser. No. 60/608,789 filed Sep. 9, 2004 which is incorporated herein by reference and priority to which is claimed.

This application is related to these copending applications, which are subject to a common assignment: Utility patent application docket KeyboardRAST070103 Ser. No. 10/612,777 filed Jul. 1, 2003; Provisional patent application entitled “Automated window washer” Ser. No. 60/394,160 filed Jul. 1, 2002; Utility patent application docket “TransportRAST070103” Ser. No. 10/612,225 filed Jul. 1, 2003; Utility patent application docket “Display_RAST092303” Ser. No. 10/670,432 filed Sep. 23, 2003; provisional patent application Ser. No. 60/413,199 filed Sep. 23, 2002; Utility patent application docket “DisplayRAST070103” Ser. No. 10/612,221 filed Jul. 1, 2003; Utility patent application docket “HardBLight” Ser. No. 09/730,327 filed Dec. 5, 2000; Provisional patent application Ser. No. 60/153,084 filed Sep. 9, 1999; Provisional patent application docket “PPA_RAST120103” Ser. No. 60/526,376 filed Dec. 1, 2003; Utility patent application docket “Steer_{—}01” of Ser. No. 10/279,480 filed Oct. 23, 2002; and Provisional patent application Ser. No. 60/346,753 filed Oct. 23, 2001.

### STATEMENT OF FEDERALLY SPONSORED RESEARCH OR DEVELOPMENT

Not Applicable.

### REFERENCE TO A MICROFICHE APPENDIX

Not Applicable

### BACKGROUND OF THE INVENTION

1. Field of the Invention

This invention pertains generally to apparatus and methods for automated cleaning and more particularly to a system and method for cleaning the exterior surfaces of a hi-rise building.

2. Description of the Background Art

Cleaning windows on high-rise buildings is both difficult and expensive. Crews of two persons typically connect boom arms at a location along the rim of the building to which they connect their motorized platform equipment, which can be lowered along the face of the building allowing them to clean one section at a time. It can take a crew weeks to clean the windows on a single high-rise building. After cleaning each section they must return to the top of the building pulling the platform on top and then moving the boom arms to another spot before dropping the equipment over the edge for another pass down the side of the building in a labor intensive process.

Aside from having a high cost per cleaning, another disadvantage of current manual systems is that windows can only be cleaned once or twice a year, and it is not cost effective to wash individual sections of the building despite the need. It will be appreciated that many situations arise wherein at least some windows are soiled and must remain so for many months or up to nearly a year before being cleaned, for example from bird strikes, droppings, blown dirt onto windows wet with precipitation, water spotting, and so forth. Furthermore, as the glass cleaning personnel are not involved with building maintenance, important information which could be seen during the cleaning process is never brought to light. In addition, conventional window cleaning equipment is not kept on site and at the ready, wherein during emergency situations it is not available for performing other operations.

Accordingly, a need exists for a window cleaning system that can be operated autonomously and which can be utilized for performing overall periodic cleaning o performing cleaning on an as needed basis. The present invention satisfies that need as well as others and overcomes the drawbacks of currently proposed window washing systems.

### BRIEF SUMMARY OF THE INVENTION

An automated exterior building washing system is described that is particularly well-suited for washing the exterior windows on high-rise buildings. The system can be configured for semi-automatic cleaning, or for fully automated remote cleaning operations. Although the bulk of the description herein describes a fully automated system, it will be appreciated that the invention may be implemented without one or more of the inventive aspects described and may thereby require manual intervention when so implemented.

A washing head is deployed for moving over the exterior faces of a building, or in other similar cleaning situations, such as solar panel sections on the rook of a building, non-windowed building exterior portions (i.e. marble), and so forth. The washing head utilizes a liquid cleaning process, wherein the cleaning liquid is applied, preferably scrubbed over the surface and then removed, such as by a combination of a squeegee and a vacuum. The washing head may be deployed for moving autonomously over a railing grid, or more preferably tethered from a movable platform that is slidably engaged within a set of rails on an associated roof portion. The system can be controlled and monitored from a remote location, such as a personal computer connecting to a building wide LAN. Furthermore, the system can be monitored and tested remotely, such as by the manufacturer.

Automated window cleaning has been considered in the past, however, the devices considered were generally unsafe and impractical, preventing adoption and penetration into the marketplace. The present invention overcomes these shortcomings and is configured to take full advantage of the benefits of an automated cleaning system, while providing additional benefits not related to cleaning.

The invention has a number of different inventive aspects and benefits for the cleaning of building surfaces. The following is a partial list presented by way of example, and it should be appreciated that these elements may be optionally utilized separately or in combination on one or more embodiments of the present invention.

An aspect of the present invention is the ability to deploy a fully automated washing system on buildings.

Another aspect of the present invention is to deploy a washing head from a movable platform which is easily and safely secured to the top of the building.

Another aspect of the present invention is to deploy a washing head from a movable platform that is not supported on building surfaces from which building materials may be displaced that can fall on individuals passing below, such as the vertical exterior surfaces and the top edge of a surrounding railing.

Another aspect of the present invention is to allow installing the automated washing system without the need of structural changes to the building.

Another aspect of the present invention is to allow for supporting the mobile platform of the automated washing system from the roof and optionally from conventional extension boom supports if additional support desired.

Another aspect of the present invention is the ability to remotely control and monitor the activity of the washing system.

Another aspect of the present invention is the ability for remote personnel to view images of the progress and activity of the washing system.

Another aspect of the present invention is the ability for authorized personnel to deploy the washing head to any selected portion of the building from a remote location.

Another aspect of the present invention is to provide a automated washing system having washing heads that may be moved from one portion of a building to another or retained

Another aspect of the present invention is to perform remote control and monitoring over a local area network in response to a washing head application program executing on a terminal or host computer.

Another aspect of the present invention is the ability to communicate selected information between the washing system to and from wide-area networks, such as the Internet, for example uploading parametric or diagnostics to a centralized service center and downloading operational parameters, firmware, software, and so forth therefrom for use by the system.

Another aspect of the present invention is to utilize an additional processing element within the washing head and/or the mobile platform, for monitoring all activity of the system and to intercede when a malfunction is detected.

Another aspect of the present invention is the ability to deploy a washing head from the movable platform and extend it over the edge of the building for lowering to areas to be cleaned, and similarly retrieve it, without the need of human intervention.

Another aspect of the present invention is to deploy the system without the need to couple additional equipment at the base of the building to support operations.

Another aspect of the present invention is the ability to retrieve the mobile platform and washing head to a storage location when not in use, wherein it is not left exposed to view and to the elements.

Another aspect of the present invention is the ability to retrieve the mobile platform and washing head to an enclosed storage location when not in use.

Another aspect of the present invention is to allow implementing the automated washing system with a self-contained mobile platform, wherein fluids and power need no be routed to and from the mobile platform.

Another aspect of the present invention is the ability to retrieve the mobile platform and washing head into a storage location from which batteries may be recharged and fluids exchanged, such as new liquid loaded and waste liquids disposed of.

Another aspect of the present invention is the ability to adjust the distance of the washing head from the building in response to rotating cable extension booms under program control.

Another aspect of the present invention is to prevent possible tangling of flexible members extending from the system.

Another aspect of the present invention is to preferably limit the connections between the moving platform and the washing head to a maximum of three connections.

Another aspect of the present invention is to allow deploying the automated washing system without the need to deploy power cords across the surface of the building.

Another aspect of the present invention is to allow deploying a washing head from a mobile platform that can be moved around corners to access different sides, or portions of a building whose windows, or other portions, are being cleaned.

Another aspect of the present invention is to control the pressure applied by the washing head to the windows on the building, despite position, atmospheric conditions, and other prevalent conditions.

Another aspect of the present invention is to control the weight distribution (balance) of the washing head by actuating weights which are moved to adjust distribution.

Another aspect of the present invention is to allow optically imaging the surfaces being cleaned, and detecting position, anomalies, or areas needing additional cleaning.

Another aspect of the present invention is to provide a washing head that can be configured with a scrubber for removing hard deposits.

Another aspect of the present invention is to provide a washing head with a squeegee that can remove wash water from the window with minimal drippage below.

Another aspect of the present invention is to provide a washing head with an extendable liquid barrier to control the descent of wash water, the barrier being preferably configured with a vacuum and air/water separator for removing waste water.

Another aspect of the present invention is to provide a washing head whose activity may be modulated in response to an image stream of surfaces and washing activity, preferably enhanced by controllable lighting (type, intensity, position, and/or direction).

Another aspect of the present invention is to provide a washing head having a camera system having a means for cleaning its own lenses, such as wipers, movable lens filters, other means, or combinations thereof.

Another aspect of the present invention is to provide a washing head with built-in acceleration sensing for determining positional tilt and dangerous conditions, such as wind induced motion, free fall, and so forth, wherein the system activated remedial actions.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a side view of an automated building cleaning system according to an embodiment of the present invention.

FIG. 2 is a side view of the system of FIG. 1.

FIG. 3 is a top view of the system of FIG. 1.

FIG. 4 is a top view of the drive wheel assembly of the automated cleaning system according to an aspect of the present invention.

FIG. 5 is a top view of a rotatable boom for the automated cleaning system according to an aspect of the present invention.

FIG. 6 is a cross-section of a supply tether for the cleaning system according to an aspect of the present invention.

FIG. 7-8 are top and underside views of a movable platform for the cleaning system according to an aspect of the present invention, showing means for retaining a the platform upon a track.

FIG. 9-10 are side and top views of an articulated balancing system for the cleaning system according to an aspect of the present invention.

FIG. 11 is a side view of a pressure detection means according to an aspect of the present invention.

FIG. 12 is a side view of a means for separating wash head of cleaner from the building according to an aspect of the present invention.

FIG. 13 is a top or side view of a gripper to allow the automated cleaning system to stabilize itself on window frames according to an aspect of the present invention.

FIG. 14-15 are top and side views of another device separations means utilizing articulated legs according to an aspect of the present invention.

FIG. 16-17 are side views of a selective separation means of the automated cleaning system according to an aspect of the present invention.

FIG. 18 is a side view of a positioning correction means of the automated cleaning system according to an aspect of the present invention.

FIG. 19 is a top view of a movable platform base station for the automated cleaning system according to an aspect of the present invention.

FIG. 20 is a cross-section of a mounting washing head for the automated cleaning system according to an aspect of the present invention.

FIG. 21 is a schematic for the building cleaning system according to an embodiment of the present invention.

FIG. 22-23 are side and edge views of a tracked window system and vehicle for the automated cleaning system according to an aspect of the present invention.

FIG. 24 is a side view of a flight-forward pillow for resting during flight according to an aspect of the present invention.

FIG. 25-27 are edge side and top views of a bag configured with an integral flight-forward comfort pillow according to an aspect of the present invention.

FIG. 28 is a side view of case charge housing according to an aspect of the present invention.

FIG. 29 is a schematic of the case charge device of FIG. 28.

FIG. 30 is a schematic of an electronic ink form of display to indicate the power generated from the solar collectors on the bag or FIG. 28.

FIG. 31-34 are views of extendable power collection strips from cell phones and less preferably other personal electronic device according to an aspect of the present invention.

FIG. 35 is a top view of a drill driver holder according to an aspect of the present invention.

FIG. 36 is a schematic of the holder of FIG. 35.

FIG. 37-38 are side views of a pressure sensing device in a first and second position respectively, in response to application of different pressure levels, according to an aspect of the present invention.

FIG. 39-40 are schematics of a one-piece and segmented sensor transducer according to an aspect of the present invention.

FIG. 41 is a cross-section of a compliant pressure sensing element according to an aspect of the present invention.

FIG. 42 is a schematic of a collision avoidance system which includes enhanced distance sensing according to an aspect of the present invention.

FIG. 43 is a block diagram of an RFID at the point of sale system coupled to image collection and analysis according to an aspect of the present invention.

FIG. 44 is a flowchart of operation of the checkout system of FIG. 43 according to an aspect of the present invention.

FIG. 45 is a block diagram of a building permit system which provide automated updating of a GPS database to assure they are kept up to date with minimal manual labor, according to an aspect of the present invention.

FIG. 46 is a side view of a clearance detection device according to an aspect of the present invention.

FIG. 47 is a schematic of the clearance detection system of FIG. 46.

FIG. 48 is a cross-section view of a laser cutting apparatus configured to sense and control the depth the cut using an active backing board according to an aspect of the present invention.

FIG. 49-50 are facing and top views of a user controlled optically designated directed audio system according to an aspect of the present invention.

FIG. 51 is a schematic of the directed audio system of FIG. 49-50.

FIG. 52 is a schematic of a noise abatement backup annunciation system according to an aspect of the present invention.

FIG. 53 is a block diagram of a rear position tactile response indicator, which is particularly well suited for racing, according to an aspect of the present invention.

FIG. 54 is a schematic of a back-up simulator for those towing boats or other elements according to an aspect of the present invention.

FIG. 55 is a flowchart of the back-up simulator according to an aspect of the present invention.

FIG. 56 is a flowchart of a business method for distributing the back-up simulation to increase driver safety according to an aspect of the present invention.

FIG. 57 is a top view of a piece of animal deterrent landscape bark according to an aspect of the present invention.

FIG. 58 is a flowchart of processing the animal deterrent landscape bark of FIG. 57.

### DETAILED DESCRIPTION OF EMBODIMENT(S)

Referring more specifically to the drawings for illustrative purposes, the present invention is embodied in the method generally described in FIG. 1 to FIG. 58. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

Throughout the specification numerous values and type designations are provided for the elements of the invention in order that a complete, operable, embodiment of the invention be disclosed. However, it should be understood that such values are type designators are merely representative and are not critical unless specifically so stated. The scope of the invention will be pointed out in the appended claims. Furthermore, aspects of the invention may be implemented separately or in various combinations without departing from the teachings of the present invention. Specific embodiments are typically shown having a given set of features for the sake of clarity, however, it will be appreciated that the invention may be implemented with more or fewer aspects without departing from the invention. Furthermore, the claims, and/or claim portions contained within the application are considered to comprise portions of the invention disclosure and are to be considered as such for all purposes.

### 1 AUTOMATED BUILDING CLEANING SYSTEM

### 1.1 DETAILED DESCRIPTION OF EMBODIMENTS

The present invention describes an automated (robotic) cleaning system that is particularly well-suited for cleaning windows on the exterior of multi-story buildings. The robotic system may also be deployed for other forms of cleaning or just removing precipitation (rain, snow, ice) from windows without the need to perform a liquid cleaning operation. In addition, the robotic washer unit of the present invention can be adapted, or utilized as is, for washing solar panels, solar collectors, and the like which may be positioned at any angle between the horizontal to the vertical. Preferably the unit also serves for cleaning other portions of the building, in particular window sills and frames (typically cleaned during the window cleaning process), as well as other desired portions of the window. In the following descriptions the window cleaning aspects will be described in depth, although it should be kept in mind that the device is also configured for cleaning solar panels or other areas on the exterior of a building, or other structure. Embodiments of the system can operate unattended without the need of cleaning personnel, and can be utilized on a variety of buildings without modification, or a minimum of necessary modification.

The unit comprises a drive mechanism capable of traversing the windows on the building, a robotic washing head assembly, positioning sensors, a controller, a power source, and preferably a means for detecting (anomalies) cleaning residues, spots or dirt on the window. The unit positions itself on a window or window section, to be cleaned, wherein the washer assembly sufficiently wets the window surface, preferably with detergents or other surfactants, after which the liquids are wiped away until the window portion is clean.

The unit can be configured for moving across the surface of the building using fixed tracks, flexible tracks, or a combination thereof. By way of example vertical and/or horizontal tracks can be coupled to the face of the building into which a drive mechanism engages for both moving across the face of the building and controlling the distance from a washing head to the windows or other portions of the building.

The system is described for deploying a washing head over a fixed track or flexible track to reach the windows or building surfaces to be cleaned. In the fixed tracked configuration the windows have tracks over which the washing head can move to reach each window. In the flexible track embodiment the washing head is suspended from one or more flexible tracks from which it moves up and down to access windows in a vertical column. The fixed and or flexible tracks may be laid out in a number of configurations depending on the application. Following are a few examples provided by way of example:

Cables (flexible tracks) coupled to fixed roof supports.

Cables (flexible tracks) coupled to a movable platform, such as riding on horizontal tracks on the roof.

Grid of both vertical and horizontal fixed tracks, wherein device can move vertically or horizontally on building faces to position itself on a window.

Horizontal tracks with limited vertical paths, such as at a corner wherein the device can transition from one floor to another.

Vertical tracks with limited horizontal pathways, such as at ground level for transitioning to another vertical path.

Window ledges to which the washing head may apply horizontal and/or vertically supportive forces.

Glass surfaces to which the washing head can apply horizontal and/or vertically supportive forces.

The types of tracks utilized and the optimum configuration and orientation of the tracks will depend on whether the building is a new design or existing building and on other aspects of the building architecture, and system selection. A single automated cleaning device may be deployed for the entire building or separate cleaning systems, or head for each floor or portion of the building. The automated washer may be moved automatically or manually between sections of the building to be cleaned, such as different roof sections of the building. It will be appreciated that a separate cleaning apparatus is not required for each separate roof section, or other separate areas, insofar as an automated or manual path exists over which the cleaning device may be moved.

A preferred arrangement of the automated building cleaning apparatus of the present invention preferably comprises a horizontal track on roof portions of the building (having one or more landings) with a movable platform having booms which extend over the edge of the building (and over any railings attached thereto) from which flexible tracks (i.e. cables) extend down toward a washing head. The flexible tracks may comprise cables or other elongated high tensile strength members. The movable platform is engaged into the track and provides suspension arms (booms) which extend over the edge of the building.

The boom supports are configured to extend sufficiently high for clearing railings and so forth. It will be appreciated that roof lips, or railings are typically sufficiently high so that persons on the roof can not easily fall over the edge. Optionally, the booms of the present invention are extendably coupled (i.e. telescoping sections) to the movable platform, providing an extended height when the washing head is deployed and a retracted height when the washing head is not deployed, such as retained on the movable platform with the combination being stored in an enclosed base station.

Unlike supporting a washing head from the exterior rim of the building, this arrangement allows the washing unit to be operated on the outer periphery of the building without stressing the material about the exterior periphery of the building, which leaves unsightly mechanisms out in the open, mars exterior building portions, and increases the risk of objects or material falling from the building surface. Supporting the washing device on the rim of the building is less preferred, especially wherein it must roll along the edge, because the device can mark up or damage the exterior of the building and cause portions of concrete, tile, marble, and so forth to fall down on persons below.

With the preferred horizontal track as described, the only contact is on the horizontal roof surface of the building, from which materials can not be displaced to persons below the building, therefore overall safety is improved. It will be appreciated that this arrangement in the present invention allows for automated deployment from various sides of a roof without the need for manual intervention and without the need for a separate washing unit for the various sides. The track may follow a path near the edge of the roof with suitable curves near the corners. For in climate weather the track may be heated, or the movable platform configured with a heated blower, scraper, or other equipment necessary for removing ice and snow from the track and path of the platform.

Booms from the platform can be rotated under program control to alter the distance of the washing head from the building and for deploying and retrieving the washing head from or back onto the mobile platform. The mobile platform and washing head can be moved over the fixed track into a covered storage container when not in use. Preferably a door on the storage area can be opened and closed under program control to allow deploying or storage of the mobile platform. The door preferably contains a locking mechanism to prevent access to the robotic unit by unauthorized parties.

When deployed on cables or other flexible vertical tracks, the washing head portion is biased toward the vertical face of the building, such as the windows, with means extended to hold it separated from the window, such as compliant wheels or articulated feet. Articulated weights extend from the unit and can be positioned to alter the force applied to the window and balance of the load. Pressure sensors coupled to the washing head detect the force with which the washing head applies to the windows, allowing the balance and the rotational position of the booms to be varied to prevent undue strain on the windows, regardless of variations in applied wind loading.

On traversing down the face of the building the feet hold the washer head a fixed distance from the window to provide cleaning thereof. However, upon returning up the window, the device can be further extended away from the windows with portions only contacting the frames, of portions contacting the windows that don't leave any debris, water, or marks, or held slightly separated from the face of the building. The control of distance can be performed by varying the rotational angle of the boom arms from the movable platform, or changing the extension of the booms over the edge of the building.

The washing head can be stabilized at the window surface in a number of alternative ways. For example by pulling itself toward the window, such as with Gecko traction pattern or suction cups, and so forth. It cleans above the area and finally cleans over the suction cup marks. It can grasp alternatively or additionally grasp a window sill (if one exists) with compliant claspers, such as covered with a rubber material. Additionally, or alternatively, one or preferably multiple weights coupled to an articulated actuator can be moved to alter the balance and weight being applied against the window surface.

The window may be wet by spraying a liquid cleaning solution, or more preferably utilizing a mechanically operated wet-scrubber, such as a sponge, wool scrub device, or other element configured for distributing cleaning liquid and preferably scrubbing the window surface with the cleaning liquid. An optional high-pressure cleaning head is controlled by the system that may be utilized on the device for cleaning hard to remove materials, or for removing dirt and debris from other portions of the building. The window portion may be optionally rinsed by the automated washing head assembly to aid in removing the cleaner. The liquids are then preferably squeegeed from the window, although they may be removed by wiping, vacuuming or a combination thereof. In a preferred embodiment at least one vacuum bar is extended and retained against the lower portion being cleaned, wherein excess wash water is collected during scrubbing the window or when the window is squeegeed dry. It will be appreciated that a vacuum inlet may be coupled to the squeegee head for collecting at least a portion of the water during that process.

Receipt and storage of liquids. The system is preferably configured with its own reservoir of cleaning liquid, and/or it may be fed cleaning material from a stationary portion of the building, such as the rooftop where other equipment is located. Similarly, the system is preferably configured to collect liquid remnants (waste) from the cleaning process. The liquids removed from the windows are preferably collected wherein they may be disposed of in an appropriate manner and so that liquids do not blow from a section being cleaned onto a section that has already been cleaned. The liquids may be collected in a collection reservoir within the robotic washer, and/or drawn away for disposal. The collected liquid can be recycled within the washing head or movable platform to reduce the amount of washing fluid utilized and the volume of disposed liquids. A filtering means is preferably coupled to the system for cleaning at least a portion of the liquid removed from the window surface and returning that liquid for reuse. Any convenient means of filtering may be utilized, for example in a two stage filtering process, such as utilizing a simple screen filter for large elements, leaves, bugs, and so forth and a small particle filter. The smaller particle filter for example may comprise a conventional filter or more preferably utilize a cyclone form of filtering which relies on the difference in fluid properties in motion for separating materials from the wash water. Cyclone filters have a low flow resistance and require less maintenance than flow-through filters.

One preferred liquids handling mechanism allows for automatic periodic refilling of a cleaner reservoir, and emptying of a liquid waste reservoir, such as for example with each return trip to the top of the building. Another preferred mechanism for fluid transfer is a supply connection between the washing head and platform containing a multiple element umbilical cord having fluid feed, optional fluid return, electrical power, control lines, and monitoring feedback signals. By using a single flex line coupling the possibilities for tangling are significantly reduced. A safety cable being preferably included in the bundle. The bundle being configured to break power connections (optionally other signals and fluid feeds) in response to the application of sufficient tension to the bundle such one or both of the suspension cables being broken, or otherwise the suspension of at least one quarter or more of the weight of the washing head. Alternatively, the power may be routed to the washing head through the suspension cables themselves, such as within plastic shielded steel cables, or other forms of flexible track having an embedded conductor, such as a conductive layer embedded within high tensile strength layers.

It is preferred that a means of detecting debris on the window provides feedback on the window cleaning operation. Preferably the washer mechanism optically determines the tough spots to clean, such as using an imaging sensor (i.e. video camera) coupled to image processing software, then it sprays a cleaner on the window and deploys a wiping device, such as sponge which is used to displace dirt on the window, and may be directed to spend extra time, or extra passes, cleaning locations where a tough spot was located. Additionally, the debris detection means can preferably detect water droplets or other residues remaining on the window after the water has been wiped from the window, wherein it can wipe off the residues or reclean that portion.

The washing head assembly is also preferably configured to store images collected during the cleaning process. For example, images may be collected in response to traversal difficulties, to save images of difficult spots to be cleaned, of spots on the window that will not come clean, or damage to windows or sills detected during cleaning. Position information may be stored along with the images as a reference, while other forms of information may be optionally collected, such as microphone audio, time, date, temperature, parametric data on robotic operation (i.e. voltage, current, motor temperatures, etc.). Furthermore, the system can preferably allow the images to be sent to an individual monitoring the cleaning process, which optionally can manually control aspects of the operation. The system is optionally configured with lighting, as it is anticipated that the cleaning operations may be performed after normal office hours, wherein workers will be subject to less disturbance by the cleaning operation, insofar as suitable temperature conditions (i.e. preferably above freezing) are available during evening and night hours. The use of lighting can aid in utilizing image sensors (i.e. day or night operations) or other optical sensors being utilized. The lighting can include infrared, and or ultraviolet elements for improving computer vision functionality.

After, or during, washing a section of a window the drive mechanism of the robotic washing assembly moves the unit, such as to another window section. Windows are typically cleaned following a sequential pattern, but however, unlike semi-automated cleaning embodiments of the invention, allow the cleaning of select portions of the building exterior, typically windows, on demand without the need of intervention. The sequential cleaning pattern followed generally depends on how the unit tracks the windows during cleaning. For example the present invention may be utilized on fixed window tracks or movable tracks, such as suspended from cables.

The washing head portion of the robotic window cleaning system can be configured for use upon a single section of the building, or more preferably configured for easy transport to different levels and/or faces of the building from which cleaning is to be performed.

The present invention preferably includes a number of optional safety features. (1) Safety tether is preferably coupled to the unit in case conventional retention devices fail to properly retain the unit. (2) In applications wherein the robotic washer unit moves over a set of tracks without the benefit of a safety tether, a parachute system can be employed (i.e. a ballistically deployed parachute) to reduce descent rate. (3) Signage on the washer unit facing the parties interior of the building notifying them of the intent of the washer unit (preferably an active display sign, such as may also display the name of the office whose windows are being cleaned). In this way persons which have not seen the unit will be assured that the unit is not a Terminator 3™ creation but a window cleaning machine. The signage area on the washer head may be sold as advertising space. (4) Optical beams, such as generated by lasers can generate markings below the robotic washing platform to mark an area below the platform and to warn individuals below of the overhead device, as it is preferable that individuals do not walk beneath the device. The optical beams are preferably directed through a focusing or patterning device that allows adjusting the angular spread and direction of the beams so that the correct, same sized pattern, is projected onto the underlying surface regardless of washer head height and any slight angular displacements. (5) Optionally, the unit can detect individuals moving below it (i.e. pyroelectric sensing), or toward the area beneath it, and cease its own motion until they have passed. In this way the chance of the unit falling are minimized. (6) Audio beams can be directed from beneath the unit (or from the top of the tower down) to the ground as an audible warning to match the visible warning, in the case that individuals begin passing under the unit, or especially in the case that the unit experiences positioning problems or begins to fall (i.e. detecting free fall conditions with a G sensor). (7) The audio beams preferably comprise directed audio beams, for example multiple ultrasonic beams that overlap at the locations beneath the unit, wherein only individuals in that vicinity hear the alarm produced as the beat frequency between the ultrasonic audio being generated. Audio systems configured for directing overlapped ultrasonic audio is known in the art. (It will be appreciated that although lights and sound can be utilized for marking the area beneath, a barricade about a traffic area beneath the unit is preferred, such as the use of cones with tape between each cone, to exclude the movement of persons below a section being cleaned. The unit can easily operate at night, such as cleaning one vertical section per night, wherein barricades may be easily set up and other precautions taken.) (8) Falling platform alarm. An acceleration sensor is coupled to an acoustic annunciator directed below the washing head. If the robotic or manual platform is detected in free fall an alarm sound is generated, preferably with accompanying flashing lights, which are directed toward the area beneath the platform. The alarms provide a warning that gives additional time for persons to get out of the way. (9) Optionally the system can detect problems during operation, such as being stuck in a given position (i.e. actuator or motor failures). A separate monitoring computer is preferably utilized that can monitor for error conditions and control retrieval aspects of the system in response. (10) Error information can be optionally communicated to building service personnel on site or at a remote site. The communication is preferably according to a wireless link to building systems or personnel. If unattended, then building systems preferably execute a call tree for contacting an individual and annunciating a problem condition to them for rectifying the problem.

### 1.2 AUTOMATED BUILDING WASHING SYSTEM

### 1.2.1 OUTLINE OF ELEMENTS OF EMBODIMENTS

The following outline is generally directed to an embodiment having a movable platform from which a washing head is deployed over extendable cables. Portions of these elements are applicable to other embodiments as well. It should be appreciated that the elements within the list are optional and when incorporated may be practiced separately or in combination with one another o other elements known to those of ordinary skill in the art.

Automated Building Washing System-Overall

Movable platform from which a washing head may be deployed
washing head retained on top of platform during storage or moving
washing head may be extended over building edge and lowered automatically

Operation may be fully automatic or controlled from a remote console

Communication link from system to manufacturer
Parameters, data, software uploaded or downloaded
Remote monitored system diagnostics
System manufacturer automatically alerted to select conditions
   example—service needed, errors

System may be moved to different roof sections
Platform (or sections thereof) rolled onto/off-of elevator
Washing head may be used from different movable platforms

Path defining Mean for Movable Platform.

i.e. a track mounted to horizontal roof portions
(unless deployed no portions extending past edge)
   May be supported by conventional post supports
Track configured to prevent engaged wheels from derailing or lifting from track
Track may be curved for access to different building faces
Track preferably with direction switches to allow dir. change
Track configured with linear position indication means
   (i.e. holes, bar codes, linear position)
One portion of track leads to a storage location
One portion of track allows for loading and unloading of platform from track

Movable Platform Storage.

Garage (base station) for storing the movable platform & washing head
coupled to portion of track for automated deployment
environmentally protected housing
an articulated door that can be opened or closed by the system
   portion of housing with glass for testing washing head operation
optionally available power, clean water, drain for waste water
   available power charges batteries of movable platform

Movable Platform.

A receptacle for receiving the washing head
retains washing head in fixed position during storage or transit
   can supply power or fluid couplings to a self-contained head (or partially)
   can allow testing washing head on a glass panel in storage area
      allows controlled conditions to test/view operation of washing elements

Single housing or articulated housing to simplify cornering

Base mounted wheels for engaging path defining means (track)

Computer controlled systems
communicates with remote control console and washing head
connection to a LAN (wired or wireless) for connecting to remote console
connection through remote console to WAN (i.e. Internet) service center
system status monitored
atmospheric condition monitoring (platform and/or wash head)
   (i.e. wind speed, direction, precipitation)

Electrical Power is supplied:
Through rails (full or limited)
Self-contained (i.e. charged at a station)

Motive force—preferably electrical motors driving wheels
Movement preferably constrained when wash head deployed

Power & Fluid supply means to Platform.
Hose connections generally less preferable although acceptable
Self-contained water supplies
   reservoirs for both clean and waste water
   in-platform filtering means (optional i.e. on large buildings)
   service reservoirs from base location
      fill new water from top
         washing agents (i.e. detergent, etc.) added to received water reservoir of concentrated additive material
         drain waste water to drain system
   Self-contained power
      charge batteries from base station
      wireless communication connection with remote controller
   Track supplied power
      control signals available through rails
      supply limited current for charging batteries & communication

Adjustable extension boom(s) coupled to platform
Preferably two rotatable booms
   rotating booms alters distance/pressure washing head to building
Controlled extension of booms optional (i.e. telescoping sections)
   allows extending from a stored position for clearing railings etc.
Flexible cable supported by booms coupled to washing head
   At least two pulleys, or bushings, along length of boom
   Angular rotation sensing in pulleys to determine extend/retract amt.
Integral cable cleaning assembly (i.e. wipe, drying)
   (i.e. UHMW bushing with brushes & *blown hot air)
Integral cable integrity sensing means (i.e. roughness)
   (i.e. force sensing means on slidable exterior contactor)
Boom camera allows viewing boom perspective
Registering angular displacement of pulley through which cable passes
Cable lockdown to prevent movement if problems detected

Support Cable extension/retraction means
Configured to sense cable force (cutout on over force)
Motor driven spool
Single spool with two segments, or dual spool, for use with dual cables
Mechanism for synchronizing multiple cable spools

Manual retraction over-ride (retract even if no motor power)
Conveying power and materials to washing head
Self-contained washing head
   self-contained fluids (wash water, waste water)
   self-contained supply of power (battery, fuel cell)
Extending/retracting an elongated supply connection
   bundle of power, *communication, *fluids (wash, waste), safety cable power supplied to washer head as a low voltage connection
      example: 12—48 VDC at a limited current (i.e. 1-5 amps)
         capacitors (batteries) in washing head support higher temp. loads
   extendable boom for conveying bundle from movable platform
   power disconnect in response to excessive pull force
   limited local reservoirs with fixed feed wash and waste couplings

Washer Head.

Preferably suspending on cables from extended booms from mobile platforms

Separator Means—keeps washing head at selected position to building surface
Integral sense of pressure between washing head and building (i.e. window)
Compliant wheels, rotating legs, articulating legs, bumpers, or combination
   *adherence means (vacuum, suction cups, nanomaterial (artificial Gecko))
Building graspers (i.e. window frames)
   pincher grasp on articulated arms

Local Height Adjustment Means (more accurate than spool)
Articulated cable connection assembly—adjust one or both
   can adjust rapidly to overcome wind instability or washing forces

Integral acceleration sensing (sense tilt, motion, free fall)

Washing Assembly
Scrubber—
   extend/retract; control applied pressure, adjust angle with surface
   control path of motion in scrubber
   control amount of fluid applied for scrubbing
      applied through a tube to the head, sprayed on, and/or dipped
   vibratory scrubbing motions (i.e. linear, rotational, orbital, combo)
Squeegee or wiper—
   extend/retract; control applied pressure, adjust angle with surface
   control path of motion in squeegee/wiper
   vacuum assist in liquid removal
      in combination with an air/water separator
   vibratory scrubbing motions (i.e. linear, rotational, orbital, combo)
Liquid limiter/collector—(prevent unwanted dripping overspray)
   extends to seal against a elongated horizontal portion of bldg (window)
   incorporates integral vacuum supply to draw of the water running down to it
      vacuum applied at interface with window
      air and water separator
Washing sensors—
   tilt and/or acceleration sensing
   locating by means of positioning system
      GPS and/or INS
         using a GPS with a local fixed reference (i.e. in platform garage)
   position sensing of actuators
   position of sensing of building structures
   detecting material on the building before and/or washing
      optical means of detecting debris (or water) materials
      optical imaging combined with signal processing
         imager with lens
         optical alert to personnel when camera active
         allow varying lens settings (focus, zoom, polarization angle)
         automated lens cleaning
         allow pan and tilt of the imager with lens
         determine damaged areas, areas to be recleaned, etc.
         communicate data and images to remote console
         communicate images for other purposes
         integral lighting means
         activate lighting visible, UV, IR, or combo
         direct position of lighting
         control lighting filters

Alerts—

Annunciate error or free fall conditions
error detected in response to acceleration sensing, system errors
lights and audio directed beneath unit

### 1.3 DETAILED DESCRIPTION OF DRAWINGS

FIG. 1 depicts an automated washing system 10 positioned on a building 12 which has a front edge 14 (with lip), with retention holes 15 into which support arms 16 have been manually positioned. The building face 18 comprises windows 20 and ledges 22.

A washing head 30 is shown with a housing 32, bumpers 34 (i.e. rollers), an optional grasping mechanism 36 to grasp structure to reduce movement during operations (preferably able to grasp horizontal structures and/or vertical structures, or structures at an arbitrary angle). Grasping only requiring in this context to apply a unidirectional force on a member in opposition to the upward cable retention force, although grasping can alternatively comprise applying a unidirection force by means of a suction device, or applying a multidirectional force for grabbing a portion of a structure to reduce movement of the unit. A washer assembly 38 within washing head 30 is shown for applying cleaning solutions and for removing liquids after cleaning.

An optional optical output beam 40 is shown with output 41 directed beneath said robowasher platform, such as outlining a warning area and preferably including a printed warning. The optical output can be a high intensity light source passed through a mask warning area, and preferably text indicating a warning message. The optical output device may comprise a laser directed through a mask, raster scanned, or outputting vector graphic patterns (i.e. using controllable mirror assemblies, rotating raster scanning bars, or other convenient means of directing graphics and/or text toward the ground. An optional audio output device 42 is shown with audio output 43 directed to the area beneath the unit. Preferably the audio is directed, such as by encoding the warning tones, and/or audio, as a frequency shift between multiple ultrasonic audio sources, wherein the highly directional beams overlap and the encoded audio can be heard only at the area of overlap of the audio beams, thereby minimizing disturbances to other parties. To assure that the pattern of light or sound is directed below the unit, despite said unit being tilted slightly in either plane, a movement stage and tilt sensor 39 (i.e. solid state acceleration sensor) may be coupled to direct the light source along the vertical extending from the bottom of the unit.

The washing head 30 is shown being suspended from a flexible track comprising cables 44, shown coupled through a pulley 46 to a motorized cable housing 48, such as moved on lockable wheels 49, thereby reducing the weight carried on the washing head and retaining the cables in a position where they are accessible to service personnel. It will be appreciated that conventional window washing platforms retain the drive motors and the spools of cables on the descending platform itself, because the parties most able to service the device are in the platform itself. However, in the case of the present invention if something fails, personnel can readily service the cable take up mechanism or manually crank up the cable by inserting a manual retraction crank 50 for pulling the washing head to the top of the building. Unlike conventional platforms that weigh many hundreds of pounds and are from twelve to fifteen feet long, the washing head may be as light as about ten pounds, although more typically is expected to be implemented at a weight of approximately twenty pounds to ninety pounds, which still allows a person to manually lift and carry the unit from one location to another.

The diagram shows an installation in which generally conventional pulley system are shown manually attached to the side of a building. Therein requiring the unit to be setup for doing a vertical section of one to a few downward passes from the same cable position. Once that portion is completed, such as after a few hours on a thirty story building, personnel must bring washing head 30 onto the top of the building (i.e. swinging it over with by rotating the supports) and remove the supports for attachment to a new position. It will be appreciated that these actions can be generally performed by normal building maintenance personnel in the course of their usual maintenance activities, wherein specific persons need not be hired to perform the window washing. However, it should be recognized that a mistake in handling these heavy supports can lead to them falling from the building subjecting passersby to injury or death and less importantly causing damage to the building.

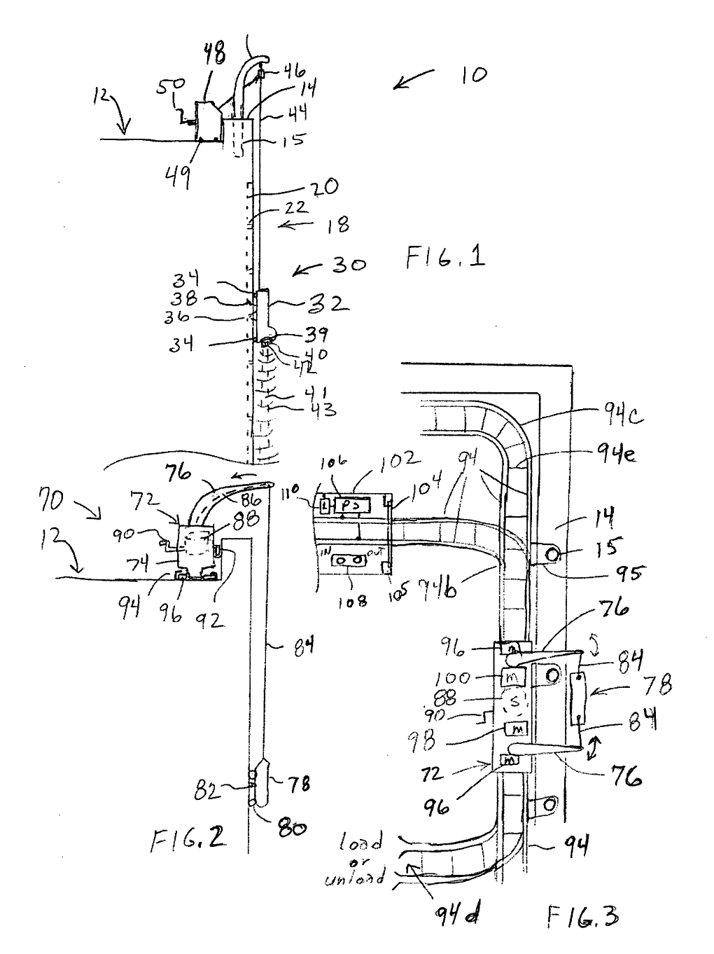

FIG. 2-3 illustrate a preferred embodiment of an automated cleaning system 70 having a movable platform configured to move in a track and coupled to a washing head. This system is capable of washing the exterior of an entire level of the building, having multiple sides without the need of manual intervention. Movable platform 72 has a housing 74 and is coupled to one or more preferably two articulated boom arms 76, preferably rotatable although the booms may be additionally or alternatively extendable, for supporting the washing head 78, which is held in separation from building 12 by wheels 80 preferably configured with articulated axles allowing the distance and angle between the platform and the face of the building, preferably windows, to be adjusted for optimal cleaning by the washing (and preferably drying) assembly 82. A flexible track 84, such as a cable made of steel, Kevlar or another material having a sufficient tensile strength to support washing head 78, (i.e. ≧20X-50X the weight of washing head 78 for each cable side).

Flexible track 84 (hereinafter referred to as a cable) can be taken up or let out under the control of a means for extending or retracting cable 84, which is preferably contained in movable base 72. Although cable 84 can be retracted (extended) over rails, pulleys, or other redirecting devices coupled toward the ends of boom arms 76, it is preferable that they be retracted (extended) through a portion 86 of boom arms 76 for extension or retraction from motorized spool 88, wherein it is less likely that cable entanglements will arise during extension or retrieval. Furthermore cable 84 is better protected when shrouded in boom arms 76. It is preferable that a means for clearing liquid and debris from cable 84 be provided so that the flexible track will be stored dry and clean, wherein it is less likely to either freeze onto other segment of the flexible track or housing or otherwise foul the mechanism within the housing. For example a set of brushes, drying collar, or even a heated blast of air may be directed over cable 84 prior to it entering movable base 72. The height of boom arms 76 is preferably configured to allow retracting washing head 78 to a sufficient height to clear wall lip 14 and be swung over movable base 72 for storage and movement.

Motorized spool 88 may be configured in a number of alternative ways. Preferably separate take-up spools are driven by separate motor and electronic drive assemblies. Optionally, the spool, or spools, can be configured with a winding guide which assures that the cable is uniformly wound on the spool, such as winding the cable to depth n on the spool before winding any portions of the spool at depth n+1. Spool winding are known to those of ordinary skill in the art. It is preferred that the movement of the cable being extended or retracted from the spools being synchronized by registering the movement of the cable from the end of the, such as the rotation of the pulley on the tip of the boom. It will be appreciated that length of cable extended or retracted from the spool is not an accurate measure since overlapping layers of cable have different circumferential lengths. The separate spools and electronics provide a redundancy that enhances safety. It should be appreciated that unlike a conventional platform, washing head 78 can be retracted to the top of the building using a motor drive, although manual intervention to aid in loading the washing head onto movable platform 72 along with excess cable would be prudent in such a failure case. If both spools are subject to failure, then the present system provides a manual retraction device, herein shown as an insertable crank handle 90.

It should be appreciated that the motorized spool may be implemented in a number of alternative ways. For example a single spool with separate bobbin sections for each cable, separate spools driven by the same motor and/or drive mechanism.

A rolling bumper 92 is shown coupled to the front face of movable platform 72 to roll against the inner wall of the building. Optionally the inner portion of the wall may be configured with a horizontal railing for supporting a rolling wheel and supporting a portion of the system load when in use. A fixed track 94 is coupled to the roof of the building for retaining a set of wheels 96 or other slidable engageable means. The wheels are configured for engaging the track wherein very limited vertical displacement is allowed, such as less than one-eighth to one-quarter inch. For example a set of wheels can be retained within a channel of track 94, or a set of wheels may be retained over and under a horizontal rail on track 94. A sufficient number of the wheels are preferably adapted for being driven by a motorized drive under the control of the movable platform computer. In FIG. 3 a number of aspects of fixed track 94 are readily seen. A switching section 94b allows movable platform 72 to be moved on and off of a section of track.

The switch between rails can be configured as an actuator on the rail, or more preferably an actuator on the platform, such as a movable extending protrusion, which triggers the track switch in a desired direction. Curvature of sections of track 94c are shown allowing movable platform 72 to traverse a number of faces of the building. If portions very near the corners of the building are to be cleaned than the boom arms can be made longer, or extended, (i.e. kept slightly canted inward otherwise to define proper washing head to building distance). The ability of moving movable platform 72 with washing head 78 around to each face of the building from the given roof section allows fully autonomous operation from that roof section. Movable platform 72 may be coupled or uncoupled from track 94 at track section 94d. For example for service, or for moving it to other roof portions of the building for cleaning other exterior portions of the building. Movable platform is preferable sufficiently compact to be rolled from the track into an elevator. Alternatively, movable platform 72 may be configured to separate into multiple sections, to reduce the linear elevator space necessary for loading. Optional braces 94e are shown retaining the two sides of track 94 an appropriate distance apart. An optional track reinforcement 95 is shown which is inserted into existing post holes 15 and attached to portions of the track to aid in securing the track to roof section.

Boom rotational drive motors 96 are shown for controlling the rotation of booms 76 for adjusting the distance of washing head 78 from the building and for aiding the deployment and retrieval of washing head 78 over the lip of building 12 to and from the face of building 12. A single spool 88 is shown with a single extension and retraction drive motor assembly 100. In this embodiment no additional lines are coupled to washing head 78, which is either powered from batteries, receives power through the connection cables, or a combination thereof.

A base station 102 is shown on the roof section of the building for storing movable platform 72 upon which washing head 78 has been docked. An automatic door 104 preferably encloses the base station, driven by motors 105, keeping the movable platform out of the elements. Base station 102 is shown with a power supply 106 coupled to the rails (or a power take off adjacent to or between the rails) for powering movable platform, in addition to or as an alternative to charging batteries within the movable platform. If a power pickup adjacent or between the rails is utilized then it may be configured with specific locations along its length at which the movable platform can connect to the power source. In this way power for moving the movable platform is drawn from batteries or capacitors, but before power is available for deploying the washing head the movable platform must be positioned properly for connecting to power, this proper positioning being in alignment with the vertical pattern by which the windows are to be cleaned.

Fluid couplings 108 are shown in base station 102 for transferring fluids to and from the movable platform, for example loading additional washing liquid and draining waste water. The washing fluid preferable comprises water, preferably filtered and optionally distilled, entrained with ozone, or otherwise modified in any convenient manner to aid in its use for washing building parts. Detergents or other agents may be added to the water from a reservoir at the base station or within movable platform 72. A LAN 110 is shown within base station 102 for communicating with the movable platform, such as by way of power line communications through the power supplied through or adjacent to track 94 to movable platform 72. The LAN may also communicate with movable platform 72 in any other convenient manner, such as wirelessly. The LAN is preferably connected to a wired LAN connection for the building, or less preferably a wireless LAN connection for the building.

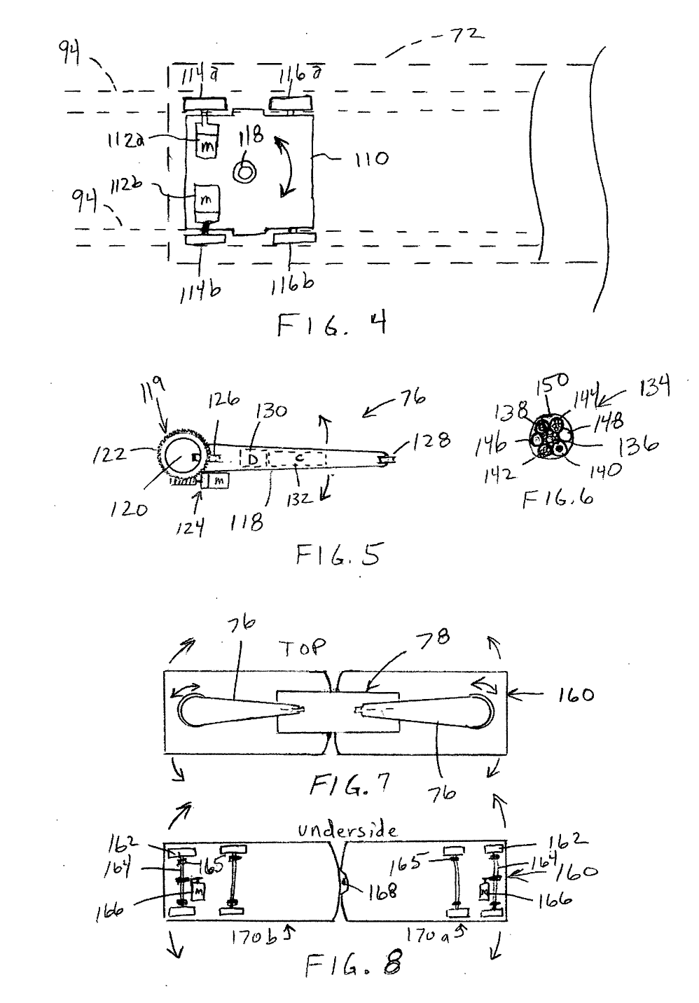

FIG. 4 is an example of a drive wheel assembly shown attached to a rotatable carrier 110 attached to the base of movable platform 72. Preferably a rotatable carrier assembly is attached to each end of movable platform 72. Drive actuators, such as geared motors 112a, 112b are configured for providing a motive force upon drive wheels 112a, 112b, which are engaged within track section 94, along with free wheels 116a, 116b. A swivel 118 allows carrier 110 to rotate allowing movable platform 72 to navigate rounded corners in track 94, including curved section 94c.

FIG. 5 depicts a fixed length rotatable boom arm 76 having an elongated arm 118, preferably a hollow tapered steel arm, which terminates at a base 119 having opening 120 and configured for being rotated by a drive mechanism, such as surrounded by a gear teeth 122 engaged by the gearing (worm gear shown) from a motorized drive assembly 124. Two pulleys are shown within the boom, a first pulley 126 near the upright portion of boom arm 76 and another pulley 128 at the tip of the boom 76. The rotation of pulley 126 or 128 is preferably detected by the system for tracking the extension and retraction of cable 84 to washing head 78 from movable platform 78. An optional detector 130 is shown within boom arm 76 for detecting damage to the cable being extended or retrieved. The detector can utilize piezoelectric feelers for determining roughness loose strands and so forth, alternatively, any convenient form of switches, pressure sensors and the like can be selected. Detector 130 may include a locking mechanism, allows the unit to lock down the cable at a given location in response to detecting a cable problem. This allows personnel to inspect the cable prior to retrieving the washing head. More preferably, upon detecting a cable problem, the location is stored (in response to how much cable has been played out) and the washing head is retrieved. The system can allow personnel from the remote location to make the decision whether to retract the washing head or await inspection and/or service. An optional cable cleaning assembly 132 is shown coupled within boom 76 for removing water and debris from cable 84 as it is retracted. By way of example brushes, bushings, wipers or the like may be utilized for removing contaminants from cable 84. Optionally a heated air source can be directed at the cable to blow off liquids and dry the cable as appropriate. Optionally, a lubricant dispensing system, such as a sprayer can be included for dispensing a liquid or solid for properly conditioning the cable prior to it being wound on the takeup spool.

FIG. 6 illustrates the use of a supply tether 134 which can be coupled to washing head 78, if it is not configured for self contained power and fluid. A central wound cable 136 is shown about which supply cables are routed with a power leads 138, 140 (i.e. DC power and ground, or AC connections), signal connection bundles 142, 144, fluid connections 146, 148 (fluid in and out). A shield 150 preferably encases these elements to provide protection from the elements and to ensure integrity, the shield may be plastic but preferably incorporates abrasion resistant material on the exterior. The supply tether may be heated along its length by incorporating a distributed electrical heater, or other heater arrangement, so that heated fluids can be received at the washing head and to reduce brittleness of the supply tether layers in cold weather conditions.

FIG. 7 and FIG. 8 depict another embodiment 160 of the movable platform, herein shown articulated for traversing track corners 94c. In FIG. 7 a top view is shown With washing head 78 shown positioned on (or over) movable platform 160 in a stored position. Booms 76 have been rotated toward one another for moving washing head from a deployed position to a storage position over the movable platform. In FIG. 8 an underside view is depicted with wheels 162 coupled to axles 164 rotating in bearing assemblies 165 attached to the underside of movable platform 160 and driven by motor assemblies 166. An articulated joint 168 is shown coupling the first and second sections 170a, 170b of movable platform 160. It should be appreciated that articulation may be accomplished utilizing any convenient articulation assemblage, with any desired number of sections. The movable platform 160 of FIG. 8 is shown with fixed wheels, however, it should be appreciated that the wheels on an articulated movable platform 160 may be configured for movement, such as shown in FIG. 4, or using any other similar rotational mechanism.

FIG. 9 and FIG. 10 depict an articulated balancing system 170 coupled to washing head 78. This mechanism allows for moving weights and/or wings (or similar wind directing devices) in response to conditions, such as tilt, to improve the balance or position of washing head 78, or to alter the amount of force being applied to the surface of the building (i.e. window) being cleaned. Multiple weights 174a, 174b are shown coupled to extensions 176a, 176b attached to actuators 178a, 178b of washing head 78. The position of each weight can be repositioned, such as from position A through positions B and C. When washing head 78 is against the surface of the building actuator 178a, 178b may be configured to limit the extent of movement in that direction to A′. It should be appreciated that the equilibrium position for the center of mass of washing head 78 is directly beneath the exit end of pulley 128. By altering the position of the weights the balance of washing head 78 may be altered and the force applied to the windows (or other building surfaces) modulated. The position of the weights may be modulated in response to tilt information, sensed wind information, pressure sensors sensing the pressure applied between the washing head and the building and so forth. It should be appreciated that airflow directing means may be additionally, or alternatively coupled to the actuators. Although the balancing system is shown with two weights, each capable of moving in an arc from a central pivot, it should be appreciated that any form of actuator for displacing the weights, or airflow surfaces, may be utilized without departing from the teachings of the invention.

FIG. 11 illustrates an example of a means for determining the pressure being applied between the washing head and the window (or other building surface) 190. It is important that the pressure applied to the window be well controlled in every condition of operation, wherein the window will not damaged or unduly stressed. It should be appreciated that the strength of a window subjected to excessive force is compromised, even though no visible signs of the stress, such as cracking are visible.

An example of stress weakening was graphically demonstrated by an individual in Chicago that periodically demonstrated the strength of the glass windows in his 32nd floor office to visitors. He would run up and bang the side of his body against the window. This demonstration was performed the same way a number of times on the same window with no visible sign of adverse effects. On his last demonstration his body went right through the stress-weakened window and he fell to his death.

It is important, therefore, to closely monitor the pressure being applied to a window surface, and to modulate the operation of the device so that undue stresses are not applied to the windows. The weight shifting (or air flow directing devices) movable coupled to the washing head 78, as shown in FIG. 9 and FIG. 10 can move readily in response to wind conditions, movement of washing head 78 or other factors to maintain a given pressure between the washing head and windows.

By way of example the pressure sensor is shown coupled within a window-washing head separator, shown implemented with compliant wheels. Compliant wheels 191 are depicted with a core 192 of a first material, which is surrounded by a wheel exterior 194 of a second material which is more compliant (spongy) than the first material. An axle 196 passes through core 192 allowing the wheel to rotate. Axle 196 is shown slidably engaged in a track 198 and biased into an extended position by spring 200. The wheels thereby can be compressed in response to pressure application while spring 200 may also be compressed. A pressure sensor 202 is shown coupled to the biasing spring wherein it can register changes from the base level bias pressure when the wheel is fully extended. It should be recognized that the force/pressure sensing means of the present aspect of the invention may be embodied in a number of alternative ways without departing from the teachings of the present invention.

FIG. 12 illustrates by way of example another form 210 of means for separating the washing head from the window or building surface, depicted with extended fixed legs terminating in pads for interfacing with the building surface. Extended legs 212 are shown terminating in pads 214, 216, which may comprise compliant elements, and/or may include structures for aiding retention against the surface of the building. By way of example pad 214 is shown configured with an artificial gripping surface which has been recently developed as a micro or nanostructure modeled after the feet of a gecko with closely spaced gripper nibs. Another form of gripped is that of a suction cup 216, which may be operated conventionally, or more preferably is coupled through tubing to a vacuum and pressure source. The grip can be actuated by activating the vacuum source to draw the suction cup against the window, and release by releasing the vacuum or alternatively applying positive air pressure. It should be realized that the active suction cups may be implemented in a number of ways on the present invention for gripping the building surface. By way of example suction cups may be built into rolling wheels, extend from a gripper bar, or otherwise deployed for stabilizing the washing head during the washing process.

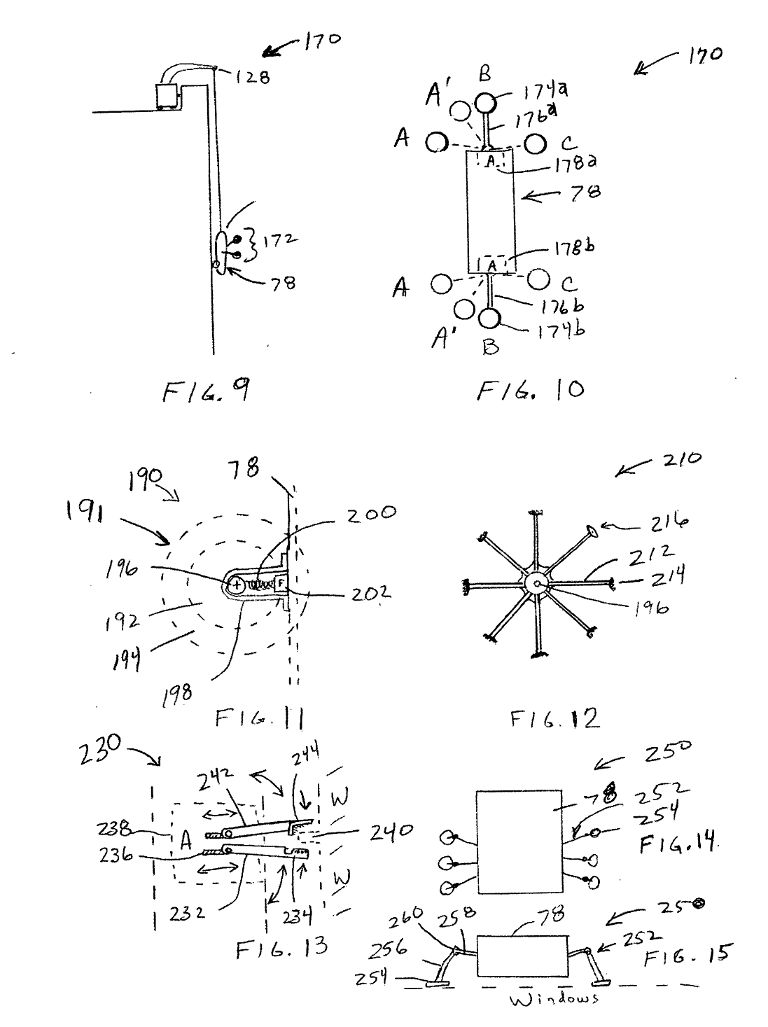

FIG. 13 illustrates by way of example another form of gripper 230 which can operate in a number of alternative ways. An elongated arm 232 is shown with a frame gripping end 234, such as having a non-marring compliant surface. Arm 232 is configured with a means for being extended and retracted, such as through slot 236 coupled to actuator 238 which also controls the rotation of arm 232. Arm 230 may be utilized for applying a pressure to a window frame element 240 which acts opposite to the force applied by cables 84, retaining the washing head in a stable position. It will be appreciated that once arm 232 is rotated to engaged and apply pressure against frame 240, that the arm can be retracted or extended to alter the position of washing head 78 relative to the window. The use of a second arm 242 with compliant head 244 controlled by actuator 238 can more securely grasp a window frame surface, wherein it need not rely on the tension in cable 84, therefore providing a more secure means of stabilizing the washing head and controlling the distance between the washing head and the windows (or other surfaces being cleaned) of the building.

FIG. 14 and FIG. 15 illustrate by way of example another separator mechanism 250 which utilizes articulated legs 252 which extend from washing head 78, and to which pads 254 are attached. The legs 252 are shown with a first leg portion 256, joined to a second leg portion 258 at a joint 260. Actuators may be located in the housing and in each joint, or the power for changing leg position may be more preferably applied remotely by mechanical forces applied to small cables or the use of miniature hydraulics. One preferred way of modulating the position of the legs is with the use of muscle fibers which are configured to contract in response to the application of an electrical potential. It should be appreciated that any form of walking mechanism may be selected, and that robotic walking mechanisms are known in the art.

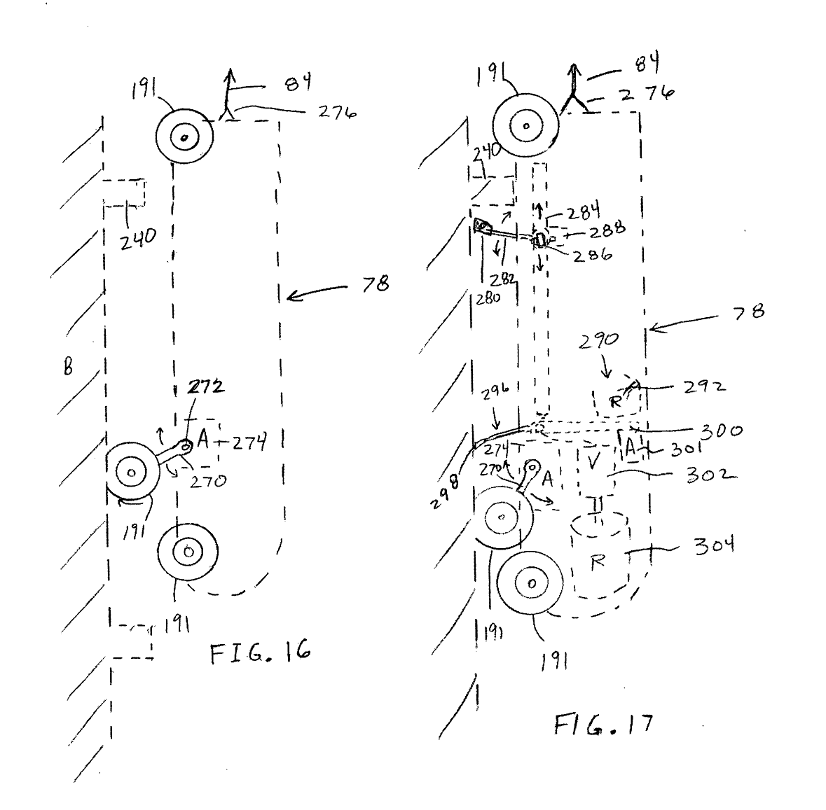

FIG. 16 and FIG. 17 illustrate by way of example maintaining of selective separation between washing head 78 and windows or other building surfaces B. Pairs of compliant separators, depicted as wheels 191 are shown extending from washing head 78 to contact the building surface. Wheels extend from the ends of washing head 78 to prevent the ends of washing head 78 from striking or hanging up on window frames and other structure extending from the building. One set of wheels 191 is shown attached to rotating arms 270 through axle 272 and coupled to an actuator 274 preferably configured for being moved under program control when moving the washing head along the face of the building. Washing head 78 is vertically supported by cable 84 coupled through attachments 276. In FIG. 16 at the position shown, arm 270 is shown almost fully extended which maintains washing head 78 away from the face of the building. Once positioned for cleaning arm 270 is rotated wherein washing head 78 moves into position nearer the building surface, in this case shown with a portion of washing head 78 resting against window frame 240. In this position a washing assembly can actively wash the window, or face, of the building. By way of example, a scrubber and/or squeegee head 280 mounted to arm 282 is shown coupled to a track 284 rotating mechanism 286 and actuator 288 for moving the scrubber or squeegee against the surface of the building, such as window surfaces. Liquid for the scrubber may be applied by a liquid supply hose (not shown) or the scrubber may be washed in a reservoir of liquid 290 wherein particulates may be removed from the scrubber surface, preferably in response to being sprayed off by a spraying head 292 located within reservoir 290. An optional vacuum arm 296 is shown extending with an elongated compliant head 298 for making contact across a horizontal portion of the window (or building surface) wherein any water falling from the scrubber, or during the squeegee operation are collected by vacuum head 298 and thereby do not drip on nearby window surfaces. A vacuum pump 302 is shown coupled to vacuum head 298 with the liquids being drawn off into a waste water reservoir 304, after the air is separated from the water, such as by utilizing cyclone spin techniques. Vacuum arm 296 is configured to be extended and retracted along a track 300 which is driven by an actuator 301.

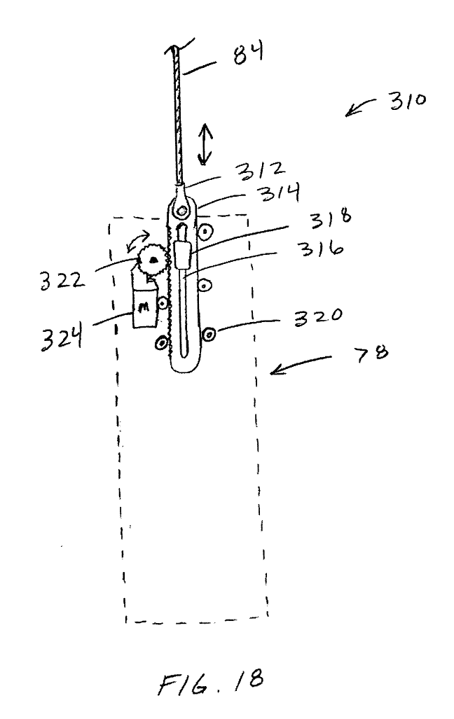

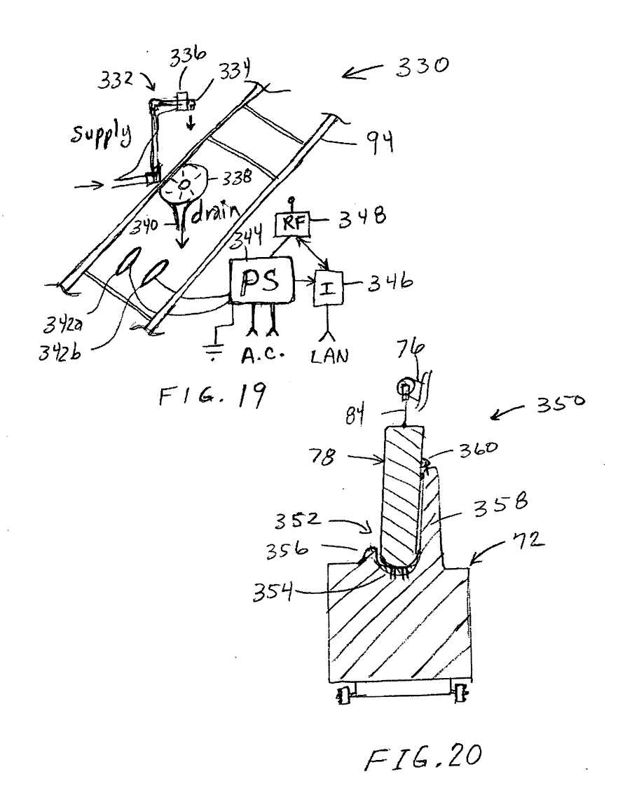

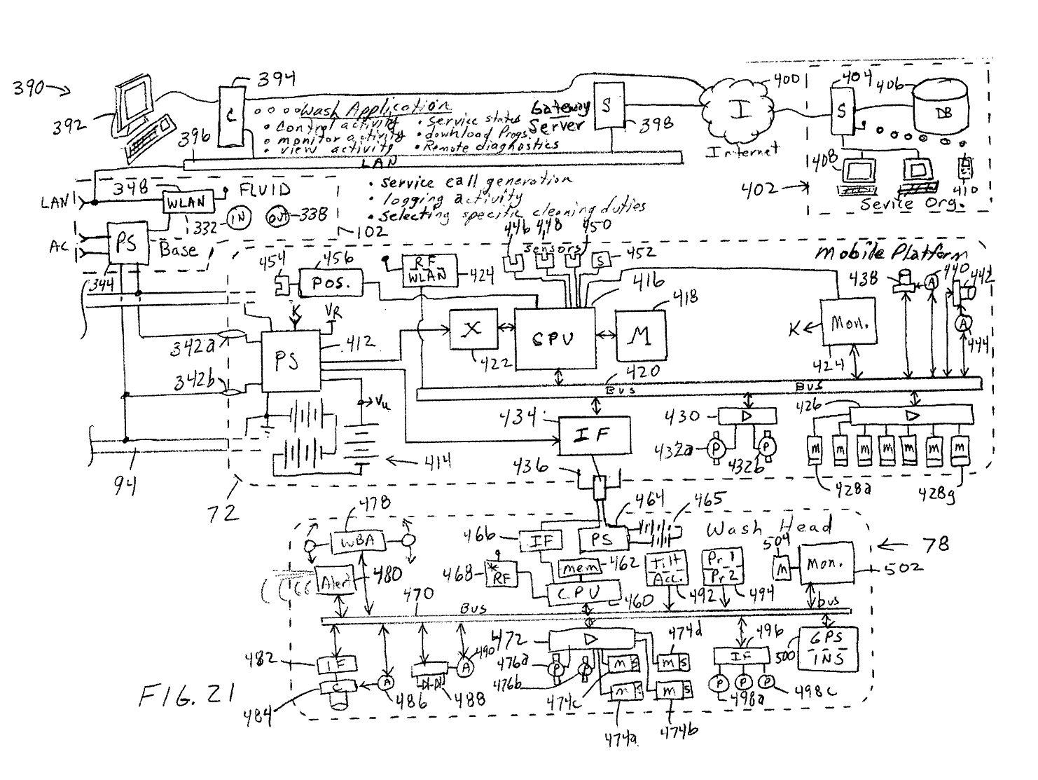

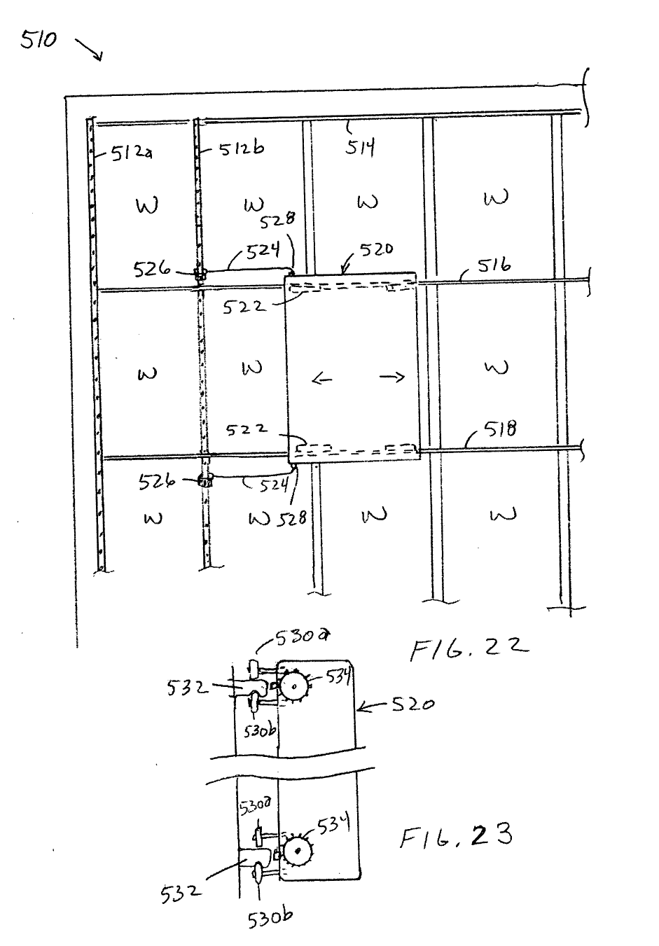

FIG. 18 illustrates an example of a means for making small corrections to the height of washing head 78. Cable 84 (only a cable on a first side are depicted) is shown coupled through a connector 312 and a swiveling attachment to a positioning assembly 314 (vertical extension arm). A slot 316 runs through the center of positioning assembly 314 into which a (T cross-section) keeper 318 is retained allowing vertical movement but in any case preventing arm 314 from separating from washing head 78. Stabilizing rollers 320 are shown along arm 314 to provide for smooth extension and retraction movements. A means for driving the extension and retraction is depicted with a gear 322 configured for engaging arm 314 and an actuator, such as a geared motor 324, which engages the gear for extending and retracting arm 314.

FIG. 19 depicts a movable platform base station 330. A fluids exchange means 332 is shown with a washing fluid supply pipe coupled to nozzle 334 through a controllable valve 336. Preferably the liquid is supplied from above movable platform 72, such as through a elastomeric flap, to simplify sealing of the fluid reservoir. Chemicals, or changes to the water itself (i.e. distilling or adding ozone) may be performed at the base station or within the movable platform, without departing from the inventions. A basin 338 is shown with drain 340 for directed waste water away from washing head 78, such as into a drain. By placing the fluid supply output and drain vertically coaxially, any leakage from the source will be captured by the drain when the movable platform is not within the base station. As previously described, power may be supplied continuously to the movable platform, such as through rails 94, or it may more preferably be supplied when the movable platform 72 is retained at the base station wherein the batteries may be properly charged. A set of contact paddles 342a, 342b are shown coupled to a power supply 344 receiving power from the AC of the building. Contact paddles 342a, 342b are configured for engaging leaf contacts on the edge or underside of movable platform 72 wherein power is supplied through a power controller for charging the batteries of movable platform 72. A communications interface 346 is shown for coupling with a local area network for communicating with a remote operator console, and through a communication link, such as RF transceiver 348 with movable platform 72 (alternatively communications may be transmitted and received through track 94 or other wired or wireless connection).

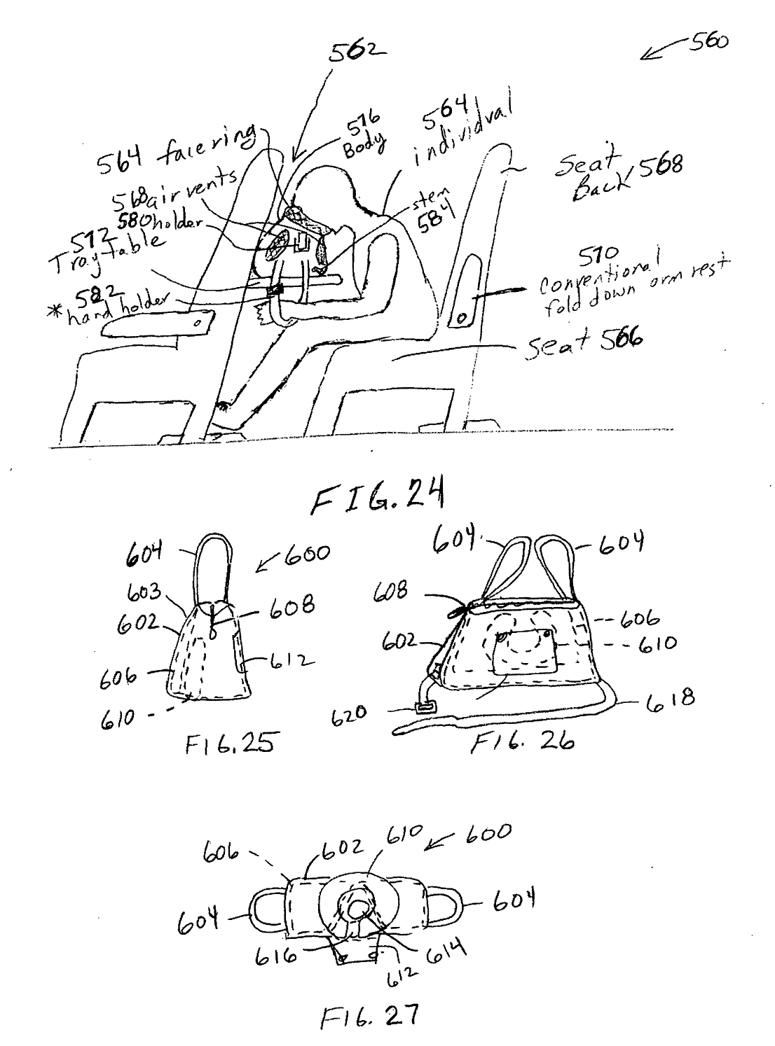

FIG. 20 illustrates an example of mounting washing head 78 to the movable platform 72. The top of movable platform 72 is configured for securely receiving washing head 78 (although it can less preferably sit suspended on cables 84). A recess 354 on movable platform 72 is shown bounded by a small first lip 356 and a larger second lip structure 358 against which the weight of the washing head can rest when lowered onto movable platform 72. A locking engagement means 360 is shown for securing the washing head to the moveable platform thereby preventing it from falling during transit or storage. It is preferable that locking means 360 comprise be automatically engaged as washing head 78 rests against second lip 358, and be disengaged in response to program control, such as by means of an actuator for instance a solenoid, thereby allowing release of the washing head for deployment.

FIG. 21 illustrates by way of example a block diagram of the electronics 390 for the automated building cleaning system. A remote operator console 392 is shown (cleaning application programming for the present invention may be run from any of a number of authorized consoles in the building), allowing building personnel (i.e. maintenance and/or security) to control the cleaning system and to monitor its activity, in a preferred embodiment without the need to dispatch personnel to the roof during any normal cleaning operation. The remote console 392 is shown connected to computer 394 upon which the programming for the automated building cleaning system may be executed, or it may be executed from a server with console 392 serving only for input and output. Computer 394 may be coupled to a local area network (LAN) 396 within the building or coupled directly or through a switch, firewall, gateway, or so forth to the Internet 400. A server 398 is shown on LAN 396 which may be used to connect to the Internet 400. Application programming of the present system is configured for communicating aspects of device operation and service with a remote service organization 402 having a presence over the Internet. The service organization is configured with a web server 404 and a client database 406 containing authentication information for its clients and information about client systems. Service consoles, such as personal computers or laptops 408 and/or personal digital assistants 410 are shown allowing persons in the service organization to aid in the operations of the remote automated building cleaning system.

Base station 102 is shown coupled to power and to the LAN connection for communicating with operators at remote consoles and the remote service organization.

Movable platform 72 is shown coupled to track 94 and either receiving continuous power, such as through track 94 to power supply 412, or receiving power through connections 342a, 342b, at the base station for charging battery power supplies 414. At least one computer 416 (i.e. microcomputer, microcontroller, digital signal processor, etc.) in combination with memory 418 is preferably contained on movable platform 72 for controlling the operations of the platform and washing head 78. A local bus 420 routes signals to other modules with movable platform 72. An extraction module 422 is shown for extracting commands encoded over power supplied through the track, if power is indeed supplied over the track. Otherwise, an RF LAN 424 can provide the communication between movable platform 72 and the LAN connection with base station 102 which is coupled to the wired LAN of the building thereby providing access to the remote operations console with an application program for operating the present invention. It is preferred that the programming contained within memory 418 be sufficient for carrying out a command received from the remote operations console and for performing every necessary emergency operation, even if the connection with remote operator consoles is severed. The remote operator console performs the interfacing with the user and performs all necessary database and historical functionality. During operation data is regularly communicated from the movable platform to the application programming for tracking, monitoring, and storing historical information on a computer accessible to the operator console.

An optional monitoring circuit 424 is shown coupled to the local bus 420 for monitoring the activity of movable platform 72 to assure that it is operating correctly. The monitor can preferably modulate the state of computer 416 (or limit it to certain command executions), perform resets, or even lockout power to the movable platform. Alternatively, multiple processors may be utilized, wherein should one processor fail the other processors can continue with correct operations. A actuator and motor controller 426 is shown for controlling the activity of a number of actuators or motors, shown as motors 428a through 428g. These motors each preferably include position sensing feedback (i.e. sensors, stepping motors, feedback pots, etc.), wherein separate motor position sensing is not shown. Example of motor/actuators within the present system include drive wheel rotation, rotating each boom arm, extension/retraction of boom arms, extending or retracting cables to support the washing head, moving a track switching device (changing direction of movable platform on track 94), and so forth. A controller 430 is shown for controlling pumps 432a and 432b for moving fluids to and from washing head 78. An interface 434 is shown for communicating with washing head 78, shown as a wired connection through a spool 436 although a wireless connection may be utilized for a self-contained washer head.

A number of sensors are preferably provided on movable platform 72, the following being described by way of example. One or more imaging systems, such as camera 438 with mechanical actuator 440 (i.e. pan, tilt and focus control, and optional lighting) and a second imaging device 442 with similar actuator 444, each with optional lighting. Sensor 446, 448, such as optical sensors, detect the motion of the pulleys 128 through which the cable is extended or retracted while another sensor 450 detects the motion of the cable spool (or spools). A sensor (or collection of sensors) 452 provides for sensing external conditions. A positioning sensing assembly includes a sensor 454 for detecting positions along track 94, such as when movable platform is aligned with the windows for deployment, and optionally a general position sensing system 456, such as GPS or INS.

Washing head 78 is also preferably controlled by at least one processing element 460 (i.e. computer, microprocessor, microcontroller, DSPs, etc.) in combination with memory 462. A power supply 464 receives power over a wired connection from the movable platform, and/or batteries 465. An interface 466 extracts commands from the power line or alternatively prepares data for CPU 460. An RF link 468 may be utilized, in particular with self-contained washing head for communicating with movable platform 72. CPU 460 communicates with modules in washing head 78 over a local bus 470.

An actuator/motor controller 472 preferably controls actuations from washing head 78 such as motors 474a-474d and pumps 476a, 476b. Preferably the following mechanical actuations are controlled within washing head 78. Moving of scrubber(s), and squeegee(s), positioning of vacuum liquid removal device, pumping cleaning fluid to scrubber, generating vacuum for drawing off water, and/or drawings a suction to adhere a separator means extending from washing head to window surface. Furthermore actuators may be utilized for controlling the extension and retraction of the cable such as shown on FIG. 18. A weight control actuator 478 is shown along with an optional alert package 480 containing lighting and/or audio alerts along with any necessary sensors. Image sensors (i.e. still, multiframe, or video) are shown coupled to washing head 78, exemplified with an interface 482 coupled to a camera 484 and an actuator 484 (i.e. pan, tilt, zoom, focus, etc.). Optional lighting 488 is shown with a positioning actuator 490. It will be appreciated that the intensity and nature (i.e. wavelength, polarization, etc.) of the lighting can be preferably altered to improve image response. Other sensors are preferably included such as a tilt sensor and/or accelerometer 442 which allows determining both the motion and steady state tilt of the washing head by CPU 460. Pressure sensors 494 for each cable allow determining tension. A controller 496 with pressure sensors 498a-498c allow sensing the pressure being applied by the scrubber, squeegee, and vacuum bar to the surface of the building. An absolute positioning system 500 is shown such as comprising a GPS and/or INS system which allows the system through CPU 460 to determine the precise position of the washing head (although this can be determined in response to the position of the movable platform and the amount of extension of the cables). It is preferred that important information be supplied redundantly, such as positioning as described above, wherein system problems can be readily detected in response to a disagreement between reporting. Along that same lines a monitoring module 502 with memory 504 is preferably coupled to the washing head electronics to monitor actions and override actions, or deploy emergency control actions if CPU 460 is disabled.

It should be appreciated that the block diagram of FIG. 21 depicts an example embodiment of the present invention, not all the features described need be implemented, while other features described elsewhere, or known in the art can be coupled to the system without departing from the teachings of the present invention.

System programming, executed within the movable platform, washing head, remote console, or a combination thereof executes on one or more computers for performing a number of functions, such as the following. (a) receiving a command to clean at least one area on the exterior of said building; (b) determining a movement path to said area to be cleaned according to building mapping information retained in the memory of said computer, or computers; (c) advancing said platform along said path to said area to be cleaned; (d) applying a liquid cleaner to said area; and (e) removing said liquid cleaner after said area is cleaned. Location information can be collected from positioning parameters received from sensors or the devices, such as tracking of the motions of the drive wheels and discrete position sensors of the movable platform, along with sensor registration of the amount of flexible track (i.e. cable) extended from the movable platform to the washing head. Location information may be generated or checked by means of a positioning system, such as a GPS or INS (optional reference generator if higher accuracy desired). Mapping for the building is preferably generated at the time the system is installed which details what is to be cleaned, the traversal paths for reaching each section, the parameters and details necessary to properly clean each section and so forth. Once operating these parameters may be optimized by the system, (in an automated approach wherein it learns what works best for each location and situation) or in a manual or semi-automatic learning mode wherein an operator has inputs on tweaking the operation of the system.

### 1.3.1 ALTERNATIVE FIXED TRACK EMBODIMENT

Although the description above refers to deploying a washing head from flexible cables extending from a movable platform, the washing head may be deployed over a fixed set of tracks coupled to the face of the building, the following describing aspects of that embodiment.

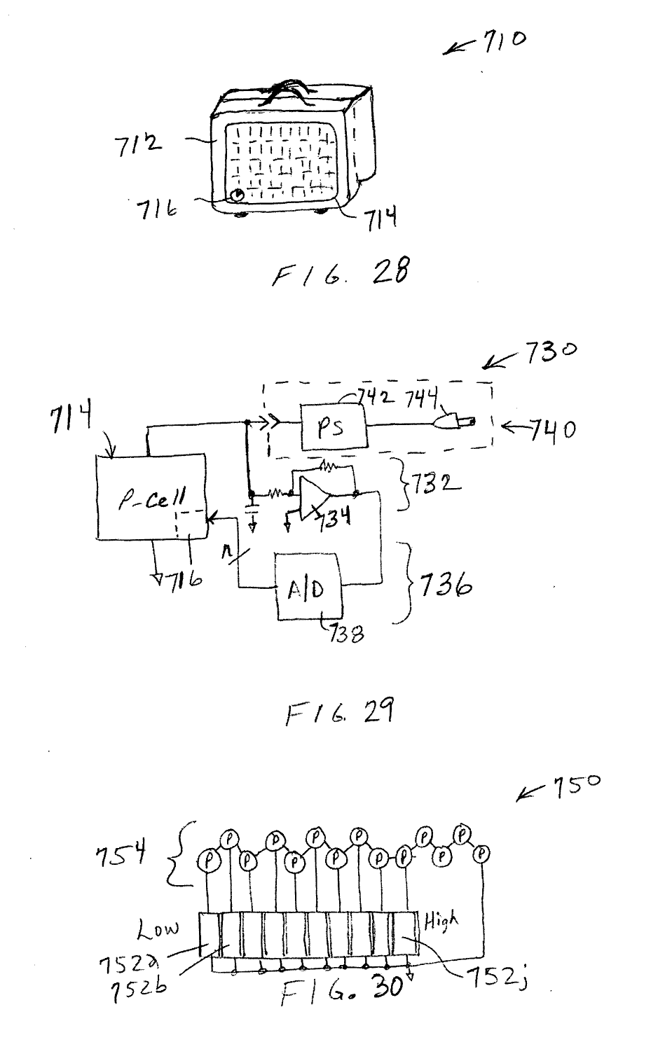

FIG. 22 depicts a set of windows 510 configured with fixed tracks upon which a movable platform with washing head can traverse the face of the building. The track may be coupled to the window frames allowing vertical and or lateral motion. A vertical track section 512a, 512b is shown with engagement apertures, (or protrusions, or other form of engagement structures) and a horizontal track 514, 516, 518 between each of the windows. This embodiment allows a moving platform with attached washing head 520 to traverse vertically to a desired row of windows, and then to separate from the vertical track and coupled onto the a horizontal track, 514-516, 516-518, and so forth, to access each window along a horizontal path. In the embodiment shown the moving platform and washing head are fixedly coupled together, however, the movable platform may remain attached to the vertical track while the washing head engages the horizontal rails and separates from the moving platform for cleaning a horizontal section of windows.

With the windows being washed horizontally, problems with spilling or overspray are minimized in relation to the conventional vertical row deployment used by manual window washers, wherein overspray from one vertical row can splash onto another vertical row that was already cleaned. In this embodiment washing head 520 is constrained to horizontal motion once it leaves vertical tracks 512a, 512b. To ascend or descend the unit moves to the far left away from the windows and rolls over and engages a vertical track wherein sprocket wheels (or similar) are deployed and with the window section not obstructing removal of the horizontal drive rollers the rollers are disengaged and the unit vertically traverses the track.

Safety connection means is shown by way of cables 524 coupled to tension collars 526 slidably engaged and locked onto vertical tracks 512a, 512b. As washing head 520 moves horizontally cable 524 extends from controlled takeup spools 528 on washing head 520. In the unlikely event that washing head separated from either the horizontal or vertical track, it would be suspended by the cables extending from the washing head. The takeup spool may also be engaged for pulling washing head 520 back to the vertical track section immediately upon sensing a loss in traction or a vertical displacement of the washing head while it traverses the horizontal rails.

FIG. 23 depicts a cross section view of washing head 520 showing the rollers 530a engaging the track with a second set of rollers 530b opposing the first to provide securement on horizontal rail 532. It will be appreciated that many different horizontal rail shapes may be utilized for securely moving washing head horizontally across the window surface. The washing head engaged the exterior of the track shown, however, sliders or drive wheels may be coupled into the interior of a horizontal frame section so long as at least one slot is provided for coupling the slider/wheel with the washing head.

A captive slider/wheel has the advantage of only being able to engage or disengage from the horizontal track at the location where it begins to disengage from the vertical track. Drive sprockets 534 are visible for engaging the vertical tracks 512a, 512b in moving from one section to another. As the horizontal drive wheels 530a, 530b engage the horizontal rail, such as by extending and closing down on the rail, the drive sprocket can then retract from the vertical track. By extending three sets of wheels on both the top and bottom of washing head 520, the center set can be retracted for passing over the vertical rail, and then the center coupled to it and the left most set retracted until the entire washing head has moved past the vertical railing.

Although the washing head may have a self-contained power source it may additionally receive power from power couplings which are accessible on the vertical track and/or the horizontal track. Washing head 520 may also be powered by a fuel cell, which generates a fixed power output X for charging a battery and/or set of capacitors, thereby allowing power consumption to exceed X for periods of time, insofar as power is available in the batteries or capacitors. The above power supply aspects apply to all embodiments of the invention, fixed track or flexible track.

In a similar manner as the embodiment previously described the automated washing system of this embodiment may incorporate any or all of the following. A communication unit wherein it may communicate its position and status information to a remote location, such as to maintenance employees for tracking the progress of cleaning. An image collection device for communicating images of the washing process back to the remote location. This allows maintenance personnel to assure that the unit is doing a proper job of cleaning the glass. One or more sets of controllable lighting is preferably attached to the washing head to enhance the detection of “spots” on the window, so that proper cleaning may be accomplished. Image processing software is preferably included within the system for processing images from the camera of the window sections. The image processing software utilizes digital signal processing techniques, neural net processing, or the like, for detecting locations of the window where dirt still remains. The washer assembly is then directed to attempt to clean the spots found. An optional spot cleaning head may be deployed, preferably on an articulated arm, for rubbing areas upon which a spot has been detected, so that a small spot may be cleaned without the need to clean the entire window section. Obstruction sensor is preferably implemented, for example utilizing sensors to detect any obstructions along it travel path, wherein it will generate an alert on said communication unit as to the obstruction. The automated washing head may then take alternate routing or perform other cleaning functions, or wait until new commands are received. Track groove cleaner and sensor are preferably incorporated for dislodging light debris from the track and a sensor for determining if obstructions still remain in said track, or if voids exist in the track system. Therefore the robot washer cleans its own track during use and is prevented from traversing a section of track that is unsafe sensing if obstruction exist along the track. The groove cleaner may simply comprise a rotating bottle brush type mechanism, or other means of brushing or pushing off debris from the track. The sensor is preferably an optical sensor directed along the path of said track and senses reflections from obstructions along the path. The sensing of track mechanical continuity (sensing for breaks in the track) may be performed optically, or using a mechanical probe that extends along a section of the path and is deflected upon encountering voids in the track, or obstructions. Sealing between window sections can be performed to reduce overspray onto sections already cleaned, wherein the unit is optionally adapted with a seal, such as a rubber strip, that seals against the horizontal or vertical sill of a window so that overspray between sections does not occur. The seal may include a vacuum draw to pull away any water from the window surface.

The washing head is preferably controlled via a control panel, such as on a host computer which communicates with the system over a network connection, over a wired or wireless connection and so forth. Through the control panel the user can preferably start the automated building cleaning system, perform diagnostics, select areas to be cleaned, monitor the progress of operations, review camera and/or audio information collected during operation, make adjustments to operating parameters, log maintenance information, select specific windows or areas to be cleaned.

### 1.3.2 EMERGENCY OPERATION

Any of the embodiment of the robotic washing system of the present invention can be adapted for providing a number of emergency services when portions of a building are otherwise inaccessible. It will be appreciated that although quite rare, situations can arise such as fires, explosions, violence, hostage situations, jumpers, climbers, building damage assessment, and so forth, wherein rapid external access to the building is desirable. The robotic washing device of the present invention is preferably configured so that it can be readily deployed in a number of rolls. The following features are presented by way of example and not of limitation.

(1) Collecting images of situations from roof of building or building exterior. The camera on the washing head of the unit is preferably configured with panning ability wherein it can turn sideways or up and down to view any desired areas from the device. Optionally the unit can be configured with multiple cameras.

(2) Law enforcement mode-the unit can be adapted to provide special functionality for law enforcement personnel. These features being preferably only accessible to law enforcement officers through a validation and activation means, such as through use of special cards, secure password sequence, or the like at the remote control console. One or more levels of security can be controlled by the law enforcement mode, wherein features with differing levels of “abusability” are accessed. The following features or other features described herein may be fully or partially controlled through one or more levels of secure access.

(a) cameras for collecting images from inside the building, these can include various forms of imagers along with light sources for illuminating the situation. Additionally, the lenses are preferably configured with proper polarizing filters for reducing reflections from the windows. Alternatively, or more preferably additionally, infrared imagers and optional light sources can be directed from the washing head which allow collecting images in the dark without the unit being seen.

(b) audio detection means that allow the unit to collect ambient sounds and sounds from within a nearby portion of the building. Conventional microphones may be utilized, such as single microphones, boom microphones, microphones within parabolic reflectors, and the like. Similarly, the unit can be configured for acoustically coupling a microphone to a portion of the window, wherein authorized personnel can register sounds or conversations from within a portion of the building. Alternatively, an optical microphone pickup can be utilized toward the building or directed at a nearby building for registering and converting reflected light variations to acoustic equivalents (it will be appreciated that windows vibrate in response to sound pressure variations inside the attached room, wherein audio information can be extracted from the reflected light energy (infrared, visible light, ultraviolet light, etc.).

(c) active deployments into portions of a building. The unit can be configured (i.e. temporarily by affixing a module) for deploying active measures. For example gaining access to a portion of the building from the outside into which fire suppression equipment, tear-gas and such can be deployed. A munition with a camera sight an articulated actuator may be mounted to the washing head platform to allow taking down an aggressor that is holed-up within a portion of the building. Preferably, this mode could only be accessed by the police attaching an additional module to the washing platform and controlling its actions remotely. The software controlling the washing head is preferably configured with uncommitted user interface functionality allowing attachment of other modules to the unit, wherein future applications can be the control of additionally will be appreciated that the

(3) Transporting elements to portions of the building. The washing head device is preferably configured with means for retaining elements for transport up or down the building. For example, emergency equipment may be transported to persons trapped in a room or floor. A harness, seat, or other means of retaining one or more individuals may be optionally coupled to the washing head, to allow the washer head to be utilized for moving persons up or down along the side of the building.

### 2 FLIGHT FORWARD PILLOW BAG

### 2.1 PROBLEM DESCRIPTION

It is often difficult for persons on a flight to get comfortable, in particular on a long trip. Many persons find it difficult to stay in a seated position for a long period of time.

### 2.2 SUMMARY

The present invention makes it easier to comfortable rest and/or sleep on flights.

Presently the individual must attempt to sleep while retaining themselves substantially erect. Which often makes sleep, or at least comfortable sleep difficult. A more comfortable upright position is slumped forward, however, this is not currently possible within commercial airline seating.

The present invention provides the user with an additional sleeping/resting position, wherein they may slump forward into an inflatable pillow positioned on the try table in front of them. This position providing greater comfort as the body need not be maintained erect and is supported at the head by the pillow, and optionally a set of arm rests which are positioned for use with the Flight-Forward Comfort Pillow. The arm rests being preferably padded and adjustable, such a slidable rest pad slidably attached to an adjustable cinch strap.

### 2.3 DESCRIPTION OF PREFERRED EMBODIMENT

FIG. 24 depicts a resting situation 560 within an airline. A pillow 560 according to the present invention is shown upon which an individual 564 is resting on seat 566 having backrest 568 and arm rest 570. The tray table 572 on the rear of the seat ahead of passenger 564 is in the down position upon which pillow 562 is supported.

Pillow 562 comprises a face ring 574 attached to a body portion 576. The body portion is formed with a large central cavity providing space for the face of the user to extend with sufficient air space remaining in front of the face. Air vents 578 in the body portion allow air to reach the face of passenger 564. Optionally one or more article holders 580 are joined to the device. An optional hand holder 582 extends from body portion 576 to provide support for the hands and arms of the passenger beneath the level of the tray table. Preferably the hand holder 582 has an adjustable length.

The body portion 576 of the device is preferably inflatable, allowing the unit to be easily stored when not in use. An inflating stem 584 is shown by which the passenger may blow up the device to the desired size. By way of example the horizontal cross section of the device is generally circular with an enlarged non-slip base.

The portion of the pillow where the individual's face rests is preferably covered in a foam material, gel material, conformal cushion, or other compliant materials that are preferably covered in a comfortable cloth material. Preferably at least the outer portion of cloth for the unit can be removed for laundering.

The air vents 578, openings from the interior of body 576 to the exterior, which allow the user to breath without restriction, may be adapted with air filter devices wherein the air reaching the user has been first drawn through the filter structure. Many persons are concerned with inhaling airborne pathogens from the recirculated cabin air, for example cases of tuberculosis and other dangerous diseases have been known to have been picked up during airline flights.

The filter may be a simple filter built into the unit, such as the cloth coverings over the vents, which can provide a similar ability as a cloth surgical mask, or a more complex filter may be employed, such as utilizing a HEPA certified filter. The use of more complex filters may be provided with or without a breathing valve, wherein intake air may take a different path (through the filter) than output air, exhausted into the surrounding air. These are preferably options that the user may select when ordering the device.

Furthermore, a small fan with self contained power source, and a speed control (ON/OFF, or adjustable speed) may be provided within the unit to increase user comfort. The unit may also be provided with ear muff style, or other forms of sound attenuation devices.

The unit may optionally be sold with or have integrated within it a sleep timer device, or software, such as described by the inventor in another application entitled “Externally Controlled Ear Alarm”, which may be separate or used with a PDA, Phone, or similar device.

The body 576 may be manufactured from any convenient air tight material, typically thermoformed plastics as use with a variety of inflatable devices. An inner and outer flexible shell of plastic are preferably joined to form the shape having its interior cavity. The material thickness should be sufficient to provide for long life and have a matte finished exterior to reduce glare for other passengers. The unit may be manufactured in a variety of colors, however, a single conservative neutral color such as tan, or gray should be amenable to most users.

An optional clear holder slot 580 is shown on the exterior of the pillow within which the user may place instructions for the flight attendants, such as “Awaken for meals”, “Do Not Awaken For Meals”, along with any additional instructions, such as for example when to awaken, or what is their final destination. It is preferred that a number of preprinted cards be included with the unit for standard situations. A clock face having an hour hand and minute hand pivoting at the center of the clock face, which are mechanically adjustable may also be included for use in combination with preprinted (or other) messages, such as “Please Awaken at:”.

The underside of the unit may be configured with material, or feet, that reduce slippage between the unit and the top of the tray table. For example, silicon, or other compliant polymeric materials.

An optional set of ear muffs as hearing attenuation devices for use in reducing the cabin sounds. It is preferred that pillow 562 and face ring 574 be configured to allow for the optional attachment of adjustable ear muffs. For example a ring can be optionally attached between the face ring and the inflatable body of the unit, from which the ear muffs, shown on adjustable stems are attached. It will be appreciated that it is beneficial to provide adjustability as to width between the muffs, and height from the ring, wherein the muffs may be comfortably adjusted for various head sizes and shapes. It should be appreciated that the ear muffs may be attached to the unit using alternative attach mechanisms. Alternatively the earmuffs may be provided as a separate unit, such as modeled after conventional over the head retained headsets, or the more recent behind the ear and back of the head style of headset mounting. Using separate muffs has the advantage that the user may retain them for use in while maintaining an erect position against the chair, or with the flight forward comfort pillow.

### 2.3.1 COMFORT PILLOW INTEGRATED WITH A BAG

In this embodiment the comfort pillow is built into a piece of luggage, such as a small carry-on bag. Preferably the handles of the bag form the handles for the flight pillow, while the face ring can be optionally made removable for a neck support ring when not utilizing it in the pillow configuration.

FIG. 25-FIG. 27 depict a flight forward pillow 600 with a detachable combination neck pillow face ring. The exterior of the bag 602 may comprise any convenient material such as ripstop nylon, rayon, or other materials. Preferably the bag material comprises a loose weave material through which air can readily pass. Handles 604 are preferably formed on the bag, such as at the ends, these may be adjustable in length (not shown). The handles provide for a means to carry the bag and for the hand rests for the flight forward pillow. The bag 602 is preferably formed with a rigid interior structure 603, such as carbon fiber, fiberglass, metallic, or other forms of rigid rods interconnected and attached to the interior of the bag in a similar manner that supports are utilized for supporting a tent structure. The support structure is sufficiently strong to provide sufficient support for the weight of the head and a portion of the torso of the individual. Alternatively, an inflatable bladder 606 may be retained in a portion of the bag, that can be inflated, such as by the user blowing through a sealable opening into the inflatable bag. Again the inflatable bladder must provide sufficient support for the head and torso portion. Fastening system 608 provides access into the bag from the top, sides, and/or ends.

A removable combination headrest and face rest 610 is preferably retained within the bag, such as affixed to a side or just contained therein. Headrest/face rest 610 may be filled with a material, such as high density foam, pillow batting, conformal foam, be inflatable, or a combination of padding approaches. Preferably the exterior of headrest/face rest 610 is removable for laundering. The headrest/face rest is configured in a U-shape wherein it can be utilized like a conventional neck support when resting or sleeping in a semi-reclined position of the airline seat. The headrest/face rest unit may also be attached to a portion of the bag forming a substantially horizontal face rest as seen in FIG. 27. The face rest may be attached to bag 602 by means of snap fasteners, hook-and-loop fasteners, zippers, or other convenient means of attachment.

At least one vent 612 preferably allows air to flow through the bag, if the material of the bag does not otherwise support the free flow of air. A filter device 614 may be optionally coupled within the unit through which all air is routed to the face of user pressing against the face rest 610. An optional valve mechanism (not shown) can route exhalations to bypass the filter while inhalations are received only through the filter device. It will be appreciated that any kind of desired filter arrangement may be utilized as well as ionizer units to freshen the breathed air. Furthermore, the unit can be configured with a means of generating hot or cold steam to aid the user's breathing. For those with other breathing difficulties an oxygen tank can be coupled to the unit to provide full oxygen or a desired mixture ratio.

A connector 614 is shown connecting the two ends of the headrest/face rest 610, to increase the available support. It will be appreciated to support the neck that this portion be U-shaped, but as a face rest this can allow separation as pressure is applied, therefore the two ends may of the face rest may be snapped together forming a closed circle, or if additional face space is required a spacer coupled in the gap to close the face ring at an appropriate size.

It should be appreciated that other aspects of the flight forward device previously described are applicable to the bag arrangement as well.

### 2.4 ABSTRACT

An pillow device and arm support to support a user in a slumped forward positions. The device is particularly well suited for positioning on a tray table on an airline and allowing the user to comfortable rest in a forward position. The device can optionally incorporate an air filter, ear muffs, and can be optionally incorporated within luggage such as a small carry-bag.

### 3 CASE CHARGE HOUSING

### 3.1 DESCRIPTION OF PREFERRED EMBODIMENTS

It is often desirable to charge or retain the charge on an electronic device which is in storage or transit. Presently the device must be connected to a charging device that couples to an outlet. Solar cell panels are available which can in some cases provide a an AC voltage to which a charger can be coupled, however this is cumbersome.

The present invention allows a device to be retained in its case while being charged, or the batteries retained at a peak state. The user need only place the unit in a location where it receives adequate lighting. If outdoors the high intensity of sunlight can fully charge the battery in a short period, and indoors even room lighting or indirect sunlight can provide sufficient energy to slow charge the battery or at least retain the current state of charge. Presently owners must periodically pull the units out of storage and from their cases and connect them to be charged. It should be appreciated that damage occurs within rechargeable batteries that are left to discharge below a particular threshold, that voltage typically depending on cell chemistry.

FIG. 28 depicts a preferred configuration 710 in which a device's portable enclosure 712, such as a laptop carry bag, is configured with an external solar cell array 714 permanently or temporarily joined to bag 712. Internally the power is coupled to a power supply that converts the voltage to the appropriate charging power for the device retained in the portable enclosure. In a preferred embodiment at least one external power indicator 716 is provided allowing the user to position the case in a location having a sufficient light intensity.

The solar cell array 714 is preferably configured as a single panel which is attached to the portable enclosure, hereinafter referred to as a “bag”, although other implementations can be utilized. The photocell array 714 can be integral to bag 712 or configured for attachment to bag 712, such as using fasteners such as snaps, Velcro, zippers, buttons, or any other convenient means of attaching the solar cell array 714 to bag 712, allowing the unit to be carried to other locations while providing in-situ charging and charge maintenance.

Within the carrying case power is coupled from the power supply to the device being charged. The device itself may have an internal power supply which converts a single or range of input power into the power needed for charging. In some instances the power supply can optionally integrate or be coupled with a power inverter to provide an AC input source to the device for charging power. It is preferable that the power-supply be configured to be adaptable to the power needs of the device to be charged. An incorporated reference describes a universal power adapter that automatically communicates with the device and provides the necessary power. In other embodiments the power supply may be configured or set to the specific device to be charged. In another embodiment a module is coupled to the optical charge unit which performs any necessary power conditioning and preferably connector adaption. In this way any desired photo panel can be readily adapt for charging any desired devices, or coupled to different bags for charging a number of different devices.

FIG. 29 illustrates an example embodiment 730 of a circuit which converts the power from a solar cell 714 and is preferably configured for driving an integrated intensity display 716. A conditioning circuit 732 is configured for registering the output from the solar cell array 714, such as a bypass capacitor and inverting amplifier 734. The registered power availability, preferably determined by the voltage generated in response to the light intensity received, is then coupled to circuits 736, such as an analog-to-digital converter configured for segment driving, for driving that portion of the solar array which contains a display 716. A portion of the circuitry is preferably connected by wiring from the solar cell array, wherein the circuit is retained within the bag and passed through a small hole to the solar panel retained on the exterior of the bag.

It should be appreciated that a number of different embodiments may be configured for charging the enclosed device and providing a charge indication. In one preferred embodiment a display is included which aids the user in positioning the solar cell array in the optimum lighting in the local vicinity. In this embodiment a differential amplifier can be added, or used to replace inverting amplifier 734, and configured having inputs comprising a current signal and an averaged input signal. The display can provide a “hotter” or “colder” indication wherein the user is aided in finding the optimum position for charging in the local vicinity. It will be appreciated that preferably a charging indicator is provided which indicates if the device is (1) connected, (2) charging, (3) the charge rate and so forth, along with the hot/cold light intensity indication.

The display 716 can be embodied as segments of electronic ink applied as a layer between control electrodes. For example, the electronic ink can be applied in a polymeric layer between an upper transparent electrode and a lower electrode over a solar cell panel comprising semiconducting polymeric layers configured to generate electricity in response to receipt of electromagnetic radiation. A number of these solar cell structures being known in the art, wherein they will not be described in detail herein.

A module 740 is shown with power supply 742 and connector 744 configured for connecting to and providing the proper power to the device to be retained within bag 712. It is preferable that the output power to adaptable or modular wherein replacement modules, or personality modules into a variable power supply, allow adapting the system for the charging of different forms of electronic devices. It is also contemplated that the power supply can provide one or more additional outputs for being connected directly to additional standby batteries to provide a maintenance charge keeping them at peak charge.

FIG. 30 depicts an alternative form of display 750 in which a series of display segments 752a-752j (i.e. return to state elnk, LCD, etc.) are driven by power from series coupled solar cell segments 754. It will be noted that little power is required to drive LCD, electronic ink, or certain other low power displays, wherein little segment area is required. Alternatively, a single stack of segments can be coupled together with resistors to provide for driving the segments in response to voltage generated by the solar cell.

### 4 EXTENDABLE TIME CHARGING

### 4.1 DESCRIPTION OF PREFERRED EMBODIMENTS

FIG. 31 illustrates an example embodiment 810 of a polymeric solar collection array 812 formed with a flexible polymeric strip 814 with embedded conductors 816 which can be extended from within the cell phone 818 to provide for off-site charging when an adapter, or AC outlets are not readily available or convenient. A graspable element 820 is provided to simplify extension and it is preferably weighted to counteract any tendency of the material to roll back up when extended. It should be appreciated that the solar strip can be adapted with at least one electronic ink surface portions wherein an electrode screed within the device writes on the tab to provide updated written information as well as to provide for charging. The electronic ink embodiment is described in another application by the invention in relation to a laptop computer.

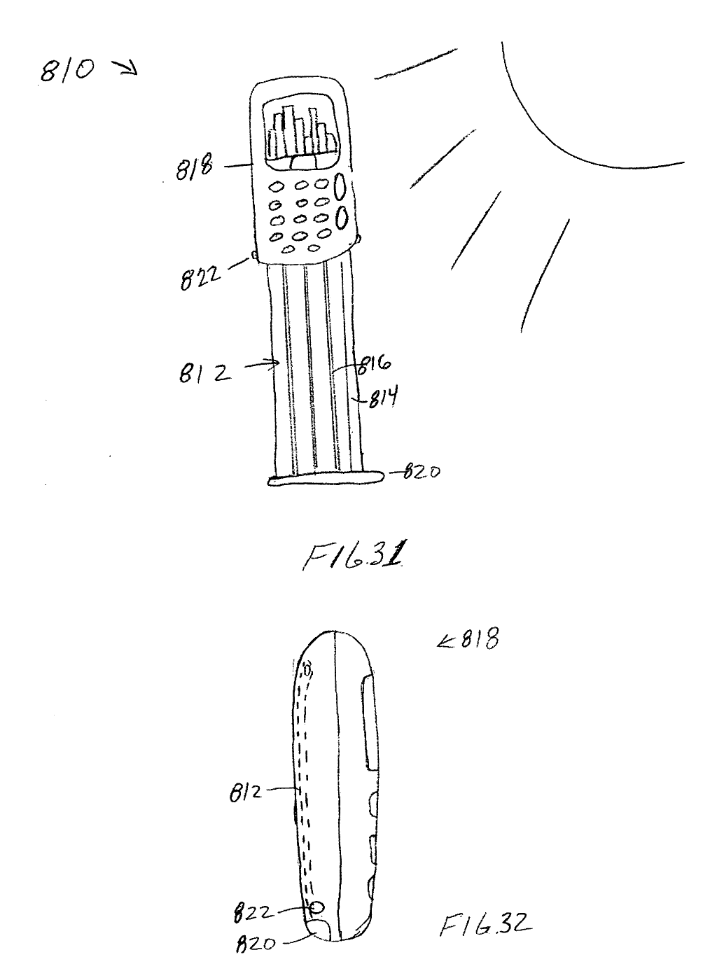

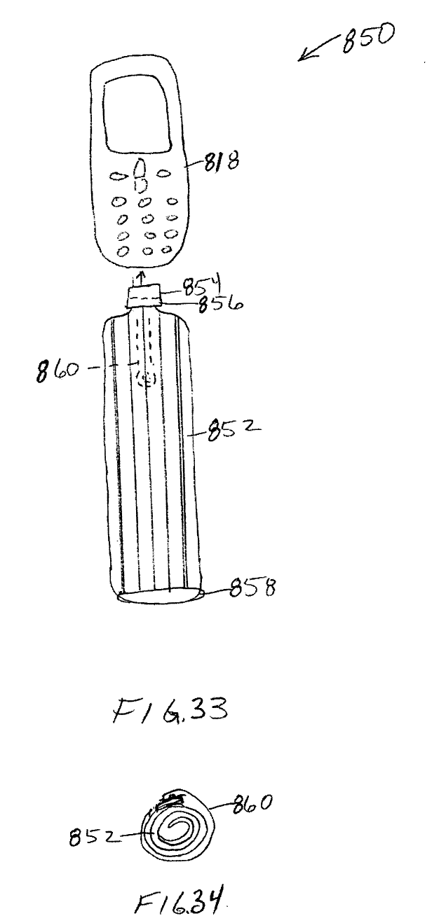

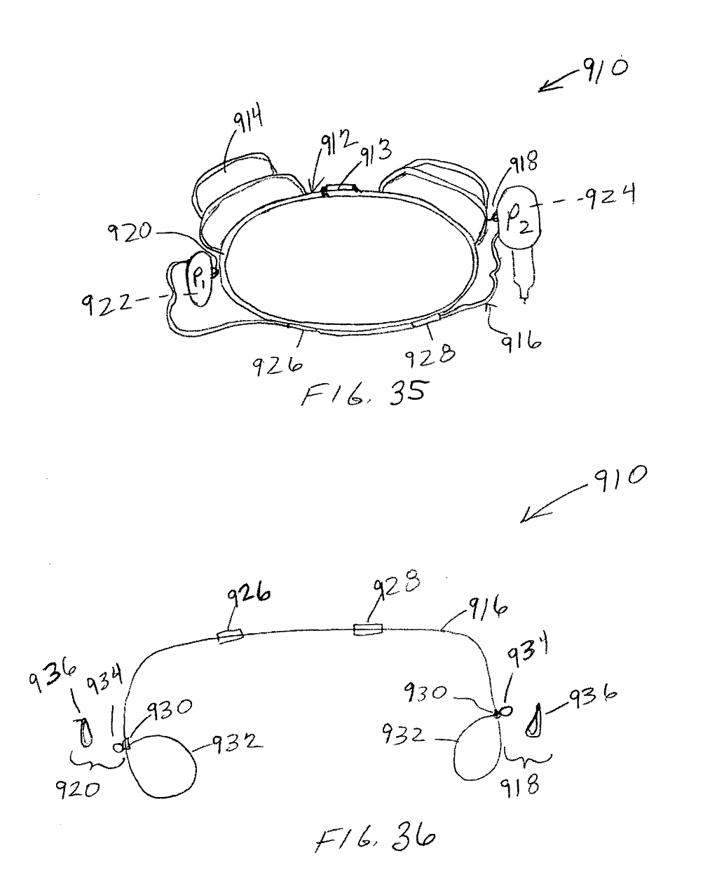

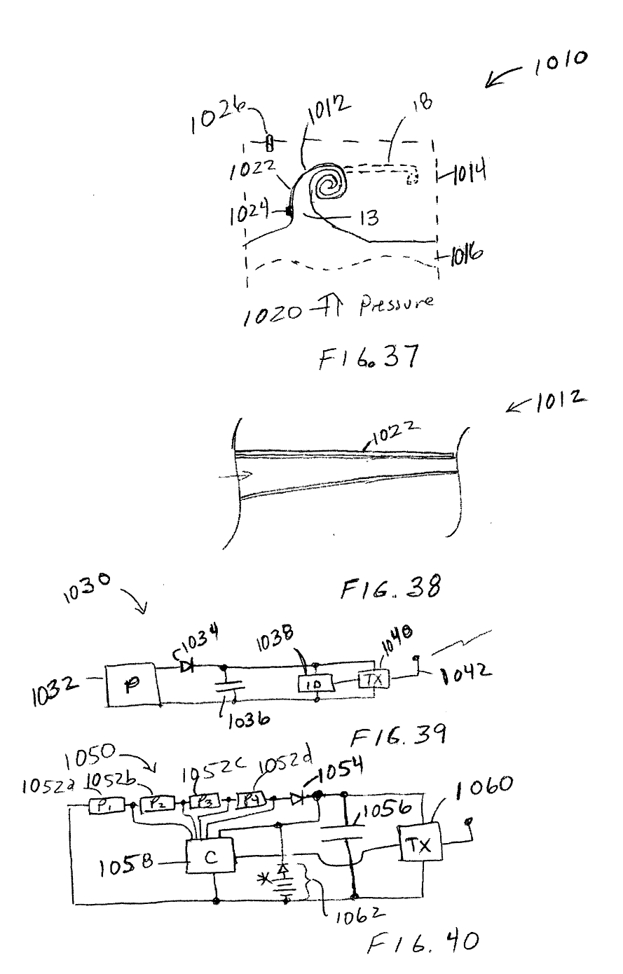

FIG. 32 depicts the solar collector when retracted into the cell phone. It is shown stored in a two layer fold-over configuration, however, it can be placed on a roll, or otherwise retracted into the device. In one embodiment a new backing for the cell phone is provided with the additional space for retaining the solar collection strip.

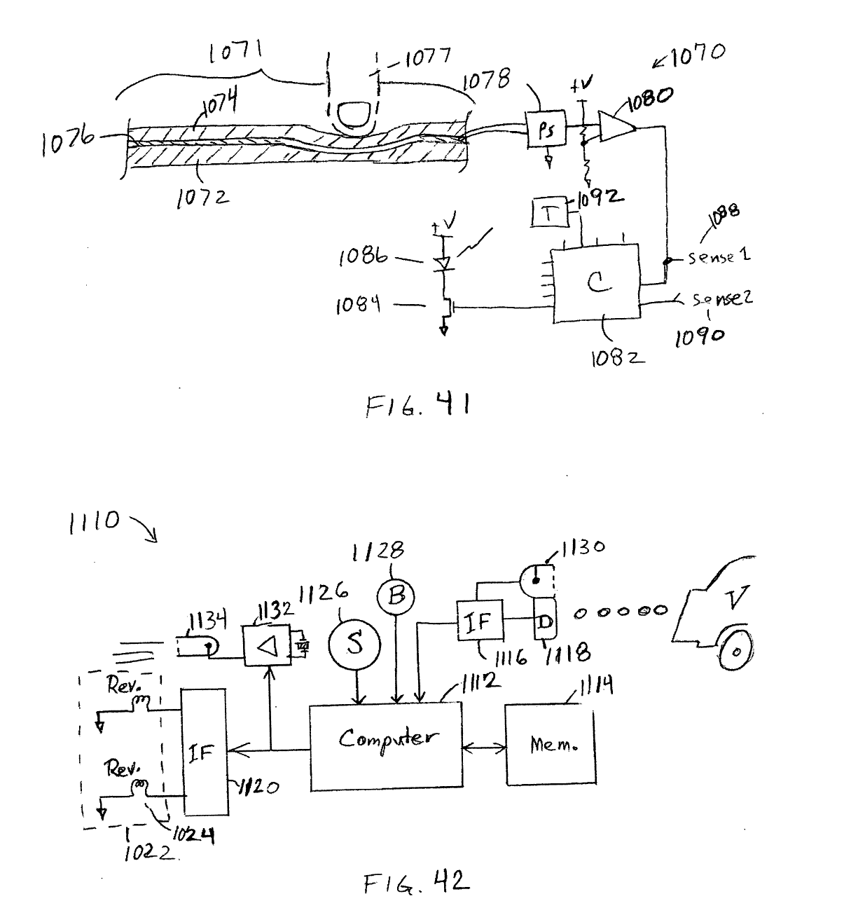

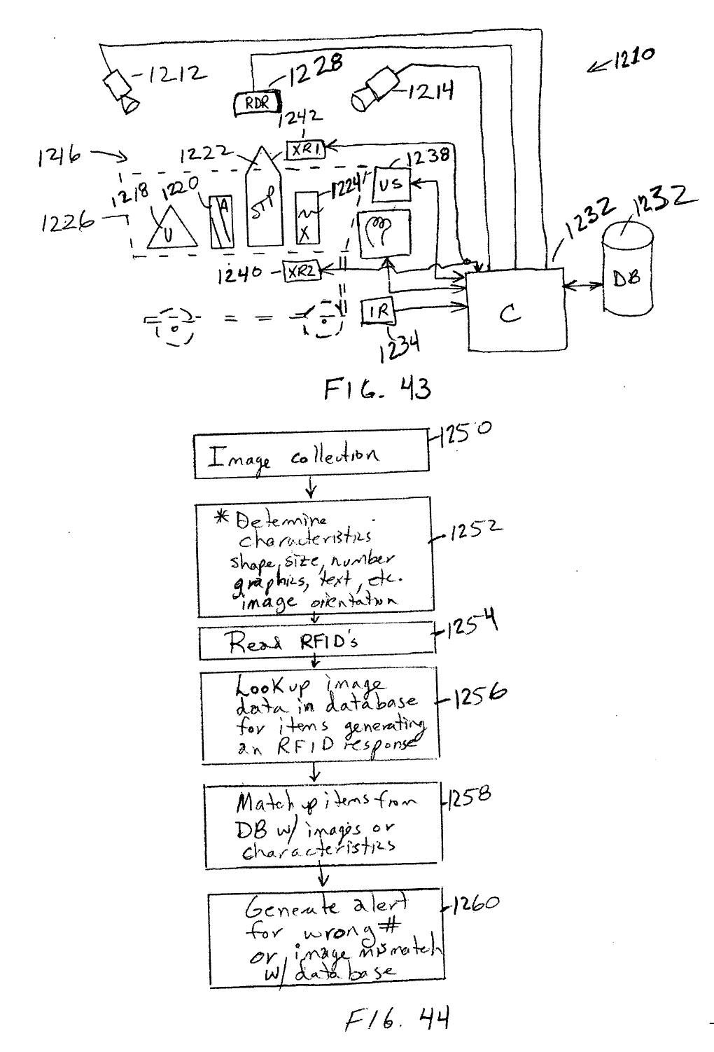

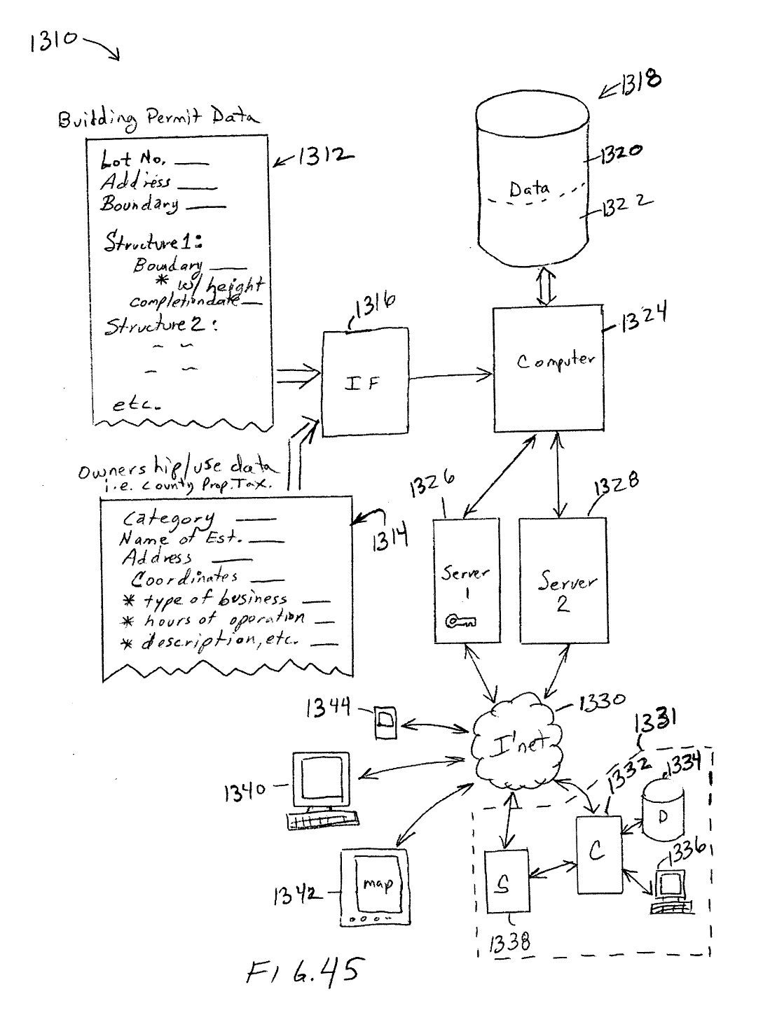

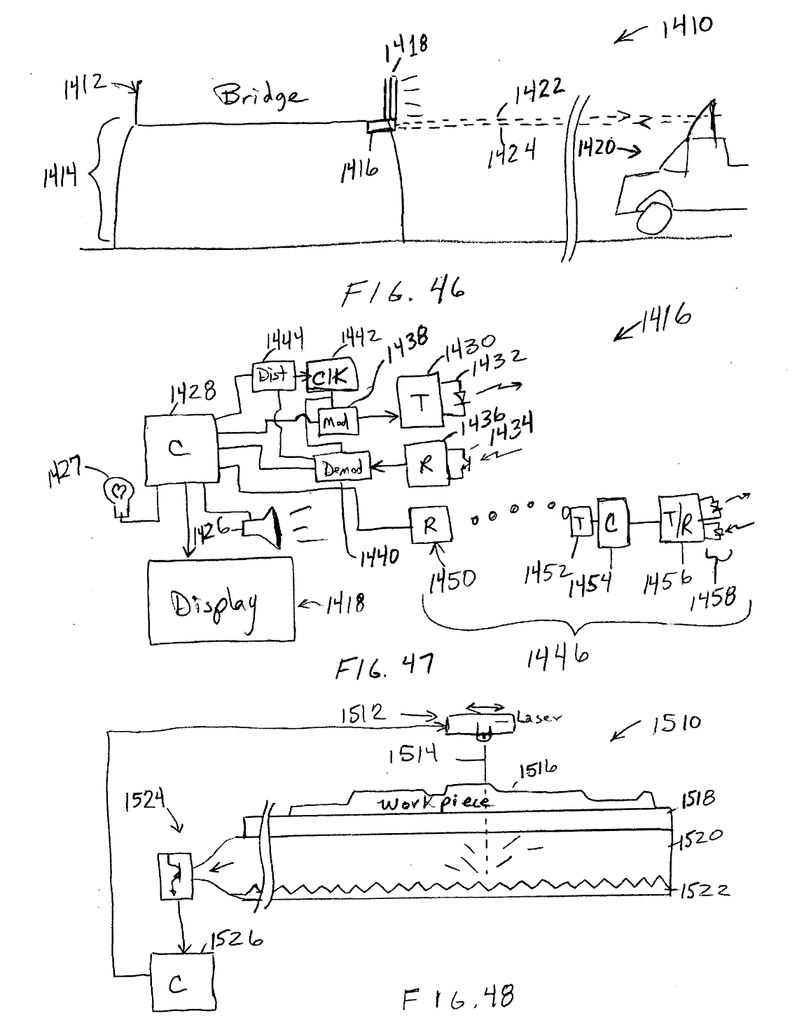

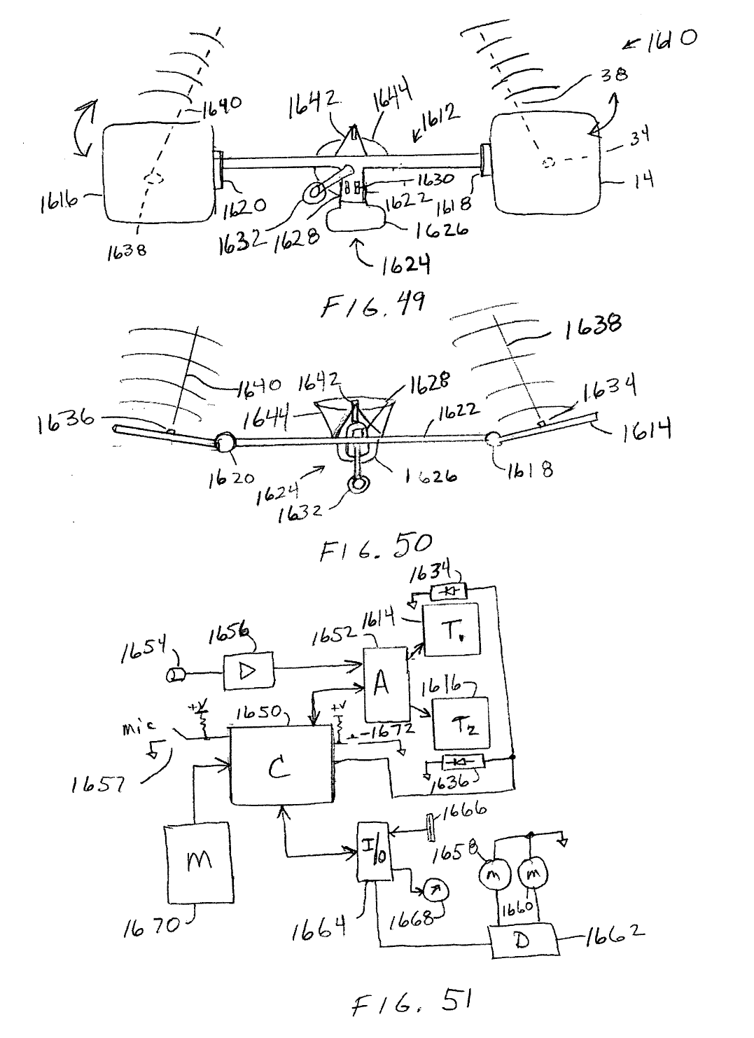

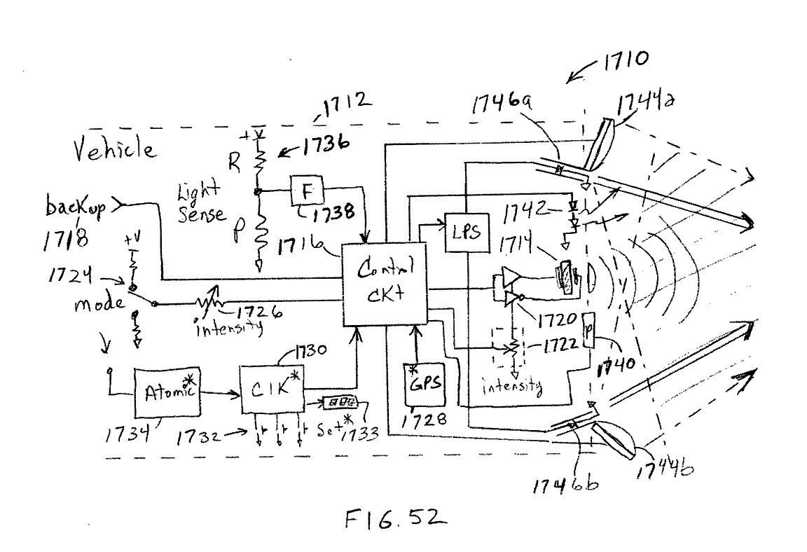

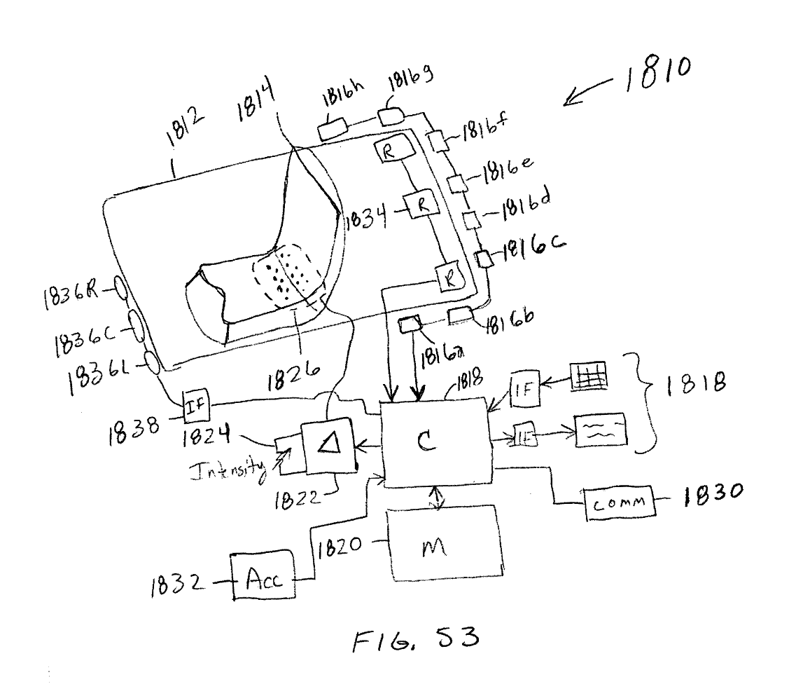

FIG. 33 depicts a less preferably embodiment 850 for aftermarket, wherein the polymeric solar strip 852 is coupled to a combination connector 854 and charge circuit 856. configured for insertion into the charge receptacle of the phone. The strip is preferably rolled up and can be stored in the size of a 835mm canister. The circuit can be configured to maintain a proper charge level, typically a trickle charge. It is preferable that the voltage of the polymeric solar cell be sufficiently high under most conditions to provide for a positive charge flow. Charge circuit 856 may simple comprise a resistor, a resistor and diode, or it may have more sophisticated charging such as a ramp charging mechanism which allows increasing charge voltage for charge bursts at sufficient voltage. The use of step-up conversion would typically be too bulky for use in the preferred svelte package, although it could be done.

A weighted element 858 is provided at the opposing end to prevent inadvertant roll up and a strap 860 is shown for retaining the rolled-up charger in a small stowable module as shown in FIG. 34.

### 5 CORDLESS DRILL-DRIVER HOLDER

### 5.1 PROBLEM DESCRIPTION

Dropping tools on the job is a common occurrence. With some tools, such as hammers, there is little damage (unless it strikes someone). However, with electronic devices, such as expensive cordless power-drill-drivers even a short fall can ruin the power tool.

Cordless power tools can be displaced from conventional pouches and holsters, or dropped while being held. Accordingly, the present invention overcomes these difficulties to protect the power tools.

### 5.2 OVERVIEW

A specialized belt arrangement that limits the distance the power-tool can be displaced from the body.

### 5.3 DESCRIPTION OF PREFERRED EMBODIMENTS

FIG. 35 and FIG. 36 depict a preferred configuration 910 in a top view. A tool belt 912 is shown with closure 913 and tool retention elements 914, such as pockets. It will be appreciated that these are not configured for retaining the large size and weight of today's many power tools. Attempts to hold the power tool in these pockets often result in dropping the tool and damaging it.

In this embodiment of the present invention a coupling means 916 connects the power tool to tool belt 912 keeping it handy and preventing loss by dropping. Coupling means 916 is configured to attach to the power tools, preferably by latching an encircled portion within a belt section which preferably has some compliance to prevent loosening of the belt from the tool. Fasteners 918, 920 on the distal ends of coupling means 916 allow for holding the power tools 922, 924 in a ready position without the need to hold them within the pouches. The fasteners preferably provide a slip free connection, such as with a spring loaded closure, that still allows for one hand fastening and unfastening of the tool from belt 912. Belt 916 is shown passing slidable through loops 926, 928, therein allowing the use of either tool 922, 924 by taking up the slack of belt 916 from both sides. The extension of belt 916 allows the user to have any desired reach with the power tool, but if dropped the extension prevents an unrestricted fall of the power tool. It will be appreciated that belt 916 can be configured with elastic, coiled sections, springs, and so forth to provide for elastic extension beyond the available slack.

FIG. 36 shows the embodiment of the apparatus in a schematic form. A clasp 930 forms a loop 932 in belt 916 for cinching down on the power tool, such as the handle or barrel of a cordless screwdriver or drill. A first connector 934 is configured for retention by a second mating connector 936, such as spring clip.

### 6 PRESSURE SENSING DEVICE

### 6.1 PROBLEM DESCRIPTION

It is often difficult to sense pressure in a variety of applications. For example sensing and communicating fluid pressure changes to a remote system. Also it is often difficult to sense pressure changes which arise over a large surface area, such as on the exterior of a housing.

Therefore, a need exists for apparatus and methods for sensing pressure and otherwise controlling operations in response to pressure and related events. The present invention fulfills those needs as well as others.

### 6.2 OVERVIEW

Piezoelectric pressure switches are described which provide two different forms of pressure sensing. The first senses operates in conjunction with a fill able vessel, while the second activates a switch in response to pressure applied anywhere over a large surface.

In the first form an apparatus is described for generating an electrical output signal in response to pressure changes, comprising: (a) an enclosure; (b) a pneumatic member disposed in said enclosure and configured for expanding and contracting in response to pressure changes; wherein said enclosure is configured with a fluidic communication port coupled to said pneumatic member; (c) piezoelectric transducer coupled to said pneumatic member and configured to generate an output voltage in response to said expansion and contraction.

In a second form an electrical switch is formed for sensing contact pressure changes over a large area, comprising: (a) a compressible material configured for covering a portion of a device housing; said portion of device housing being larger than a conventional keytop; (b) a piezoelectric transducer coupled to said compressible material and configured to generate an output voltage in response to movement as pressure is applied to said compressible material; and (c) means for generating a change in switch state in response to said output voltage reaching a predetermined threshold.

Wherein the means for generating a change in switch state may comprise a microcontroller (or other circuit element) configured to detect a sufficient change in voltage output from said piezoelectric transducer. For example the sufficient change may be sensed by detecting crossing a logic threshold of an input gate, such as an interrupt input or other input configured to awaken a microprocessor, or other circuit, from a low power mode, or detected by an analog-to-digital converter input.

The change in switch state can be used for controlling a variety of device operations. By way of first example an application is described in which the change in switch state controls the activation of user interface backlighting. A sufficient pressure from user contact with said electrical device switch on and energizes the backlighting. Preferably the pressure sensing areas are placed on opposing sides of the device, wherein upon grasping the device with sufficient pressure applied to both sides, the pressure is sensed and activates the backlighting, such as for a predetermined period of time after user inputs cease. A second example is described wherein motion sensing is utilized, with or without pressure sensing, for activating the backlighting of a portable device.

It will be appreciated that aspects of the described devices and methods may be practiced separately or in combination thereof without departing from the teachings of the present invention.

### 6.3 DETAILED DESCRIPTION

### 6.3.1 VOLUMETRIC PRESSURE SENSING EMBODIMENT

This aspect of the invention describes a mechanism for sensing fluid pressure changes, such as in response to water level changes, or other gaseous or liquid pressure changes. By way of example the embodiment is shown implemented as a means for sensing that a large object (i.e. such as the size of a cat, dog, or child) has fallen into a pool upon which the pressure sensing device is coupled.

FIG. 37 and FIG. 38 depict a pressure sensor 1010 having a volume compliant element 1012 (pneumatic member), with interior volume 101 3, which expands and contracts in response to pressure changes, shown within an optional housing 1014, the lower portion 1016 of which is shown by way of example for coupling pressure changes within a liquid level, such as within a spa or pool, to the volume compliant element 1012. By way of example element 1012 may be constructed of a rubber or polymeric material formed in a coiled flattened tube having a piezoelectric strip coupled along at least portions of its exterior, such as along the flattened exterior and/or interior sides. FIG. 38 depicts a cross section of the tube 1012 in an extended position with piezo strip coupled to the exterior surface. The volume of volume compliant element 1012 changes in response to changes in fluid pressure, such as from a first position 1012 to a second position 1018 as pressure 1020 increases.

Under static pressure conditions the volume compliant element can be configured to be in any desired state along its expansion profile. For example, if both increases and decreases in pressure are to be sensed, then the member is biased to an intermediate position, wherein pressure increases result in expansion and decreases result in contraction. In the example embodiment of FIG. 37 the compliant element unrolls in response to pressure increases and rolls more tightly in response to decreases in pressure. It should be appreciated, however, that the unit can be mechanically biased to an extended position for accentuating the response to pressure decreases, or biased toward a contracted position to accentuate the response to pressure increases. The biasing can be provided by the naturally fabricated shape of the volume element or in response to mechanical biasing elements such as spring like members and the like.

A thin piezoelectric transducer element 1022 is coupled to volume compliant element 1012, wherein the piezo is flexed and generates an output voltage in response to the expansion and contraction of the volume compliant element. An electronic circuit 1024 is coupled to transducer 1022 for registering the voltage output of the piezo in response to the pressure changes. The circuit may be powered from a separate source of power, such as a battery or fuel cell, but the present embodiment illustrates a preferred embodiment in which the power generated by the piezo is utilized to maintain a charge on a capacitor for supplying device power.

The output of circuit 1024 can be configured to communicate the pressure changes by way of a wired or wireless connection. Circuit 1024 may interpret the pressure changes prior to outputting a signal, such as determining if the pressure changes exceed a desired threshold level. One preferred means of communicating the pressure information is by way of a radio frequency output. This communication may be generated autonomously by circuit 1024 in response to sufficient pressure fluctuations, or may be generated in response to a challenge, or query from a remote device. By way of example, the transmitter portion of circuit 1024 may be fully or partially powered from receiving a challenge from a transceiver as is typically utilized for powering passive RFID devices.

To facilitate determining the direction of pressure changes, the voltage output of certain forms of piezo material may be detected or the piezo material implemented as a number of segments (or taps along a single section of piezo), wherein a circuit can detect which direction segment activity is being displaced in response to the registered pressure changes. For example in the case of curled sensor 1012 flexure is greatest at the farthest bend, the remainder being pseudo-static, wherein detecting whether activity is moving toward or away from the tip determines respectively if it is a pressure increase or a pressure decrease.

In the majority of applications, it is the changes of pressure to be sensed wherein a pressure relief port 1026 (bleed port) is coupled to the housing to allow the inner pressure to stabilize with ambient pressure over a span of time determined by the cross section of the opening in relation to the volume of the housing. For example, the port may be set to equalize a typical pressure deviation within 1-5 seconds depending on the conditions being sensed.

FIG. 39 illustrates an example of a simple pressure sensor embodiment 1030. A piezo transducer element 1032 generates an output voltage which passed through a rectifying means (or power control means) 1034 for charging a power source 1036, such as a capacitor. It will be appreciated that the voltage generated by the piezo can be up converted if desired to provide a higher charge voltage (or otherwise modified), although this increases circuit complexity. Variable up converting allows taking full advantage of any voltage produced by the piezo, wherein even small voltages are up converted sufficiently to charge the capacitor.

When the voltage on power source 1036 reaches a given voltage then transmitter 1040 is activated to signal to a remote receiver device. To allow for discerning the output of multiple units the transmitter is shown encoding an identifier, such as from an ID chip 1038, for sending to the remote location.

The transmitter may encode an indication that a pressure transition has occurred, or it may transmit information about the level and/or rate of the pressure fluctuations. The transmitter may incorporate a microcontroller, or other circuits, for registering and encoding data about the pressure changes. Additionally, the circuitry may be activated in response to a sufficient voltage being present wherein it records pressure information and determines the optimum time for sending information about the pressure changes. The circuitry may be set to enter a low power mode, for periods of time when no significant pressure changes are taking place. By incorporating a microcontroller, such as a PIC® microcontroller from Microchip Incorporated™ from Chandler Ariz., the unit can operate at very low power levels and enter a power down mode when no significant activity is occurring. Furthermore, voltage sensing with simple programmable I/O pins can be performed by setting as output low to discharge input and then setting as an input and registering the time to reach the logic threshold. Although numerous ways exist to register voltage levels this way is perhaps one of the least inexpensive.

FIG. 40 illustrates another example 1050 of the pressure sensor that utilizes a segmented piezo (or measurement taps along a single element) having segments 1052a-1052d (although any desired number of segments may be supported). The segments are shown coupled in series to simplify generating a sufficient voltage output, although they may be coupled in parallel or in other ways. The output of segments 1052 still is shown being rectified and isolated 1054 for charging capacitor 1056. A microcontroller 1058 is powered from capacitor 1056, although a separate supply of power, such as optional battery 1062 may be provided without departing from the invention. The controller in this example is configured to detect the portion of the piezo that is flexing the most for ascertaining the position of the volume member 1012. Controller 1058 preferably records pressure changes and can activate transmitter 1060 as desired to communicate pressure information to a remote location. If power is maintained to controller 1058, such as by incorporating batter 1062 (i.e. coin cell lithium) then the controller can maintain pressure data readings and maintain some sense of time (i.e. real time clock if awake at all times, or pseudo real-time clock by sleeping for fairly well known periods of time) for relating the pressure changes to one another and for controlling when and how data is transmitted. Transmitter 1060 may be replaced with a transceiver allowing two way communications. One mechanism is by utilizing a transponder form of circuit to replace transmitter 1060, the transponder may respond to challenges in the form of RF or inductive fields (short distance transmission) wherein it can receive a trigger for sending data back up, it can also receive information from the remote unit, further the power from the challenge itself can be utilized to aid in powering the device if desired. It should be appreciated that numerous forms of communication link can be adapted without departing from the teachings of the present invention.

In general the means for transmitting pressure is selected from the group of transmission mechanisms consisting essentially of radio frequency transmissions, magnetic field transmissions, audio transmission and optical transmission. It will be appreciated, that although less preferred for most applications, the wireless communication may comprise an audio output by the device which signals the pressure changes. These are preferably pressure changes for being registered by a remote electronic device, although audible pressure alert is inherently provided. Considered an audio output which is preferably not to be heard by humans. A vibratory pressure port can be coupled to the pneumatic member and configured to vibrate at ultrasonic frequencies as air flow through the port to generate sound in response to changes in pressure and/or volume of the pneumatic member. It is preferably to incorporate at least two pressure ports on the device having a known frequency relationship (and/or modulation), wherein the remote device can discern the sounds generated in response to pressure changes from ambient sounds that may be near the same frequency. The tube can be configured to alter the pitch of the emitted sound as the tube volume changes thereby generating both a pressure event and a pressure reading by measuring the frequency of the audio.

### 6.3.2 COMPRESSIVE PRESSURE SENSING

This aspect of the invention describes sensing compressive forces, such as may be applied to the exteriors of a device housing when a user picks up the device in preparation for use. It is beneficial to be able to sense when the user elects to use a device, such as picking up a remote control from the coffee table, and so forth. Requiring the user to press a specific button to activate backlighting requires the user to see well enough to discern that lighting. The present aspect of the invention describes a pressure sensing means as well as other mechanisms for sensing that the user desires to use a remote control, cell phone, or other portable device.

In this first portion an electrical switch is described which can cover a portion of the exterior of a portable device, such on the facing, on the sides, on the back and so forth. Preferably the pressure sensor is sensitive to the grasp of the user, wherein the backlighting for the unit is activated.

FIG. 41 depicts a pressure sensing element 1071 which is insulated from the device and which is protected from the exterior. A sensing element 1071 is shown with a compliant layer 1072 for bonding to a portion of the device exterior (not shown) a piezoelectric transducer 1074 which generates an output voltage in response to being flexed, and an outer layer 1076 which insulates and protects the piezoelectric material. It will be appreciated that in response to localized pressure, such as applied by finger 1077, the piezo layer flexes as the underlying layer is compressed, and a voltage is generated. The magnitude of the piezo output signal is determined by the depth of flexure and extent of flexure along the strip.

In this embodiment the output from the piezo pressure sensor 1071 is coupled to a signal conditioning circuit, such as an RC network 1078 to limit the bandwidth, although a power supply or converter may be utilized as desired. The output of the piezo in the desired frequency range of interest is compared against a threshold, depicted by a comparator 1080, although other conventional means of detecting if a sufficient output from the piezo has been generated. Upon reaching a sufficient threshold, in this case a gently squeeze by the user, a circuit 1082 (preferably a microcontroller) receives the signal and elects to activate backlighting represented by a switch 1084 controlled by the circuit 1082 for driving current through an LED 1086 or other forms of backlighting elements.

### 6.3.3 ACTIVATING BACKLIGHTING IN RESPONSE TO MOTION OR PRESSURE

It is often difficult with portable electronic devices for a user to find the correct keys on the device. In some cases units provide backlighting, however, typically the backlighting is activated when the user either turns on the device (i.e. a cell phone), or after they have pressed their first selection key. However in many instances, such as a television, VCR, DVD player, or cell phone in standby mode, the user can't see the keys well enough without backlighting to make that first selection.

The present invention automatically activates backlighting in response to sensing appropriate pressure on the housing and/or of sensing motion of the housing. It will be appreciated that sensing motion may not be appropriate for devices such as a cellular phone which are often been carried about by the user, but can be appropriate for handheld remote control devices, such as for controlling video and audio systems.

It should be appreciated that the above is a simple pressure sensing circuit illustration, and a number of variations may be considered without departing from the invention. One preferred configuration is that of requiring the pressure be registered on both sides of the portable device on two separate pressure sensing strips 1071, therein assuring that the unit is being grasped and not simple set on its side. The figure shows a sense 1 signal 1088 received from pressure sensor 1071 with a signal sense 2 1090 for receipt from an additional pressure sensor (not shown). The pressure sensor is implemented to span an area on the device housing which is larger than a conventional keytop, and preferably much larger so that wherever the user grasps the device along its length the pressure is sensed and the unit can respond by activating the backlighting. It should be appreciated that the piezo only generates an output voltage in response to a change in flexure, so once flexed in a particular way, then the voltage drops to zero. Consequently if stored with both sides compressed, such as wedged between the seat cushions, the piezo would only sense changes in pressure and not retain the backlight in an active state.

The pressure unit may be adapted with its own sense circuit to convert the piezo output voltages to a binary activation output, or to operate as a switch. However, directing the output to a microcontroller, or similar circuit, is preferred so that other backlight activation and deactivation conditions can be supported.

The microcontroller can be configured to detect a sufficient change in voltage output from said piezoelectric transducer, preferably after conditioning, wherein comparator 1080 is not necessary. The output of the piezo may also be coupled directly to a suitable microprocessor input wherein it performs the signal conditioning. In order that the microprocessor circuit be activated in response to pressure, the input to the microprocessor may comprise an interrupt line or other input configured to awaken the microprocessor from a low power mode, or an analog-to-digital converter input, again which preferably can awaken the processor under the proper conditions.

The microprocessor programming preferably provides routines for deactivating the backlighting after a sufficient period of time when no activity has occurred. Also the sensitivity of the unit to pressure can be modulated in the microcontroller. For example, minor pressure fluctuations may initially activate the backlight, but if no buttons are pressed for a given length of time then the pressure threshold can be raised, as it is assumed that the user is fidgeting as they hold the unit while watching. Wherein activation requires an increased, more intentional, pressure input.

A tilt sensor 1092 may be coupled to the microprocessor in addition to, or in some cases as an alternative to the pressure switch detection. As mentioned, motion sensing would not be appropriate for a cellular phone or other device carried by a user and may be less than desirable for a device held by the user such as an audio or video remote which is held by the user while watching and/or listening to programming. Still other alternatives exist such as sensing user proximity, however, again these can't readily discern that a user holding the remote desires to see the keys. The pressure sensing embodiment, in particular the twin side bar pressure sensing described, allows the user to get backlighting as soon as the unit is picked up and to reactivate backlighting in response to giving the unit a little pump squeeze at any time to activate backlighting no matter how long is has been held for.

### 6.4 ABSTRACT

Systems and method of sensing pressure are described as well as a method and system for controlling the activation and deactivation of backlighting for portable devices, such as audio and video remote controls, cellular phones, and so forth.

### 7 HARDBLITE—FOLLOWING DISTANCE SENSING ENHANCEMENTS

### 7.1 DETAILED DESCRIPTION

In another embodiment of the hard braking safety system, the forward distance to another vehicle is registered either additionally or alternatively to the registration of the braking intensity. Although this distance sensing is described within the parent application, this enhancement adds aspects to that utilization.

A distance sensor may be selected from any of a number of different technologies which typically transmit a signal and evaluate its received reflection. The transmission being optical, radio-frequency, ultrasonic. The present system appreciates that low cost radar can be implemented using newly available ferroelectric phase shifters within smart antenna arrays. Other forms of proximity detection may be less preferably utilized, such as those based on sensing magnetism, electric field effects, image collection and processing, and so forth.

The system processes the information to determine the relative threat based on the available information, such as the absolute distance and closing speed. If the threat level exceeds a threshold, then the threat is communicated to approaching vehicles (following behind the vehicle in which the system is located), such as via lighting, and preferably including transmitting a signal (i.e. RF) to approaching vehicles which can preferably be repeated (retransmitted) by those vehicles. The receiver is preferably integrated with the distance detection module for mounting toward the front portion of the vehicle directed forward.

A global positioning system (GPS) may be configured for performing the radio frequency transmission and reception of danger signals between vehicles, although less preferably directional transmission characteristics can result. The annunciation ability of the GPS unit, such as a moving map display device, may be utilized by the system for announcing danger situations to the driver. Optionally the computation power of the GPS unit can be utilized as the main computer processor of the system, wherein distance and other metrics are evaluated to determine if the level of danger that exists exceeds an annunciation threshold, wherein the danger is communicated visually from the rear of the vehicle or via communication transmissions directed rearwardly to approaching vehicles.

The forms of annunciating the alert are described in the parent application, such as including activating reverse lights, and providing visual or audio alerts near the dash for the approaching driver in response to danger information received in data communication from preceding vehicles.

A computer processor within the system evaluates the dangers to determine if the danger should be annunciated, and to what extent. Preferably the program executing on the processor evaluates additional metrics such as described in the parent application, incorporated herein by reference, to assess the danger. For example, vehicle speed can be very important to properly determining the danger associated with a given following distance and closing speed. Speed can be registered from a separate sensor, although it preferably receives information from the speed sensor integrated within the vehicle.

The system is also preferably configured for receiving information from tire-based sensors, such as inflation sensors, an application of the inventor being incorporated herein by reference. Problems registered by the tire-based sensor, such as a blow-out, are utilized by the system in assessing the threat danger to be annunciated to approaching traffic. Furthermore, the system can evaluate information from tire-based sensors such as swerving, braking, skidding, and so forth depending on what information is available from the specific tire-based sensor utilized within the vehicle.

FIG. 42 is a block diagram of an illustrative embodiment of the collision avoidance system 1110. A computer 1112 with memory 1114 is configured for registering sensory inputs, evaluating dangers based substantially on the monitored distance, and of generating danger signals for annunciation to approaching vehicles, such as optically or via data communicated to a system within the approaching vehicle which annunciates the data if it exceeds the danger threshold, such as set by the driver of that vehicle. An interface 1116 is shown which controls the operation of a distance sensor 1118, such as one which transmits a directional signal and registers its reflection. Distance sensor 1118 may operate on any convenient electromagnetic wavelengths such as optical or ultra-high radio frequency, or may comprise audio in the ultrasonic wavelengths. Other forms of sensor may be utilized without departing from the present invention.

Computer 1112 registers the distance and computes closing speed determined from comparing sequential distance measurements. The distance and closing speed, preferably along with other factors, are compared against a collision danger threshold. If a sufficient collision danger is found (i.e. short distance and fast closing speed) to exist then computer 1112 generates an annunciation to approaching traffic, such as controlling lighting interface 1120 which activates a mode of rearward exterior lighting 1122, such as conventional incandescent back-up lighting. The light output is preferably modulated to aid in recognizing the collision danger situation, such as at a frequency within the range of frequencies spanning from about 2 Hz to 200 Hz, or more preferably in the range of from 4 Hz to 10 Hz. It will be appreciated that the use of lighting other than incandescent lighting can be utilized, such as LED lighting, and so forth without departing from the teachings of the present invention.

The computer preferably receives additional information upon which to assess the relative level of collision danger which exists. By way of example, a speed sensor 1126 is shown for registering the speed of the vehicle, for basing the dangers associated with distance and closing speed. Furthermore, a braking intensity sensor 1128 is shown for registering panic braking or other forms of rapid braking by the driver of this vehicle to be communicated to approaching drivers as a form of collision danger alert. As described in the parent application, additional and/or alternative information may be sensed, such as direction of travel, roadway incline, rate of turn (i.e. swerving), impacts (i.e. air-bag deployment), emergency vehicle approach, posted emergencies or construction, tire-conditions (i.e. blow-outs), and so forth and combinations thereof. The directional nature of the data communicated between vehicles is preferably enhanced both by limiting the distance and/or depth of vehicles over which retransmission occurs, by encoding directional information into the data being communicated, wherein upon receipt the receiving system can determine the applicability of the data, for example ignoring reflected signals from traffic passing in the opposing direction, side streets and so forth.

Each packet of data transmitted may optionally include a timestamp, such as from an onboard GPS unit, which can be utilized for very accurately time stamping a data transmission. Vehicles receiving a collision alert transmission from another vehicle can then compare the timestamp with the time maintained by their GPS unit (extremely accurate high resolution satellite updated time base), to determine if the alert is still valid. Optionally, with each retransmission of a collision alert signal the original time of the alert and the time of the latest retransmission can be included within the data, wherein the system receiving the alert can better assess the age of the alert, how recently retransmitted, and in some cases the distances. The number of retransmissions for a collision alert signal is preferably controlled at least in part by the timestamp value. For example, controlling regeneration based limiting the duration over which a retransmission can be performed in relation to the originating event and/or the previous transmission. It should be appreciated that the distance that the system is preferably configured with programming for determining the time delay since an alert was transmitted (and compensating for encoding and reception delays which are preferably predetermined for the system), wherein the system can determine the distance to the transmitting vehicle so that the validity of the alert and possible retransmission thereof can be properly assessed.

The distance information received from the distance sensor within the present invention also preferably regulates the number of sequential retransmissions of the collision danger alert sent within data communicated rearwardly. For example, a hard braking signal generated at freeway speeds by vehicle 1 is received by vehicle 2 which is following vehicle 1 at a distance of 100 yards, wherein an abrupt stop by vehicle 1 does not present a collision danger to vehicle 2, and so the system of vehicle 2 does not retransmit the collision signal. By way of a second example, if vehicle 2 were following at 20 feet at freeway speed, then the collision avoidance signal from vehicle 1 based on hard braking or excessive closing speed with a vehicle ahead would be communicated with a high repeat value to approaching traffic. It will be recognized that in so doing the available response time for the approaching vehicles can be substantially increased.

Additionally, or less preferably alternatively, the annunciation is generated as a data communication directed to receivers located in approaching vehicles. Signals are received from previous vehicles (vehicles ahead) from an antenna 1130, preferably directional and directed forward, which is coupled to interface 1116 containing a receiver (it should be appreciated that the distance sensor and receiver can be implemented as fully separate modules without the need to share interface 1116). The computer thereby receives data from vehicles up ahead as to the dangers that exist. A transmitter 1132 is shown coupled to a directional antenna 1134, for communicating collision dangers that have been detected within this vehicle and those received from vehicles up ahead, insofar as the signal depth of repeatability remains valid to allow for retransmission.

### 8 RFID AT POINT OF SALE USING OBJECT IMAGING VERIFICATION

### 8.1 PROBLEM DESCRIPTION

RFID tags promise to streamline order processing, tracking, and even point of purchase processing. They provide the ability to register the presence of a tagged item without the need to scan a bar code.

The Applicant has recognized that one of the problems with performing self checkout on the articles is that tags can be removed, swapped with other tags and so forth, wherein the proper charges would then not be registered. The present invention overcomes this problem and others at the point of sale or in other applications.

### 8.2 DETAILED DESCRIPTION

FIG. 43 illustrates an embodiment of a system 1210 for verifying that the items being detected by an RFID system, such as at a point of purchase, are the same as the physical items associated with the RFID. An imaging system, comprising at least one imaging device, illustrated by a first camera 1212 and second camera 1214 registers the collection of items 1216 to be purchased, depicted as items 1218, 1220,1222 and 1224 within a basket 1226. The RFIDs are read by a reader head 1228 by a computer 1230 on the articles and images of the items, and/or visual characteristics (i.e. package size, package weight, packaging markings (color, text, images)) for those items from a database 1232 describing the items. The computer compares the database information against that collected from the imaging system. Each item is compared to be sure the appropriate item is registered, and that all items present have been registered by the RFID reader system. The elements can be compared based on visual characteristics, image patterns, or any convenient visual recognition criterion which are known in the art.

The imaging can be extended with imaging that extends outside the visual range. For example, using infrared detectors 1234, inductive sensing 1236, ultrasound imaging 1238, x-ray imaging (source 1240 and detector 1242), or other means of detecting characteristics of the items within the packages, assuring that the correct item and number of items is in the package.

FIG. 44 illustrates a flowchart for processing within system 1210. Images are collected at block 1250, and optionally processed to extract information or simplify the images at block 1252. The RFIDs are read from the items (this may be performed at any stage of the flowchart—such as before the images are collected). The computer then looks up in block 56 the image based data for each of the items which were registered when the RFIDs were scanned. The collected images are matched with the image data in the database at block 1258, the matching must fulfill certain thresholds in the criterion being checked to be considered a match. Finally, an alert is generated at block 60 if any items read by RFID did not match the items whose images were detected in the cart, such as unscanned items (i.e. missing or disabled RFID transponder), items that generated an RFID which did not match the image data (i.e. RFID tags were swapped).

Alternatively, the system can be utilized with bar coding systems to similarly verify that the item scanned matches the imaging information, and other characteristics about that item.

### 8.3 ABSTRACT

An apparatus for corroborating the data collected from an RFID system, such as at the point of purchase, with the physical item whose data was collected.

### 9 AUTOMATED CARTOGRAPHY UPDATES IN RESPONSE TO FILING OF BUILDING PERMITS

### 9.1 PROBLEM DESCRIPTION

Creating updated maps which reflect all building changes is costly and often not practical. These maps for example may be utilized within moving map display systems for depicting cityscapes with buildings being represented properly. Furthermore, mapping provides useful data for government agencies. The present invention solves that problem and provides additional benefits.

### 9.2 OVERVIEW

The present invention provides a method of automatically updating cartographic, (mapping) information, such as for use in moving map displays and for other mapping needs involving building position and related information. The present invention requires that any change to building structures requiring a building permit are documented with regard to coordinates and information about the new building structures. Furthermore, county property tax records, or other form of ownership and use information records are preferably coupled to the database wherein information is made available as to the establishments which own the specific structures. This collection of information allows accurate maps to be created and maintained at low cost. The information from the database may be provided free to government agencies with any necessary level of detail, and to external agencies and the public at preferably a lower level of detail. Access to the map data may require payment of fees.

Requiring that upon approval of a building permit that details as to the construction are uploaded to a cartography database (i.e. for the county or state), which is made accessible to other moving map programs. When a building permit is received, the controlling agencies can readily pull up information from the database to ascertain what is on and near the location. Information about when the start of construction is to begin should be listed, or the information released into the database a given period before construction starts allowing databases to be properly updated.

### 9.3 DETAILED DESCRIPTION

The system preferably provides multiple levels of information dissemination. For example all data is made available to planners and other government agencies. However, the information provided to external users is preferably more limited, such as to knowing what is the land use, size and relative location of the structure. Organizing information dissemination in this manner provides a seamless means by which governments can properly plan growth, while providing for automatic updating of mapping that is utilized by industry and the private sector.

For example in moving maps for vehicles and aircraft. In the example above, the moving map for an aircraft database can be automatically updated, when an open filed (i.e. which could be listed as a landing site) is slated for construction. Systems relying on the mapping information, thereby can use information about the size and location of new construction to determine if a site is still suitable for a forced landing.

FIG. 45 depicts a system 1310 configured for receiving building permit data 1312 which requires the inclusion of conventional lot number and address fields along with topological information about the lot (i.e. boundary coordinates), as well as two, or more preferably three dimensions the coordinates of the structure (or structure being built). A date of completion is also preferably provided. Furthermore, information about the use and ownership of the structures 1314 are preferably collected from a separate set of information (although less preferably this information could be provided with the building permit submission). Since information about use of structures is subject to changes over time even without any building permits being filed, this information is preferably updated by collecting information whenever the business changes hands or a new business permit is issued for the establishment. One preferred means is collecting information used for county property tax records, or other government records containing information on the establishments within a given property. This information being input into the system containing information on location for matching with the structure data above (i.e. address, lot number, and/or coordinate information). A category for the entry is provided which allows selecting the form of business, personal or government use of the structure. Furthermore, the selection of a category defines which fields are present for the given record. Fields are provided within the record to allow businesses to give information about their business name, type of business, hours of operation, description of operation and so forth, as may be useful for those that may want to do business with the organization. Information about private residents being preferably retained in private, although government agencies could preferably utilize the data to speed the finding of residences.

A collection interface 1316 is shown for converting user inputs into database records, this can be accomplished using conventional key entry personal, computer readable forms, and the like. The records are entered into a database 1318, or multiple related databases. The database is shown with optional partitions 1320, 1322 for containing the records 1312, 1314 in separate connected databases within the larger database. A computer 1324 is shown for organizing the database, formatting entries into the database, and executing queries and updates in relation to the database.

Programming for the computer is preferably configured for securely outputting data to government agencies, such as through a first server 1326. A second server 1328 is shown through which non-secure public use data can be disseminated, such as over the internet 1330. A cartography organization 1331 is shown which can access the merged building and use data within the database, such as for a fee. The data generated for public use being stripped of any private data. Preferably, the data in the database is merged to generate a separate public use database, which contains only public records built from the original database, in this way there is provided no means by which programming errors in the main database program could disseminate private information to the public as the information would not exist in the database driving the server which dispenses this information.

By way of example the cartography organization receives the building and use information on computer 1332 and stored on data storage unit 1334. The cartography organization then builds one or more map representations under the control of a user at a control console 1336 from the data, such as with computer 1332 or other computers. Typically external data is also collected, such as topological information, sponsored information, and so forth. One or more types of completed maps can then be communicated over the internet, or served through a web server 1338 allowing users to download the information from the internet. The raw mapping data from the system or completed maps generated by the cartographer organization can be utilized on computer systems 1340, in moving map display systems 1342, wireless applications 1344 (i.e. phones, PDA, etc.), and a variety of other applications.

### 10 VEHICLE VERTICAL ROADWAY TRAFFIC CLEARANCE ALERT

### 10.1 PROBLEM DESCRIPTION

A number of collisions occur each year in which vehicles with an extended height collide with low clearance obstructions, such as under bridges, within parking garages and so forth. Typically the clearance height is posted, but in many cases the drivers do not recognize that their load exceeds the vertical space available. The worst of such incidents occur on roadways, especially highways and freeways in which a collision at a high speed with an obstruction can result in death or injury for a large number of parties. On a less dramatic scale, smaller trucks often collide or get wedged into parking garages.

### 10.2 OVERVIEW

The present invention provides a “Vertical Traffic Clearance Alert” which detects upcoming vehicles or protrusions therefrom which will exceed the available clearance wherein a warning is generated, such as with light and optionally audio. Objects breaking a substantially horizontal sense plane (except on hills) are detected preferably using optical sensing. By way of example a laser projecting back from an area of reduced clearance, preferably sweeping an angular range on a horizontal plane or other shape corresponding to the shape of the object for which vertical clearance is detected. Reflected light from the laser is monitored with a means for detecting reflections of the projected light.

Preferably, the laser source is modulated and the detecting means is configured for ignoring light components that do not represent the transmitted modulation.

An annunciator is activated in response to the detecting that an object is breaking the beam or plane of a scanned beam. The annunciator preferably comprises a flashing lighted warning, although any convenient form of annunciator may be selected.

In a preferred configuration a display is provided ahead of the sensor allowing the driver to view clearance information as the vehicle approaches the area of reduced clearance. The present invention is preferably configured to read out the distance of the a portion of the vehicle from the sensor along with information about the available height clearance.

By way of example, a laser transmitter-sensor head can be canting slightly downward from the horizontal, and the distance from the transmitter to an object breaking the plane of the light beam determined. The system can then update the display with information about the available clearance. By canting the sensor slightly downward the system can warn a driver early if any possibility of insufficient clearance exists, thereby allowing the driver to move slowly forward wherein the system then makes more accurate determinations as the vehicle nears the obstruction.

### 10.3 DETAILED DESCRIPTION

FIG. 46 depicts an embodiment of the detection system 1410 for indicating to approaching drivers of a height problem. A bridge 1412 is shown with clearance 1414 and height detection system 1416 with and annunciator 1418. A vehicle is traveling toward the clearance 1414 in structure 1412 and a laser output 1422 directed from system 1416 is reflected from the vehicle 1420 and reflected back to the system 1416. Multiple beams may be generated, or more preferably the output beam may be scanned in the horizontal axis to assure covering the lane, or lanes, of traffic being checked.

In response to detecting an on coming vehicle which extends above the vehicle clearance, the system generates an alert to the driver a sufficient distance prior to the vehicle arriving at structure 1412. Although shown attached to the structure for which clearance is to be determined, the detection and annunciation system is preferably placed on a post or other structure at the appropriate height and angle at a sufficient distance preceding the limited clearance structure 1412 in cases in which the vehicle is traveling at a high rate of speed such as on a freeway, highway or similar.

The laser output may be within the visible frequency range, or may extend into the either the UV or less preferably into the infrared range, or combinations thereof. It will be appreciated that green laser light has a longer visible range. The use of UV light has the advantage of not posing a distraction in cases wherein the road slopes down toward the obstruction. The laser output is preferably encoded so that background energy can be discerned readily from the returning signal. Furthermore, the encoding of the laser preferably is configured with a pattern wherein a distance can be detected from the time required for the signal to travel out, be reflected, and return. It will be appreciated that these encoding methods are known in the art wherein more detailed description is not required. By angling the laser output the unit can be configured to provide warnings for vehicles at a far distance which MAY not have sufficient clearance, the warnings becoming more intense as the distance to the obstruction decreases and the accuracy of measurement increases.

For example imagine a structure clearance of 14′0″ wherein the laser can be directed slightly downward such that at 10′ distance or less the 14′0″ is checked (sensor being 10′ ahead of obstruction), while at 60′ distance the height check is at 13′10′, and at 110′ at a height of 13′8″. In this instance, those with loads approaching the limit are warned. The purpose of this is to alleviate problems with accuracy and to slow traffic that “may” not have adequate clearance. Waiting for the vehicle to reach the obstruction would not otherwise provide sufficient reaction and stopping time.

FIG. 47 depicts the system 1416 with display 1418 and annunciators 1426,1427 (i.e. sound and light) coupled to a control element 1428, such as a microcontroller, or other hardware or programmable control element. A transmitter 1430 is shown with collimated beam generating device 1432, depicted preferably as a laser. A detector 1434 is shown for detecting the reflections of generating device 1432. Detector 1434 is shown as a optical transistor, preferably configured to respond to the wavelength of the beam generating device 1432. The transmitter 1430 is preferably modulated by circuit 1438, while the received beam reflection is demodulated by circuit 1440. The modulation preferably comprises a clock 1442 which can be used to discern the received signal from interference, therein increasing the signal to noise ratio. Also modulation is shown being encoded with a detectable distance pattern 44 (may be the same as that for discerning interference, or a separate pattern), which is also decoded in the reflected signal and passed to controller 1428. In response to detecting insufficient distance, controller 1428 generates an appropriate warning, such as an output on display 1418, activating of audio alert 1426, and/or warning lights 1427. It will be appreciated that since few vehicles are subject to clearance problems the system need not notify the specific driver whose vehicle has the clearance problem.

It is preferred that the warnings be provided with higher “intensity” (i.e. more severe alert such as bigger, louder, more emphatic) as the driver approaches and the accuracy of the measurement is increased. Optionally, the display can output the speed of the offending vehicle, in particular if that vehicle is speeding. The controller is preferably configured with programming that selects an appropriate emphasis for the annunciations in response to both distance and speed as well the probability that the clearance limit will be exceeded. A clear case of exceeding the clearance in this instance being annunciated with higher emphasis.

Also shown in the figure is the use of a remote detector 1446 allowing the clearance problem to be detected at any arbitrary distance before the limited clearance structure is reached. The remote detector comprises a receiver 1450 (or transceiver) for receiving signal conditions from a transmitter 1452 coupled to a measurement controller 1454 which operates an optical transceiver 1456 with optical input/output 1458. It should be appreciated that the remote detection may be performed either in line with the roadway as shown, or less preferably in response to an “electric-eye”, beam breaking form of detection, although this cannot provide speed information to allow the emphasis of the warnings to be more accurately controlled.

### 11 LASER CUTTING HEAD FEED SENSOR

### 11.1 PROBLEM DESCRIPTION

Backing plates are utilized in many industrial fields for capturing the damage of a laser cutting or drilling operation so that it does not cut into the equipment itself. These backing plates often require frequent replacement. Often the sacrificial backup plates are cut excessively during laser cutting of a material. The depth of the cut is set to assure that the material is cut through, wherein the backing may be cut to a significant depth in many instances. Unfortunately, this method of cutting wastes power and can readily make the backing plate unusable.

The present invention reduces the number and depth of cuts on the backing plate while reducing energy consumption.

### 11.2 OVERVIEW

It has not been appreciated in the industry that both energy and materials are being wasted as the backing materials are cut through. The present invention provides a backing which provides feedback to control the cutting operation, wherein less energy, time and material are wasted.

The invention couples a means for sensing cut-through with a cutting speed, intensity, or depth control device wherein laser cut through is better controlled with less damage to backing plates, less wasted energy and more rapid cutting. Embodiments of the invention are described which utilize vapor generating backing, a direct optical detecting backing, and an indirect optical detection backing.

An optical detector (or other detector configured for the specific backing plate) is coupled within the backup plate to detect a cut through situation, wherein the information is fed back to the control processor which marks that area as having already been cut through wherein it then cuts other regions until they are likewise cut through. The controller of the system preferably compares the estimated time for cutting through (cutting speed) with the actual measured cut-through wherein it preferably updates the cutting rate to speed job completion and minimize the amount of cut-through.

The device can also allow the user to almost cut through, wherein a final release cut, or manual release, can be performed so that a clean release occurs. To facilitate clean cuts it is preferably that the power output or timing be modulated so that a cut through “dotted line” is produced on the cut path just prior to cut through. In this way the sensor can sense that cut through is about to take place, especially when cutting through completely opaque materials such as steel.

### 11.3 DETAILED DESCRIPTION

FIG. 48 illustrates by way of example a laser cutting apparatus 1510 having a laser cutting head 1512 emitting cutting beam 1514 to cut a workpiece 1516. The laser head can be moved in reference to a stationary workpiece platform, or the workpiece may move, or a combination thereof to provide the desired cutting speed through the workpiece.

In this embodiment a first backing 1518 is provided which is of a transparent, or semitransparent material. A second backing 1520 is configured with a means of detecting the optical energy as the laser cuts through the material of the workpiece. In this example the detecting means is shown as a reflective (i.e. silvered) structure 1522 which reflects the light from the vertical direction, wherein a portion travels horizontally and is registered by an optical detector 1524. A controller 1526 receives the “cut-through signal” from the optical detector and modulates the cutting speed, wherein the cutting speed for a given laser power is maximized, while minimizing the wasted power of the cut through. In pieces has different depths, it will be appreciated that controlling cut through without just guessing based on depth of cut can save substantial resources.

The reflective region 1522 can be replaced with an photocell, such as a polymeric photocell material, which directly converts the impinging light to a voltage signal. The output signal from this photocell region is then coupled to the controller, such as to an A/D converter input.

### 12 OPTICALLY CONTROLLING A DIRECTED AUDIO SYSTEM

### 12.1 PROBLEM DESCRIPTION

A number of situations arise in which it is desirable to be able to “aim” audio to a given location with fair precision. Current technology utilizes an audio broadcasting mode where the sound is scattered everywhere including the location to which it is intended.

The present invention provides directed audio to a selected location and overcomes drawbacks with a number of previously attempted solutions.

### 12.2 OVERVIEW

The present invention provides a system and method of controlling the directing of audio to a specific location. The invention allows the user to visibly direct the audio source to a given destination, or range of destinations.

At least two ultrasonic transducers are configured for relative motion with one another to control the point of intersection of the audio beams. The transducers may be flat panels which are articulated to provide positioning, or the transducers may be located on a flexing base, such as on a parabolic flexing structure in which the parabolic “radius” changes in response to flexure.

A convergence indicator is preferably provided, such as a laser that is in line with the direction of each ultrasonic transducer output. The user can control the orientation of the panels (manually, or by actuation) and see the convergence point of the audio where the audio stream will be heard.

The apparatus generally comprises (a) multiple focused ultrasonic acoustic transducers; (b) at least one focused light source configured to generate one or more beams of light; (c) encoder for converting audio in the range of human hearing to a frequency difference spanning two or more of said ultrasonic acoustic transducers; wherein said focused light source is aligned with the focus of said ultrasonic acoustic transducers for indicating the location at which the sound is directed. The apparatus can further comprise one or more of the following. (i) A means for directing the distance at which two or more of said ultrasonic acoustic transducers converge. (ii) A means for visually indicating the convergence location, such as multiple light beam sources configured for having their output beam directed in the same direction as said multiple focused ultrasonic acoustic transducers. (iii) An articulated shape base to which said ultrasonic acoustic transducers are coupled, with light sources coupled to said articulated shape base.

A number of applications arise for optically controlling the audio convergence location, such as on police and military vehicles, handheld directed audio units (i.e. similar to a megaphones or so called “bull horns”). The strategic importance of being able to speak (or direct desired sounds such as vehicles) to one group of enemy elements while conveying different audio information to another element should be readily recognized. In the police and civilian realm it will be appreciated that the unit allows for communication at even high audio intensity, with a first group while not disrupting others in the vicinity, as occurs with traditional audio mechanisms.

The units can be configured to provide a combination of non-directed audio and directed audio, or generating directed audio to a first location while another audio stream is directed broadly. The system can utilize prerecorded audio, such as generated for non-directed audio for crowd control, warnings and so forth.

### 12.3 DETAILED DESCRIPTION

FIG. 49 and 50 depicts an embodiment 1610 of a directed audio megaphone with a laser convergence indicator. To a base 1612 are coupled at least two ultrasonic transducer panels 1614, 1616, such as to joints or actuators 1618, 1620 which couple the panels to member 1622 utilized for providing structural rigidity and carrying the signals to the panels. It will be appreciated that joints 1618, 1620 can be utilized to allow the user to perform fully manual direction adjustments. It is preferred however that a more precise means of control be utilized. Consequently, actuators 1618, 1620 are preferred wherein they can be implemented using a mechanical control, such as a central control from which elongated members (i.e. wire, ribbon, stiff control rods, etc.) extend to each panel for controlling the direction. This embodiment in the figure, however, will depict the user of electrical actuators 1618, 1620 for controlling the direction of the ultrasonic transducers. A hand-held control 1624 is provided, such as in the form of a hand grip 1628 having a set of user controls 1630. A battery pack 1626 (i.e. similar to that utilized for cordless drills) is preferably attached to the base of the handgrip to provide operating power. A microphone input 1632 is provided for coupling user audio input for output from the transducer panels.

A set of lasers 1634, 1636 is shown generating beams 1638, 1640 which coincide through the center of the ultrasonic audio generated from panels 1614, 1616. An optional rough citing device 1642 is shown to which the beams can be centered on.

An option speaker 1644 is shown combined with the unit allowing the user a choice of directed audio or non-directed audio, or both.

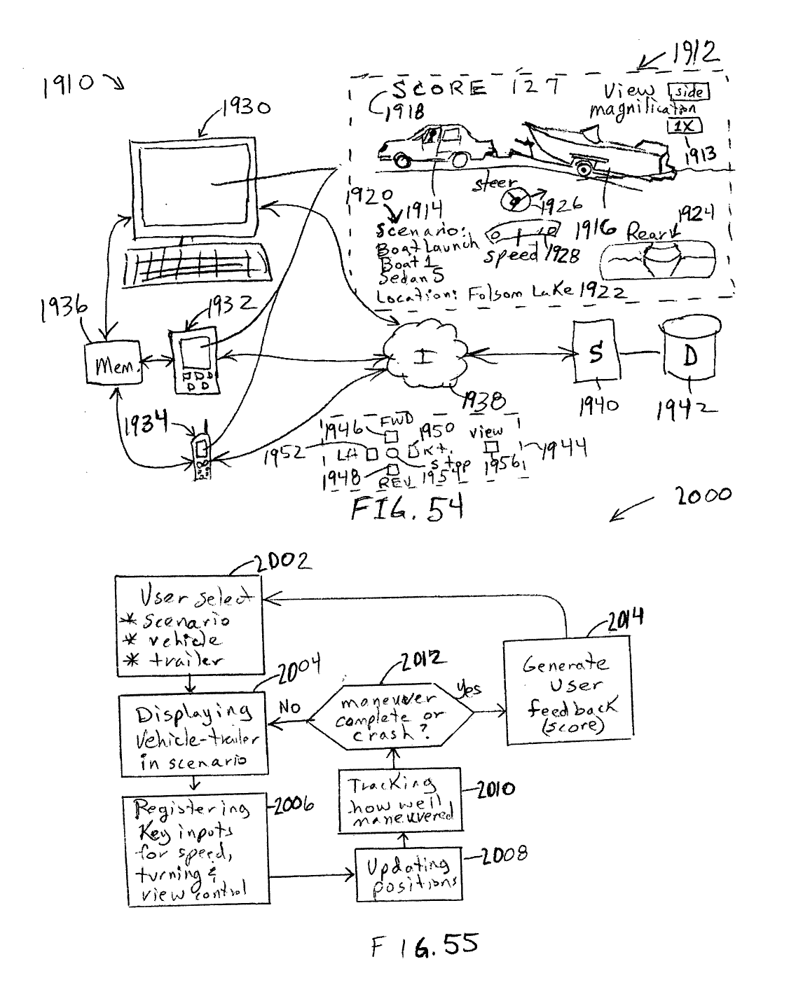

FIG. 51 illustrates an example block diagram of the system. A controller 1650, such as a microcontroller, microprocessor, or other control system is shown controlling the elements of the system. It should be appreciated, however, that a less capable system can be constructed without the need of a computer element, in particular if the user controls are provided either as manual controls (i.e. for adjusting convergence) or as analog controls (i.e. laser activation, distance readout). The microprocessor allows for the use of a more sophisticated user interface, as well as for the storage and retrieval of sound segments from a memory, such as for storing segments of speech to repeat, storing sound effects, and so forth.

At least ultrasonic transducers elements 1614, 1616 are provided, although any number may be utilized. An audio conversion circuit 1652 is configured for converting an audio source to multiple ultrasonic signals having the received audio as a beat frequency. For example in the case of an input tone of 2 kHz, conversion unit 1652 generates two ultrasonic outputs which have a frequency difference of 2 kHz. The input audio is said to be encoded in the output audio. This can be accomplished by maintaining one stream at a fixed frequency and modulating the other with the audio signals, although there are numerous techniques for this known in the art, wherein further description is not necessary. The input audio is shown being received on microphone 1654 and being conditioned and amplified by pre-amp circuit 1656 prior to being received by audio conversion circuit 1652. The input audio from pre-amp 1656 can technically be anything within the nominal range of hearing (20-20,000 Hz) though practically the range need only span from about (200-8,000 Hz) to provide good audio quality for this application. The range can be any desired input range depending on the desired audio quality desired and cost trade-off issues. It should be remembered that conventional POTS telephone equipment has only about a 3 kHz bandwidth. A microphone control 1657 is shown, preferably in the form of a trigger or other easily activated control switch, that when pressed takes the audio stream from the microphone for output to the converged location.

Laser elements 1634, 1636 are positioned in alignment with the path of the ultrasonics generated from transducer elements 1614, 1616. These beams are preferably activated and deactivated under user control, because once the proper location for convergence is established the laser output need not be maintained. The positioning of the ultrasonic elements 1614,1616 and lasers 1634, 1636 is depicted as being controlled by a set of electrical actuators 1658, 1660 powered from driver 1662 which receives control inputs from an I/O port 1664 (or directly from the processor or from a separate (i.e. non-intelligent control). The actuators can comprise geared motors, piezoelectric actuators, muscle wire, or other forms of translation. Alternatively, a mechanical means of deflecting the ultrasonic audio into a position of convergence can be utilized. A distance control 1666 is shown to allow the user to select an approximate distance, while a distance output gauge 1668 is shown which can display estimated distance based on convergence angles, or more preferably can utilize coding of the laser beam in conjunction with optical receivers for detecting the reflected laser beam and determining distance based on round trip delay. These techniques for determining distance are known in the art wherein detailed description is not necessary. Furthermore, the optical detectors can be utilized within the device for “listening” through windows or other similar surfaces which vibrate in response to sounds. The technique converts the amplitude of reflected light, collected over a small arc, into audio and is well known in the art.

A memory 1670 is configured for storing prerecorded audio, sound effects and so forth, as well as for recording repeating loops and so forth for output over the system. A number of controls, exemplified by switch 1672, including control knobs and other conventional controls can be provided for directly controlling operational aspects, or indirectly communicating the desired configurations to the microcontroller. For example, controls for the storage and playback of audio from the memory, and so forth.

### 12.3.1 SUBFEATURES

In another embodiment of the invention, the ultrasonic transducers are separable from the control base, allowing them to be farther dispersed in the field, and providing increased safety as the party communicating need not be at the position of the transducers. A wireless link is preferably provided between a control console (i.e. hand-held) having a microphone and control inputs and a remote portion including the audio panels. The panels may be configured for moving in angle to change the convergence if attached to a single base. If the ultrasonic transducer panels are separate, then it is preferred that each be mounted on a two-axis stage allowing the user to control their positioning, such as after actuating the laser. The user would preferably activate the laser for each unit separately and generally align them to the target and then activate all lasers and make fine adjustments to the convergence.

### 13 NOISE ABATEMENT BACK-UP ANNUNCIATOR SYSTEMS AND METHODS

### 13.1 PROBLEM DESCRIPTION

Construction crews often must work through the night to minimize the disruption to traffic and speed the time to completion. To prevent collisions between vehicles and pedestrians or other vehicles being driven, the vehicles utilized for construction have been equipped with audio annunciators which emit a loud intermittent sound, beeping, any time the vehicle is put into reverse.

However, as construction vehicles are subject to moving back and forth, such as in the case of a skip loader, backhoe, tractors, and so forth, the audio is generated nearly continuously and can be a severe nuisance to the surrounding neighborhoods where persons are attempting to sleep. The sound level even seems accentuated at night since the normal traffic sounds are not present to soften the noise.

### 13.2 OVERVIEW

The present invention provides a system and method of reducing the audio disturbance caused by back-up annunciators. Described are several aspects of the invention which can be implemented separately or in various combinations.

By way of example and not of limitation the following neighborhood-friendly aspects can be implemented singly or in combination.
1. condition sensitive—modulates intensity of beeping in response to time of day.
   (i) manual selection of mode. User input device. Also preferably over-ride for the following.
   (ii) sense time of day (a) clock or atomic clock, (b) sense light intensity (but can be affected by artificially generated light).
   (iii) reduce audio intensity during evening hours.
   (iv) generate flashing light to augment audio output.
   (v) generate beeping during daylight hours and flashing light at night.
2. obstruction sensing—modulate intensity of annunciations in response to obstructions in vicinity.
   (i) generate audio only in response to sensing objects.
   (ii) generate audio in evening hours only in response to sensing objects.
   (iii) modulate intensity of lighting or sound in response to presence of obstructions.
   (iv) e-field sensing of objects in the vicinity.
   (v) modulating the direction of annunciations in response to position of obstruction.
3. collimated audio source-limit area in which audio heard.
   (i) generate directed ultrasonic audio at all times, or more preferably sensed at night.
   (ii) generate collimated light beams generally corresponding to the area of the ultrasonic audio as visible sign of extent of overlap.

The present invention provides a number of beneficial aspects for controlling the nuisance factor of vehicle backup annunciators, especially when utilized at night.

### 13.3 DETAILED DESCRIPTION EMBODIMENT

FIG. 52 depicts a back-up annunciator system embodiment 1710 shown on a vehicle 1712 (outline shown in phantom) which is particularly well-suited for use by construction equipment that operate, or may operate, at night in populated areas. It should be appreciated that the embodiment shown comprises a number of optional elements and elements which can be combined in a variety of combinations without departing from the teachings of the present invention.

An annunciator 1714 is shown, such as a piezo-electric transducer or beeper circuit, although speaker elements or any other convenient means of generating audio in the audio spectrum can be utilized.

A control circuit 1716 is shown for controlling the operation of the backup annunciation elements, and may comprise discrete circuits, custom or semi-custom circuits, microcontrollers, or any combination thereof. The use of a small microprocessor allows provides benefits with regard to controlling the activity of the system, easier interfacing to user controls and inputs, as well as easy customization and updating of system operation.

A reverse input 1718 is received by control circuit 1716 for indicating to the control circuit that the vehicle is backing up. The reverse input is shown for being coupled to a transmission mounted switch, or coupled into the lighting system, although it should be appreciated that the signal may be received in any desired form. Furthermore, the system may provide its own sensing of backing up based on the direction of acceleration, the sensing of ground movement (i.e. similar to how some optical mouse checks images from sequential frames), or any other desired form of sensing.

A driver circuit 1720 is shown for controlling the audio output from annunciators 1714, herein depicted as an inverting and non-inverting amplifier coupled to an intensity control 1722 regulated by control circuit 1716, such as a electronic potentiometer or other convenient means of regulating the drive voltage and/or pulse-width modulation of the output to control audio output amplitude.

Optionally, a means of user control of mode and intensity can be provided. The mode of the system can entail selecting day or night operations, selecting which of the outputs or combination thereof is to be utilized, and so forth. In this embodiment the equipment operator (or other party in authority) can control the mode of operation and intensity of audio output, especially for the substantially non-directional audio output 1714. These controls are depicted as a day/night switch 1724 and intensity control 1726, however, it will be appreciated that any form of user inputs may be utilized. Furthermore, the system can be configured for allowing for a plurality of positions, such as in response to the population density of the constructions area.

An optional GPS 1728 is shown which can be utilized for controlling the mode of the system based on location and proximity to residences. In addition, it should be appreciated that GPS provides a very accurate time clock signal that can be utilized by controller 1716 for regulating day and night mode. It should be appreciated that GPS 1728 need not be part of the annunciator, as a signal can be received from a GPS located elsewhere in the vehicle. Preferably, a GPS is coupled to a moving map style display for the driver, wherein the map may contain information about the allowable noise levels in areas depicted on the map. The GPS system can be utilized for generating an output to the annunciator in response to the noise abatement level at which the vehicle is located, in this way controlling the mode of controller 1716 for generating annunciations.

Another optional means for generating time of day information is depicted as a clock 1730 shown with inputs 1732 and output 1733 for setting the time. More preferably a signal is received from an atomic clock 1734, or the GPS 1728 as already mentioned, wherein the time is maintained continuously without the need of ever setting the time.

Less preferably, the outside light can be sensed by a circuit 1732 to determine the difference between daylight and night conditions. Shown is a resistor coupled to a resistive photocell, although any form of light sensor may be used. However, it will be appreciated that due to the use of intense artificial lighting, and working in shady areas during the day, this form is sensing is more subject to error. If used it is preferred that a filter 1738 be utilized for preventing false detections. For example, artificial lighting typically fluctuates at a given frequency as determined by the power mains (60 Hz) or the generator being used, wherein the filter can filter out artificial lighting allowing daylight to be sensed properly. In addition, or alternatively, the temporal characteristics of the light can be detected, such as presuming it is daylight if the propensity of light from different sides of the vehicle detect light.

At least one optional proximity sensor 1740 is shown for use in selected embodiments for modulating the operation, such as mode, of the backup annunciation system in response to detections of obstructions behind the vehicle. For example optical, electromagnetic, radar, ultrasonic, and other forms of proximity detection can be utilized. In one embodiment it is preferred that the unit sense any obstruction rearward of the vehicle without being too directional. For example the use of electric field sensing can be utilized, as it can register the changes in field intensity in response to obstructions presented over a wide area rearward of the vehicle. Even directional sensors, can be utilized, however, covering sufficient rearward directions behind the vehicle can require multiple sensors or modulating the direction that the sensors are directed.

In the above described elements, the intensity of the audio output from annunciator 1714 may be modulated in response to time of day, lighting, obstructions, location and/or user inputs. Embodiments may be implemented of the invention which contain any one or more of these elements without departing from the invention.

One or more lighting assemblies 1742 may be coupled to the backup annunciator for generating enhanced levels of lighting in response to backing up. It will be appreciated that vehicles typically already have backup lights, but in many cases these are not of sufficiently high intensity, and rarely are configured to strobe to create an alert effect. It is preferred that one or more high intensity LED elements be utilized, although other forms of lighting may also be selected.

An optional multi-element distributed directional ultrasonic audio element 1744a, 1744b can be coupled to the rear of vehicle 1712, and directed so that the signals from the multiple elements are configured to overlap in the area behind the vehicle to provide a warning. It will be appreciated, however, that the audio signal which can be heard by humans is encoded as a beat frequency between the multiple ultrasonic heads, wherein audio which can be heard by humans is only produced in the area where the ultrasonic outputs overlap, as shown by the hatched area. The ultrasonic transducers are shown in a slightly dome shaped configuration wherein the angular spread of the signal is increased to assure that the ultrasonic signals overlap one another covering a sufficient area. In locations farther behind the vehicle the audio can not be heard since the ultrasonic signals have diverged. Preferably coupled with the ultrasonic transducers are collimated light elements 1746a, 1746b (i.e. solid state LASERs) which indicate the rearward extension of the sound. It will be appreciated that the scope of coverage can be changed and if the collimated light elements are joined to the ultrasonic transducers then the person setting up the system can readily see whether the proper audio coverage is being provided thus increasing the safety of the system.

As the principles of generating audio in the human hearing range from audio multiple audio signal above the hearing range, circuits need not be shown. The audio that is to be heard by persons behind the vehicle in the ultrasonic overlap range, is encoded as the difference in frequency between the first and second ultrasonic transducer panels. The beat frequency is only heard by users that are in a position to pickup audio from both transducers. It should be appreciated that control circuit 16 is preferably configured to alter the intensity of the ultrasonic output, and optionally the direction over which the overlap occurs in response to the conditions (time of day, lighting, obstructions, and/or other conditions).

### 14 SKATUNES—ENHANCEMENTS & EMBODIMENTS

### 14.1 ALTERNATE EMBODIMENTS

### 14.1.1 INCORP. OF RF PORT INTO PERSONAL SOUND SYSTEMS

To allow the personal sound system to be utilized with a number of external control devices such as the described skateboard having the sensor deck, an RF port is preferably incorporated into the walkman or other form of sound system. The RF port preferably comprises a separate communication link, such as operating by the Bluetooth™ standard or any other RF standard. Although communication may be less preferably linked by way of unused AM/FM broadcast bandwidth, this however prevents simultaneously receiving input from the port and listening to an active AM/FM broadcast station.

### 14.1.2 INCORPORATING HEADPHONE WITH BOOM MIC INTO PERSONAL SOUND SYSTEMS

In this embodiment of the invention the sound port (or ports) comprise transceivers allowing the personal stereo to communicate with external devices as well as for receiving information from external devices. One feature of this allows the user to send commands from the personal stereo to the external device, such as skateboard sensing deck, steering wheel input device, or any other device configured for receiving control inputs and selections.

By incorporating a microphone, such as by way of a mic boom attached to a headset, the personal stereo systems can communicate with one another. This can allow a group of skaters to have voice communications between each other and/or listen to a common music source, which can be modulated/modified by the singular or collective outputs of the skateboard deck described for the SkaTunes device. The users can also share audio files, control files and the like. Preferably the communication channel can be selected allowing a group of skaters to have their own private channel. A simple form of voice encryption may also be utilized to make them feel more secure that other skating groups are not privy to their conversations.

### 15 VEHICLE REAR POSITION REGISTRATION APPARATUS

### 15.1 PROBLEM DESCRIPTION

In situations such as racing one often has to look away from the road to get a sense of where the other vehicles are. This can break the drivers concentration.

### 15.2 OVERVIEW

The system and method of the invention is particularly well-suited for racing and it signals to the driver about the presence of nearby vehicles using tactile actuators having a relationship with the driver position that can be readily interpreted by the driver.

The apparatus brings new meaning to the phrase, “He's right on my butt!!”, because the driver literally senses the position of the other drivers and how they are “pressing in”. This advantage allows the driver to react appropriately while not needing to remove their attention from the roadway. For example they can feel when the other driver is about to make a move.

### 15.3 DETAILED DESCRIPTION

The system generally comprises (a) a means for detecting the distance of objects from the rear of a vehicle; and (b) a means of tactile annunciation (i.e. applying pressure at one or more of a plurality of locations to the back, bottom, or both, of a seated driver) in response to the proximity and movement of objects near the rear of said vehicle.

FIG. 53 illustrates an example embodiment 1810 of the apparatus attached for use on a vehicle 1812 having a driver seat 1814. A plurality of sensors 1816a-1816h are depicted about the rear of the vehicle, the number of sensors required depends on the angular spread provided by each sensor, which is dependent on the type of sensor utilized. It is important that gaps in the sensor net should be small enough wherein the presence or movement of a vehicle in relation to the rear of the driver is not ambiguous.

A controller 1818, such as a microprocessor, microcontroller, DSP, etc is configured to receive the proximity signals (optionally a separate processing unit, or units, may be utilized for conditioning these signals, and/or for correlating the signals. In the example shown it is presumed that the sensors are provided with a serial bus connection to the processor and provide digital data to the processor. One of ordinary skill will appreciated that analog processing sections can be provided for less capable sensors to accomplish the same objectives. Processor 1818 determines the positions of the vehicles and can perform lookups and the like from memory 1820 to collect any desired data.

In response to the position of the vehicles feedback is generated for the driver by activating a means of tactile annunciation which are depicted as a driver circuit 1822 with driver regulated intensity control 1824 (intensity can additionally/alternatively be regulated remotely based on driver audio comments) coupled to a set of actuators 1826.

The parameters for the system may be established, preferably when not racing using a user interface 1828, or through a communication link 1830.

An acceleration sensor 1832 is preferably provided which allows the processor to estimate the down force on the seat for modulating the intensity of the tactile annunciations so that they remain indicative of vehicle proximity and not of the acceleration and deceleration of the driver.

The means for detecting the distance of objects preferably comprises a plurality of sensors mounted near the rear portions of said vehicle which can detect the position and relative distance of a driver. By way of example these detecting means may be implemented as ultrasonic distance detection units (i.e., like so called “Polaroid” sensors), or optical sensors, electric field sensors, and so forth. It will be appreciated that many forms of distance sensing may be utilized. It is preferred that the sensors do not rely on the material of the vehicle being sensed, as various material may comprise the forward portions of a vehicle, wherein magnetic sensing for example is less preferred.

The means for applying a pressure can utilized a moving element which can press against the back of the driver and move as the nearby vehicles move, or alternatively a collection of individual actuators that are activated and deactivated to simulate the same sort of situation. Less preferably electrodes can be utilized in the seat or actually attached to the back, buttocks, thighs, or even legs of the driver for indicating the presence of the other drivers.

### 15.3.1 SPECIFIC VEHICLE IDENTIFICATION

An aspect of the invention, which also may be implemented separately, is a means of identifying nearby vehicles. One or more RFID reader, or other form of proximity based communication device is coupled to the vehicle for reading RFID tags attached to nearby vehicles. RFID tags are loaded with car number of other identification information, wherein when the tag is read the computer can identify the racing team driver, or other information. The use of the tags should be mandated by each race once such system are in place, as the cost is low and safety can be increased. The identification information can be communicated to the driver in a number of ways, such as using small displays in the vehicle indicating vehicle number and/or driver name. Small displays 1836R, 1836C, 1836L are shown with interface circuit 1838 for displaying identification for cars that are on the right rear, center rear, and left rear of the driver's vehicle. These displays may be part of a larger display or separate displays, such as LCD, Elnk, or any other display. The identification may also be given by audio means and so forth.

### 16 SIMULATOR FOR BACKING UP A CAR AND TRAILER, BOAT, AND SO FORTH

### 16.1 PROBLEM DESCRIPTION

It is often very difficult for persons to “get the hang of” maneuvering a vehicle with attached trailer, boat trailer, horse trailer, or other wheeled vehicle being pulled behind a vehicle. Currently persons must get used to maneuvering vehicles by actually getting behind the wheel and driving. However, this approach is time consuming and can lead to severe embarrassment, delays, and even endanger not only the vehicles but parties nearby the maneuvering activities.

These problems have not been fully appreciated in the industry. The present invention, however, provides a mechanism for simulating maneuvering with a trailer, in particular backing up the vehicle.

### 16.2 OVERVIEW

A simulator configured to aid persons with backing up of a trailer, and other slow speed maneuvering of consumer vehicle-trailer combinations. Preferably the simulator is very small and simple, and particularly well suited for being given away as a promotional item by the various trailer related industries, including small boat manufacturers, travel trailer manufacturers, horse trailer manufacturers, motorcycle trailer manufacturers, snowmobile manufacturers, jet-ski manufacturers, trailer rental companies (i.e. U-Haul®, Rider®, etc.), and related manufacturers and other industry parties in the travel and recreation industry. It may also be useful for distribution by safety organizations, such as department of motor vehicles. The present invention also describes a business method in which the program is preferably given away to promote safety and/or a particular organization. The program is preferably be configured with advertising or links to one or more sponsoring companies or organizations. The program can be given away in many different forms, including as a download from web sites, or as an application to run from the web sites, it may also be given away on a small CD disk. It will be appreciated that the program can be otherwise sold or utilized without departing from the teachings of the present invention. A simple version can also be loaded onto cellular phones as a practical game for the cell phone user, wherein they can practice during downtime.

The program may be developed by any desired software development company. The present invention contemplates developing the program as a much smaller and modified version of an arcade style driving game modified for the current purposes and limited control and display needs. The developer can gain recognition and advertising, or may be paid by other industry parties for the development. This form of development can significantly reduce the cost of implementing the present invention.

By way of example the invention is embodied in an application, java script, applet, or other executable that can be executed on personal computers, laptops, and preferably even PDA, and phones.

### 16.3 DESCRIPTION OF PREFERRED EMBODIMENTS

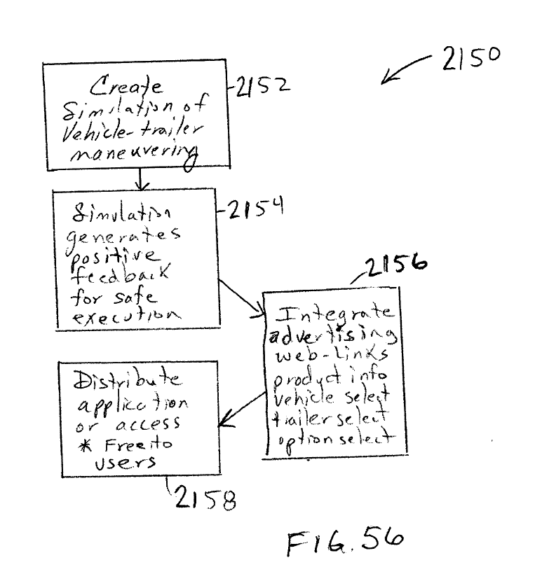

FIG. 54 depicts a preferred configuration 1910 of the simulator which can be operated with simple keyboard controls, or optionally a mouse, pointer stick or other available use input device or combination of user inputs. An example of a output display is shown 1912 with a user selected view and optional magnification 1913. The view given is currently a side view wherein a vehicle 1914 and attached trailer 1916 are shown in a side view, in this case the user is attempted to execute a scenario of backing a trailer into a launching ramp. Preferably the display shows simplified views of the vehicle, trailer, along with elements of the environment, wherein the simulation can be rendered on displays of various sizes and quality, for example the elements may be shown as outlines with monochrome or limited color rendering. A score 1918 is being shown for how safely and efficiently the user is performing the maneuver, such as backing up the trailer as shown. User selection of scenario 1920 is shown with boat launch”, for a vehicle=sedan 5, and a trailer=boat 1. The specifics of the scenario may be selected, such as vehicle options, trailer options, specific situations, specific locations 1922 (Folsom Lake is shown such as launching at Beale's Point). It will be appreciated that any desired level of detail may be incorporated without departing from the teachings of the present invention. Additional views may be simultaneously shown if the display is of sufficient size, by way of example a rear view mirror view 1924 is shown simulated the rearward view from the drivers seat (preferably optimized for best viewing angle as driver would automatically execute when driving). Optional elements may also be displayed such as the position of the steering wheel 1926, and the vehicle speed 1928, shown as between 0 to 10 mph, no readout for reverse speeds are shown, as in accord with real vehicle speed readouts.

The present slow-speed vehicle-trailer maneuver simulation application may be implemented for execution on a number of different computer based platforms, a few examples of which are shown in the figure. The application may execute on a personal computer 1930, a personal digital assistant 1932, a cellular 1934, or other computer enabled device capable of loading an the simulation application program. It will be appreciated that phones may be configured with digital links for downloading information from the internet, or for downloading digital information over a phone modem. In one mode simulation if distributed as an application program which is loaded into memory 1936 of a device, (i.e. RAM, hard disk, etc.) from which it is executed. Alternatively, or additionally, the simulation may be executed over a network, preferably the internet 1938, from a server 1940 coupled to a data base 1942. It will be appreciated that web based applications are coded in a variety of languages, such as JAVA™, macromedia flash™, and any other convenient format.

The simplest keyboard controls for the simulation are shown 1944 as key inputs, with forward 1946, reverse 1948, right turn 1950, left turn 1952, stop 1954, and view toggle 1956. For example each time the right turn button is pressed the simulated steering wheel is turned slightly more to the right, or it moves increasing to the right as it is held down. Menus, or other user selection mechanisms, allow the user to select from different maneuvering scenarios and different types of vehicles and towed trailers. For example the user can practice backing a BMW X5 towing a Nautica ski boat into a small slip at a marina. Other scenarios can include other real-world situations of boat launching, parking, parking and setting up a trailer in a camp site, unloading, backing up a vehicle to couple the trailer, obstacle courses, different types of vehicles and so forth.

The simulator of the present invention preferably allows the user to select trailers of different lengths with different wheel locations, coupling arrangements, heights, widths, rearward visibility from the driver's position, and other metrics. The selection of vehicles and trailers can be determined by the sponsor, for example if auto manufacturer “ACME” sponsored the program, then the vehicles and trailers may be those associated with the manufacturer. The system also is preferably configured to allow the user to alter the equipment utilized for viewing/assessing nearby objects, for instance rearwardly. As an example the user can select different mirror configurations, optional electronic sensors, electronic rearward imaging equipment and so forth. The system may be sponsored by companies making these items, wherein the user gets the opportunity to test how vehicle-trailer operations are made safer and less stressful by adding these additional safety features.

The user is preferably provided a selection of various views such as including: (1) front window view, (2) rear view mirror view, (3) rear view with some front view, (4) both front and rear views simultaneously, (6) side mirror views, (7) aerial view, (8) side view (well suited when launching from a sloped boat ramp, (9) resultant path track, (10) overlays of tracks for preceding attempts, (11) history—such as of improvements in driving. The system is configured to score the maneuvering efforts based on accuracy, smoothness, and safety. Although speed is considered, unlike most games this is one of the least important aspects and the game is preferably not intended to create overly confident drivers that may endanger others in attempting to “score” points or show off on how quickly they can back-up or otherwise maneuver their vehicle and trailer rig.

Other options may also be included for input and display. By way of example other elements can be displayed. Optionally, a steering wheel position indicator is preferably configured to indicate how much the steering wheel is turned to the left or to the right, while a speed indicator is optionally configured for indicating the speed of the vehicle. Although in the real world one does not have concrete metrics on the angle of steering wheel rotation and at such slow speeds does not typically rely much on the speedometer. Preferably when at a stop, giving the forward or reverse a quick pulse results in a pulse of slight acceleration, just enough to move the vehicle (as in real life) with speed dropping back to zero shortly thereafter. Once confident on track then the user can press the key and hold for at least about 0.5 second to 1 second wherein the speed increases to a given first speed wherein it remains, until altered.

Options for the simulation, include but are not limited to the following. Simulating backing into a water on a ramp of a given slope. As one backs into the water, the sound of the muffler bubbling in the water is heard, too far and water enters the vehicle or it floats away with associated sounds and visuals. Options can allow the user to take rear views from an open driver door and other selected viewpoints. The user can optionally attempt to launch or retrieve boats from a dock. The system in this mode operates to teach the user a checklist on handling trailer operations such as launching/retrieving boats or performing other trailer related functions.

The system is preferably configured to allow selecting other simulated obstruction situations, such as entering a section of road having reduced vertical clearance, side clearance or other situation. In these scenarios, other objects such as vehicles, persons, and animals can randomly enter into the simulated situation, wherein the user must make allowances for the new situation, maneuver accordingly, honk the horn, and so forth. If the user makes poor choices then the system is configured to allow replaying the situation, wherein the user is alerted as to what the correct choice was at the time. In this way the user is led through a number of different things that can happen with regard to towing a vehicle, such as a trailer, fifth wheel, auxilliary vehicle and so forth.

It should be appreciated that in a typical video driving game the user is awarded points for being reckless, for the sake of speed. They typically race a vehicle in a forward direction at a range of high speeds with other traffic nearby. In this simulation, however, the user is awarded points for safety and accomplishing the task without damaging the equipment or persons nearby, the user gets no points when damage occurs to persons, animals, other vehicles or their own vehicle or trailer.

The invention can be generally described, as a system for simulating maneuvering of a vehicle with attached trailer, comprising: (a) programming executable on a computer having key or button inputs and a graphical display output; and (b) said programming configured for, (i) user selection of a simulated vehicle-trailer handling scenario, (ii) displaying the vehicle and trailer combination in said simulated scenario, (iii) registering user key or button inputs, (iv) updating said vehicle and trailer combination in response to said inputs, (v) tracking how well maneuvering is being executed, (vi) repeating steps (iii) and (v) until the maneuver in the selected scenario is either completed successfully or simulated damage has arisen from the improper driving, (vii) generating user feedback, such as scoring, indicating errors, multiple attempts, execution tracks, and other feedback gleaned from the maneuver.

Wherein said maneuvering is preferable limited to slow-speed maneuvering that comprises forward and reverse speeds of not greater than approximately 5 to 10 miles per hour. Wherein said programming is further configured to perform any or all of the following: Score execution of the trailer driving maneuver scenario, such as based on safety, smoothness, sparseness of attempts. Display alternative or additional views of said vehicle-trailer maneuver scenario in response to user inputs. Wherein said view may be selected from the group of view consisting of: (1) front window view, (2) rear view mirror view, (3) rear view with some front view, (4) both front and rear views simultaneously, (6) side mirror views, (7) aerial view, (8) side view (well suited when launching from a sloped boat ramp, (9) resultant path track, (10) overlays of paths from multiple executions of the scenario.

FIG. 55 illustrates method steps 2000 that generally describe the invention. User sets up the simulation by selecting the type of scenario, along with the vehicle and trailer to be utilized as represented by block 2002. They computer renders a display of the scenario and the combination of vehicle-trailer as per block 2004. User inputs are registered, such as fwd, rev, right, left, stop, and view, keystrokes, as depicted by block 2006. The elements of the simulation are updated as per block 2008. Preferably, the updates are performed on a periodic basis, wherein movement is computed based on previous settings (i.e. wheel turn, throttle setting, position) to which the changes are applied to yield new settings and new positions. User actions are compared against the maneuver to determine how well the user is executing the scenario, as represented by block 2010. Unless the maneuver is successfully completed, or the driver crashes (or otherwise fatally fails the maneuver as checked in block 2012 (or selects other options which terminate processing of inputs) the user input to display output loop continues back to block 2004. Once completed, or optionally during execution, feedback is generated to the user as shown in block 2014, these can include listing errors, making suggestions, shown wrong path excursions and so forth.

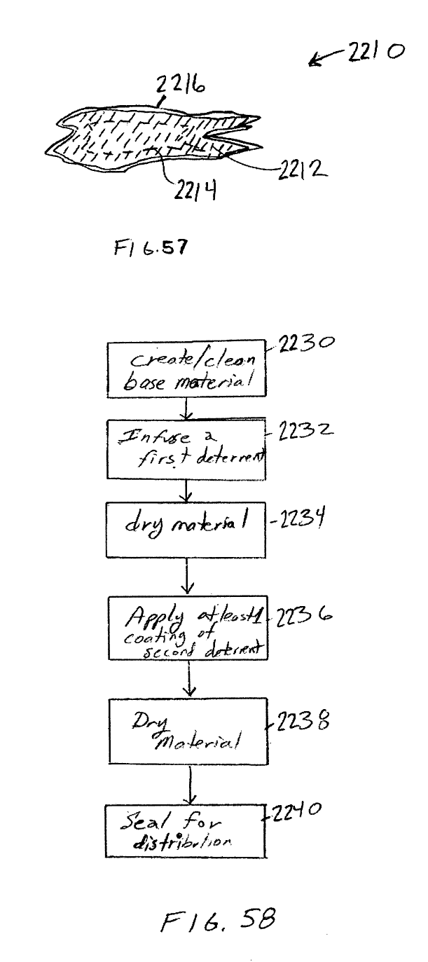

FIG. 56 generally depicts a business method implementation 2150 for the present invention which generally comprises. Creating a simulation of maneuvering a vehicle-trailer combination at low speed according to a selected real-world scenario as represented by block 2152. Providing positive user feedback within said simulation in response to safely maneuvering the vehicle-trailer combination as per block 2154. Optionally advertising for one or more sponsoring organizations is incorporated (information, visuals, web links, selection of advertiser vehicles, advertiser trailers/boats/snow mobiles/jet skis and so forth, advertiser trailers, advertiser optional equipment, such as view enhancement), as shown by block 2156. Distributing said simulation (preferably free) to encourage safe operation of vehicles towing trailers as per block 2158.

Wherein the combination of said vehicle-trailer are non-commercial vehicle-trailer. Wherein said vehicle-trailer is not commercial tractor-trailer equipment. Further comprising integrating advertising, information, and/or web links, into said simulation for one or more sponsoring organizations. Wherein the programming is customized to simulate maneuvering a vehicles associated with the manufacturer (i.e. a car, SUV, boat, trailer, and so forth).

### 16.4 ALTERNATE EMBODIMENTS

The present invention can be less preferably adapted for use in teaching the proper use of commercial vehicles. Primarily these commercial scenarios may have more entertainment value than educational value. It is preferred that commercial vehicle training be performed in a large simulator that provides a wide range of speeds and a wider variety of situations with more precise control inputs, preferably a steering wheel, accelerator pedal, brake pedal, clutch, stick shift, and other equipment that must be learned for driving a commercial vehicle.

### 17 ANIMAL DETERRENT LANDSCAPING BANK

### 17.1 PROBLEM DESCRIPTION

Animals, both domestic and wild, often dig up flower beds and leave their waste and/or spray their scents to mark the territory. Cats, dogs, rabbits, skunks, raccoons, and so forth sniff around your landscaping and have their way with your flower beds. Human sensibilities are offended by these intense smells of urine and feces, not to mention the mess made by animals playing, digging around, or mating. The smell often being so offensive that we don't want to use that area anymore, we at least don't enjoy the area as we could otherwise.

### 17.2 OVERVIEW

The present invention describes landscaping materials that can be spread in flower beds and other areas to deter animals without detracting from your enjoyment of the area. One embodiment of the invention is a landscaping bark material that it treated with natural ingredients which deter the presence of animals, without harming them. Once close sniff and they are gone, . . . no more digging, defecating, or urinating in your planter beds and other areas.

The deterrent landscaping material can provide the look and feel of trusted materials, such as redwood bark, but contains an aroma that animals can't stand to sniff, one that masks their natural scent identification system and bothers their keen sense of smell. The deterrent scent preferably comprise vegetable-based materials having a scent that is not unpleasant, if noticed at all, to humans but that animals with their intense sensitivity to certain materials can't stand to sniff.

The treated material retains this ability to deter animals for a long period of time because it is infused and/or coated on the material, wherein it does not simply wash away from the operation of sprinklers or the action of the rain.

### 17.3 DESCRIPTION OF PREFERRED EMBODIMENTS

FIG. 57 illustrates an embodiment of a decorative material 2210 according to the invention, which is based on redwood bark, or shredded natural wood materials, of a suitably small size for spreading in flow beds and other landscape areas, such as less than approximately one to two cubic inches per chip. The base material 2212 is shown having a solid interior and a natural rough exterior.

The base material is then subjected to one or more infusion and/or coating processes so that the deterrent scent material is adequately retained on the material when exposed to environmental factors. It is not necessary, however, that the deterrents remain in force indefinitely, as the material is typically periodically replenished.

The infusion treatment, or treatments, result in driving the deterrent into the material, such as to a depth 2214. The infusion process may utilize a soaking process, but more preferably utilizes a pressure to more deeply infuse the compounds. For example, pressurized water steam, or more costly processes using heated non-polar solvents. The infusion can be aided by first drying the material to rid it of native moisture. Ultrasonic or microwave energy sources can be used during the process to also aid in infusing the compounds.

The coating process binds the deterrent onto the material by any convenient means, as shown as an exterior layer 16. In one embodiment the material, such as bark, is coated with a binder material and then subject to the deterrent, such as tumbled with it or otherwise bringing the material into contact with the deterrent. Preferably the binding material does not seal the material from water and oxygen, yet does not readily wash off when exposed to the environment. The binder is preferably an organic binders, such as a gum derivation, although many binders are known in the art for both food grade and non-food grade applications. The coating may comprise multiple layers, which may each have their own binder, however, this is not necessary and generally increases manufacturing cost. Although the use of both infusion and coating have been described it should be appreciated that either infusion or coating could be less preferably relied upon in and of itself for practicing the invention.

By way of example, one class of scents that deter animals are those based on peppers, and hot chili peppers. Animals naturally steer clear of peppers, the capsaicin compounds and other natural alkaloids and related compounds that are utilized by plants to provide protection from animal predation. Examples of these are even found in food seasoning products such as Paprika, Cayenne pepper, Chili powders, and so forth. The scents of these materials are not strong unless held up closely to the nose. Animals, however, being much more sensitive to scent as repulsed and typically don't need to sniff it in close proximity. It is also interesting to note that capsaicin, from a portion of hot chili peppers, such as habaneras, jalapenos, and so forth, even provides a natural fungicide and antibacterial agent, which as a side benefit can prolong the useful life of the landscape bark. The use of pepper based agents also can immediately eliminate problems with slugs and snails as they are not able to traverse the material.

Other forms of peppers are derived from black or white peppers, Piper nigrum, which contain a volatile oil and pungent components, commonly known as piperine. Both the steam volatile oil and certain non-steam volatile constituents contribute to the organoleptic properties of pepper. The scent is derived from its aromatic steam-volatile oil, while the characteristic pungency is produced by non-steam-volatile alkaloids, of which piperine is the most important. The volatile oil level in black pepper is usually higher than in white pepper. The hull of the pepper contains fibre and some essential oil. This essential oil is removed during process into white pepper. The volatile oil content increases up to the level in a green peppercorn, and then decreases with maturity.

The piperine is an amide of piperic acid and piperidine. It also contains small quantities of chavicine, piperidine and pipperettine, which together give the sharp bite and pungency. The piperine is the trans, trans form of 1-piperoylpiperidine. Other minor pungent alkaloids present are piperettine, piperyline, piperolein A and B and piperanine. Piperine content increases with maturity of the berry.

It should be appreciated that a number of different compounds may be utilized for deterring the animals. Embodiments of the invention may utilize other natural ingredients, either singly, or in combinations. By way of example any of the following or combination thereof may be utilized. Cayenne pepper, Paprika and Chili powder are from parts of the ground dried fruit or seeds of the cayenne pepper plant Capiscum Annum. Allspice such as from berries of the allspice tree Pimenta Dioica. Anise, similar to licorice and from the seeds of the anise plant Pimpinella Anisum. Coriander is from the seeds of the coriander plant Coriandrum Sativum. Cumin is the ground seed of the cumin plant Cuminum Cyminum. Horseradish is the ground roots of the horseradish plant Armoracia Lapathifolia. Other safe food grade materials have also been known to repel domestic and wild animals including: Garlic, mustard oil, or peppermint oil which effects their sense of smell, and putrescent egg, which emits the smell of an animal protein. These can be used singly, or in combination, with the pepper materials or derivatives as well as other compounds to provide a product that is safe to animals and humans, does not harm plants, and provides a long period of activity.

FIG. 58 depicts an embodiment of the process for manufacturing the landscape bark material. The base material, such as bark, is preferably cleaned at block 2230, such as if (1) the material needs to be clean for use in the market; (2) dirt or other substances would hinder the infusion or coating of the material. Part of the cleaning step can include drying the material to allow it to better accept the infusion, such as drying in a kiln to reduce the water content.

One or more infusion operations is depicted at step 2232, it will be appreciated that a number of compounds can be utilized simultaneously or in multiple infusion steps. A very economical means of infusion involves placing the material in a boiling vat containing the deterrent material in suspension or solution, with the material being preferably churned, such as by an impellor so that the bark or other material is drawn through the heated liquid during this soaking process. The bark can then be removed from the liquid, drained and dried as represented by step 2234. A coating process 2236 can then be utilized. For example, a binding agent can be applied, if desired, then the bark brought into contact with a dry deterrent material, which sticks to the bark. A binding agent need not be used, if the deterrent material is configured for attachment to the bark material, such as part of a thick liquid which is applied to the exterior of the bark, (i.e. sprayed, drench, or other coating process. The bark, or other decorative landscape material, is then dried as per block 2238, and preferably packaged for distribution as per block 2240, such as sealed in substantially air-tight bags so that full effectiveness of the decorative landscape material is retained during shipping and storage. The material could also be distributed in bulk, if utilized within a reasonable period of time.

It should also be appreciated that the liquid from the infusion step can provide for binding a dry material on its exterior, thus eliminating the need to drain and dry the bark material before coating. Still further it will be appreciated that the vat of liquid may contain compounds that are capable of infusing into the bark material (such as compounds in solution), as well as non-soluble compounds which are in suspension and which adhere to the exterior of the bark after the carrier liquid is dried. In this way the infusion and coating process can be performed simultaneously thus reducing manufacturing cost.

### 18 WEIGHING MAIL PIECES RAPIDLY

### 18.1 PROBLEM DESCRIPTION

It is generally difficult to weight mail pieces when they are quickly moving through an automated system. Scales require a period of time to stabilize to a reading and are not adapted to operate with a stream of enveloped or similar packages flowing.

### 18.2 DESCRIPTION OF PREFERRED EMBODIMENTS

A weighing system is described for mail pieces and similar items which does not hold up the line, and in fact makes use of the movement. Typically in a conveyor line, the speed of the items through the system is well controlled, yet the weight is often unknown, in particular of mail pieces.

The conveyor is system is adapted with a “jump” wherein the items move horizontal from a first vertical location to a second vertical location which is lower than the first, such that a drop is induced. An optical detector, such as a camera, laser system or the like is adapted to track the path of the letter or package as it drops. The pieces drop in accord with their weight and small packages only slight affected by air friction. The system can closely estimate weight of letters (especially when processed on their edges) and small packages. Items which weight too much, or have insufficient postage can be directed from the conveyor onto another check station which can use convention means to determine if any problems exist.

Invention Scope.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof. For example, one of ordinary skill may find other suitable substitutes for certain applications, expressed as types, configurations, placement, number of, etc.

Moreover, a system, apparatus, or method according to the various embodiments of the invention may be provided with all with all of features described herein, or only portions thereof, which combinations may be practiced and/or sold together or separately. For example, a system, apparatus, or method may be manufactured and sold without certain desired equipment for later assembly. In this regard, such equipment may be “adapted to” include or otherwise couple to such equipment without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for automatically cleaning areas on the exterior of a building, comprising:
a mobile platform configured for moving along the exterior surfaces of a structure;
a washing head coupled to said platform unit and configured for directing water or a liquid cleaner to a surface to be cleaned;
a drive mechanism coupled to said mobile platform and configured for positioning said washing head on a portion of a building exterior to be cleaned;
a computer for controlling motion and cleaning operations; and
programming executable on said computer for,
receiving a command to clean at least one area on the exterior of said building,
determining a movement path to said area to be cleaned according to building mapping information retained in the memory of said computer,
advancing said platform along said path to said area to be cleaned,
applying a liquid cleaner to said area,
removing said liquid cleaner after said area is cleaned,
repeating the above steps for additional areas to be cleaned.

2. An apparatus as recited in claim 1, wherein said area to be cleaned comprises window surfaces.

3. An apparatus as recited in claim 1, wherein said area to be cleaned includes window framing members to be cleaned.

4. An apparatus as recited in claim 1:
wherein said mobile platform is configured for engaging a fixed track attached to the exterior of said building upon which it can move;
wherein said washing head is attached to said moble platform and is positioned over a window portion to be cleaned in response to the movement of said mobile platform.

5. An apparatus as recited in claim 1:
wherein said mobile platform is configured for engaging a fixed track attached to an upper portion said building above areas to be cleaned;
wherein said washing head is suspended from said mobile platform and is positioned, in a vertical direction, over a window portion to be cleaned in response to altering the separation between said the washing head from said mobile platform.

6. An apparatus as recited in claim 5, further comprising:
at least one or more boom arms extending from said mobile platform;
elongated flexible members which can be extended between said boom arms and said washing head for adjusting the vertical position of said washing head.

7. An apparatus as recited in claim 6:
wherein said elongated flexible members comprise cables.
wherein said elongated flexible member is coupled to a means of extending or retracting said flexible member;
wherein said means of extending or retracting is attached to said mobile platform.

8. An apparatus as recited in claim 5:
wherein said fixed track is attached to a generally horizontal portions of a tier or roof of said building;
wherein said track is configured to limit tilting of said mobile platform engaged therein.

9. An apparatus as recited in claim 5, wherein said fixed track comprises an elongated track subscribing a path near the exterior of the building over which said mobile platform may be positioned.

10. An apparatus as recited in claim 5: wherein said mobile platform is configured with a drive mechanism and control circuitry for selectively positioning said mobile platform at a position along said elongated track.

11. An apparatus as recited in claim 1, wherein said programming further comprises returning said movable platform to a staging area in which cleaning fluids are received and/or waste fluids are removed for disposal.

12. An apparatus as recited in claim 11, wherein said programming further comprises returning to said staging area for recharging electrical power reservoir.

13. An apparatus as recited in claim 1, further comprising a drying head coupled to said platform and configured for removing water and/or liquid cleaner from a surface to be cleaned.

14. An apparatus as recited in claim 1, wherein said area to be cleaned comprises window surfaces on the exterior of said building.

15. An apparatus as recited in claim 1, wherein said programming further comprises detecting debris or cleaning residues remaining on said area after cleaning; wherein the cleaning operation may be repeated over all or a portion of said area to be cleaned.

16. An apparatus as recited in claim 1:
further comprising a drying head configured for removing excess water.
wherein said removed wash water is stored in a reservoir in said washing head, pumped back to said movable platform.

17. An apparatus as recited in claim 1, further comprising means for detecting horizontal window framing.

18. An apparatus as recited in claim 17, wherein said means for detecting horizontal window framing comprises a separate sensor which detects position regardless of cycle.

19. An apparatus as recited in claim 17, wherein said means for detecting horizontal window framing is coupled to washing elements or drying elements for detecting horizontal and/or vertical window edges.

20. An apparatus as recited in claim 1, further comprising a position registration system for determining position of said unit on said building.

21-146. (canceled)
